(19) United States
(12) Patent Application Publication
(10) Pub. No.: US 2019/0020877 A1
(43) Pub. Date: Jan. 17, 2019

(54) IMAGE PROCESSING APPARATUS AND METHOD

(71) Applicant: SONY CORPORATION, TOKYO (JP)

(72) Inventor: ATSUSHI YAMATO, TOKYO (JP)

(21) Appl. No.: 16/068,965

(22) PCT Filed: Jan. 6, 2017
(86) PCT No.: PCT/JP2017/000209

§ 371 Date: Jul. 10, 2018

(30) Foreign Application Priority Data
Jan. 21, 2016 (JP) 2016-009699

(51) Int. Cl. H04N 19/13; H04N 19/196; H04N 19/174; H04N 19/157

(52) U.S. Cl. CPC H04N 19/13; H04N 19/157; H04N 19/174; H04N 19/196

(57) ABSTRACT

The present disclosure relates to image processing apparatus and method that can improve the throughput of encoding and decoding. Flag information indicating whether to apply arithmetic coding to binary data is set, the binary data including binary information regarding an image. The information regarding the image is encoded to generate encoded data including the set flag information. For example, on the basis of the flag information, the encoded data may be generated by binarizing the information regarding the image to generate binary data and then applying the arithmetic coding, or the encoded data may be generated by binarizing the information regarding the image. The present disclosure can be applied to, for example, an image processing apparatus, an image encoding apparatus, an image decoding apparatus, or the like.

### TECHNICAL FIELD

The present disclosure relates to image processing apparatus and method, and particularly, to image processing apparatus and method that can improve the throughput of encoding and decoding.

### BACKGROUND ART

In recent years, to further improve the encoding efficiency from MPEG-4 Part 10 (Advanced Video Coding, hereinafter referred to as AVC), the JCTVC (Joint Collaboration Team-Video Coding) that is a joint standards organization of the ITU-T (International Telecommunication Union Telecommunication Standardization Sector) and the ISO/IEC (International Organization for Standardization/International Electrotechnical Commission) is standardizing an encoding system called HEVC (High Efficiency Video Coding) (for example, see NPL 1).

In the AVC and the HEVC, a predicted image of an image to be encoded is generated, and quantized data obtained by an orthogonal transformation and quantization of residual information between the image to be encoded and the predicted image is encoded to obtain encoded data. CABAC (Context-Adaptive Binary Arithmetic Coding) is stipulated as a system for encoding the quantized data. In a case of encoding of CABAC, quantized data is binarized to obtain binary data, and arithmetic coding is applied to the binary data to obtain encoded data (bit string). In a case of decoding of CABAC, arithmetic decoding is applied to encoded data to obtain binary data, and multi-level data of the obtained binary data is formed to obtain quantized data.

### CITATION LIST

### Non Patent Literature

### [NPL 1]

ITU-T, “SERIES H: AUDIOVISUAL AND MULTIMEDIA SYSTEMS Infrastructure of audiovisual services. Coding of moving video High efficiency video coding,” ITU-T H.265 (V3), 2015-04-29

### SUMMARY

### Technical Problem

However, although the encoding efficiency of the arithmetic coding and the arithmetic decoding is excellent, the process is slow, and it is difficult to improve the throughput of encoding and decoding.

The present disclosure has been made in view of the circumstances, and the present disclosure enables to improve the throughput of encoding and decoding.

### Solution to Problem

An aspect of the present technique provides an image processing apparatus including a flag information setting section that sets flag information indicating whether to apply arithmetic coding to binary data including binary information regarding an image, and an encoding section that encodes the information regarding the image to generate encoded data including the flag information set by the flag information setting section.

On a basis of the flag information set by the flag information setting section, the encoding section can binarize the information regarding the image to generate the binary data and apply the arithmetic coding to the generated binary data to thereby generate encoded data including the binary and arithmetic-coded information regarding the image or can binarize the information regarding the image to generate encoded data including the binary information regarding the image.

The image processing apparatus can further include a flag information addition section that adds the flag information set by the flag information setting section to the encoded data of the information regarding the image.

The flag information addition section can add the flag information so as to include the flag information in a slice header of the encoded data.

The flag information setting section can set the flag information on a basis of information regarding the encoding of the image.

The information regarding the encoding can include information regarding a throughput of the encoding of the image.

The information regarding the throughput can include at least one of information regarding a code amount generated by the encoding of the image, information regarding a compression ratio of the encoding of the image, and information regarding processing time of the encoding of the image.

The information regarding the encoding can include information regarding a delay in the encoding of the image.

The flag information setting section can set the flag information for each slice of the image.

The flag information setting section can set the flag information on a basis of control information for controlling use of the flag information.

The control information can include permission information for permitting the use of the flag information, and the flag information setting section can be configured to set the flag information in a case where the use is permitted by the permission information.

The image processing apparatus can further include a control information addition section that adds the control information to the encoded data of the information regarding the image.

The aspect of the present technique provides an image processing method including setting flag information indicating whether to apply arithmetic coding to binary data including binary information regarding an image, and encoding the information regarding the image to generate encoded data including the set flag information.

Another aspect of the present technique provides an image processing apparatus including a decoding section that applies arithmetic decoding and obtains multi-level data of encoded data, the encoded data including binary and arithmetic-coded information regarding an image, on a basis of flag information indicating whether to apply the arithmetic coding to binary data including the binary information regarding the image to thereby obtain multi-level data of the encoded data, the encoded data including the binary information regarding the image.

The image processing apparatus can further include a flag information acquisition section that acquires the flag information added to the encoded data. The decoding section can be configured to apply the arithmetic decoding and obtain the multi-level data of the encoded data, the encoded data including the binary and arithmetic-coded information regarding the image, on a basis of the flag information acquired by the flag information acquisition section to thereby obtain the multi-level data of the encoded data, the encoded data including the binary information regarding the image.

The flag information acquisition section can acquire the flag information stored in a slice header of the encoded data.

The flag information acquisition section can acquire the flag information on a basis of control information for controlling use of the flag information.

The control information can include permission information for permitting the use of the flag information, and the flag information acquisition section can be configured to acquire the flag information in a case where the use is permitted by the permission information.

The image processing apparatus can further include a control information acquisition section that acquires the control information added to the encoded data. The flag information acquisition section can be configured to acquire the flag information on a basis of the control information acquired by the control information acquisition section.

The aspect of the present technique provides an image processing method including applying arithmetic decoding and obtaining multi-level data of encoded data, the encoded data including binary and arithmetic-coded information regarding an image, on a basis of flag information indicating whether to apply the arithmetic coding to binary data including the binary information regarding the image to thereby obtain multi-level data of the encoded data, the encoded data including the binary information regarding the image.

In the image processing apparatus and method according to an aspect of the present technique, the flag information indicating whether to apply the arithmetic coding to the binary data is set, the binary data including the binary information regarding the image.

In the image processing apparatus and method according to another aspect of the present technique, on a basis of the flag information indicating whether to apply the arithmetic coding to the binary data including the binary information regarding the image, the arithmetic decoding is applied to the encoded data including the binary and arithmetic-coded information regarding the image, and the multi-level data is obtained. In this way, the multi-level data of the encoded data including the binary information regarding the image is obtained.

### Advantageous Effect of Invention

According to the present disclosure, an image can be processed. Particularly, the throughput of encoding and decoding can be improved.

### BRIEF DESCRIPTION OF DRAWINGS

FIG. 1 is a diagram for describing an example of a situation of encoding and decoding of CABAC.

FIG. 2 is an explanatory diagram for describing an overview of recursive block partitioning regarding a CU in HEVC.

FIG. 3 is an explanatory diagram for describing setting of a PU for the CU illustrated in FIG. 2.

FIG. 4 is an explanatory diagram for describing setting of a TU for the CU illustrated in FIG. 2.

FIG. 5 is an explanatory diagram for describing scan orders of CUs and PUs.

FIG. 6 is a block diagram illustrating a main configuration example of an image encoding apparatus.

FIG. 7 is a block diagram illustrating a main configuration example of an encoding section.

FIG. 8 is a diagram describing a difference in throughput.

FIG. 9 is a diagram describing a difference in latency.

FIG. 10 is a flow chart describing an example of a flow of an image encoding process.

FIG. 11 is a flow chart describing an example of a flow of an encoding control process.

FIG. 12 is a flow chart describing an example of a flow of the encoding control process.

FIG. 13 is a flow chart describing an example of a flow of the encoding control process.

FIG. 14 is a flow chart describing an example of a flow of an encoding process.

FIG. 15 is a diagram illustrating an example of syntax.

FIG. 16 is a flow chart describing an example of a flow of the encoding process.

FIG. 17 is a flow chart describing an example of a flow of the encoding process.

FIG. 18 is a block diagram illustrating a main configuration example of an image decoding apparatus.

FIG. 19 is a block diagram illustrating a main configuration example of a decoding section.

FIG. 20 is a flow chart describing an example of a flow of an image decoding process.

FIG. 21 is a flow chart describing an example of a flow of a decoding control process.

FIG. 22 is a flow chart describing an example of a flow of a decoding process.

FIG. 23 is a block diagram illustrating a main configuration example of the encoding section.

FIG. 24 is a flow chart describing an example of a flow of the encoding control process.

FIG. 25 is a block diagram illustrating a main configuration example of the decoding section.

FIG. 26 is a flow chart describing an example of a flow of the decoding control process.

FIG. 27 is a block diagram illustrating a main configuration example of the encoding section and the decoding section.

FIG. 28 is a diagram illustrating an example of a multi-view image encoding system.

FIG. 29 is a diagram illustrating a main configuration example of a multi-view image encoding apparatus according to the present technique.

FIG. 30 is a diagram illustrating a main configuration example of a multi-view image decoding apparatus according to the present technique.

FIG. 31 is a diagram illustrating an example of a tiered image encoding system.

FIG. 32 is a diagram illustrating a main configuration example of a tiered image encoding apparatus according to the present technique.

FIG. 33 is a diagram illustrating a main configuration example of a tiered image decoding apparatus according to the present technique.

FIG. 34 is a block diagram illustrating a main configuration example of a computer.

FIG. 35 is a block diagram illustrating an example of a schematic configuration of a television apparatus.

FIG. 36 is a block diagram illustrating an example of a schematic configuration of a mobile phone.

FIG. 37 is a block diagram illustrating an example of a schematic configuration of a recording/reproducing apparatus.

FIG. 38 is a block diagram illustrating an example of a schematic configuration of an imaging apparatus.

FIG. 39 is a block diagram illustrating an example of a schematic configuration of a video set.

FIG. 40 is a block diagram illustrating an example of a schematic configuration of a video processor.

FIG. 41 is a block diagram illustrating another example of the schematic configuration of the video processor.

### DESCRIPTION OF EMBODIMENTS

Hereinafter, modes for carrying out the present disclosure (hereinafter, referred to as embodiments) will be described. Note that the embodiments will be described in the following order.
1. First Embodiment (Image Encoding Apparatus)
2. Second Embodiment (Image Decoding Apparatus)
3. Third Embodiment (Encoding Section)
4. Fourth Embodiment (Decoding Section)
5. Fifth Embodiment (Encoding Section, Decoding Section)
6. Sixth Embodiment (Etc.)

### 1. First Embodiment

### <Flow of Standardization of Image Encoding>

In recent years, to further improve the encoding efficiency from MPEG-4 Part 10 (Advanced Video Coding, hereinafter referred to as AVC), the JCTVC (Joint Collaboration Team-Video Coding) that is a joint standards organization of the ITU-T (International Telecommunication Union Telecommunication Standardization Sector) and the ISO/IEC (International Organization for Standardization/International Electrotechnical Commission) is standardizing an encoding system called HEVC (High Efficiency Video Coding).

### <CABAC>

In the AVC and the HEVC, a predicted image of an image to be encoded is generated, and quantized data obtained by an orthogonal transformation and quantization of residual information between the image to be encoded and the predicted image is encoded to obtain encoded data. CABAC (Context-Adaptive Binary Arithmetic Coding) is stipulated as a system for encoding the quantized data. The CABAC is encoding using binarization and arithmetic coding (decoding using arithmetic decoding and multi-level formation).

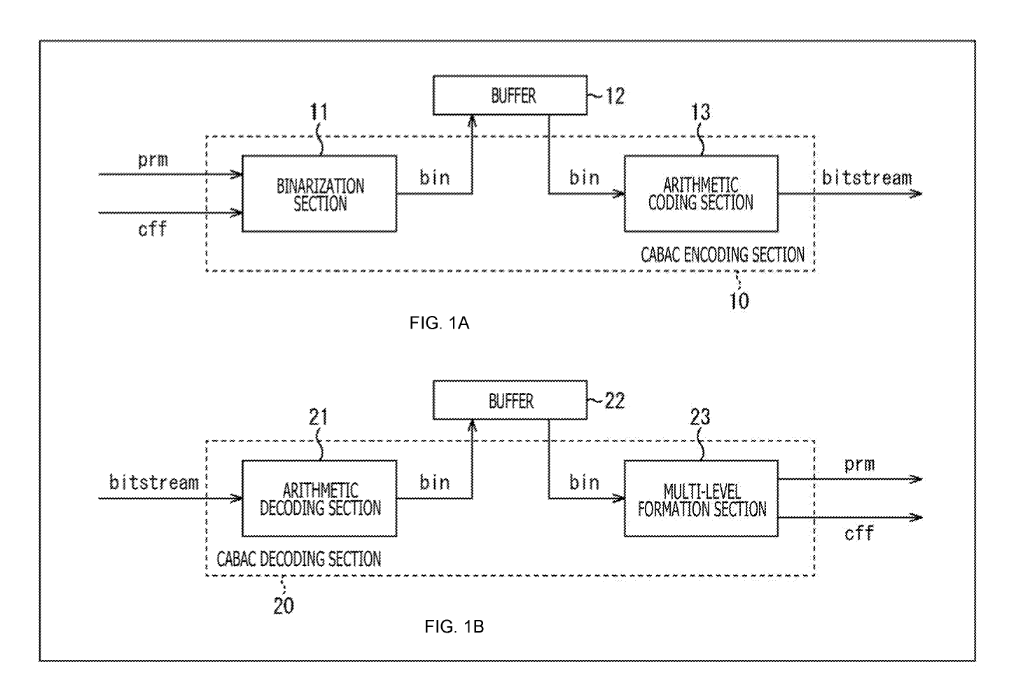

For example, a CABAC encoding section 10 that performs encoding of CABAC includes a binarization section 11 and an arithmetic coding section 13 as illustrated in A of FIG. 1. The binarization section 11 obtains binary data (bin) by binarizing (Binarization) information of a parameter (prm) and a coefficient (cff) that is called Dpath (Data path) and that is generated in pipeline processing. The binary data (bin) is accumulated in a buffer 12. The arithmetic coding section 13 applies arithmetic coding (Ac) to the binary data (bin) accumulated in the buffer 12 to obtain encoded data (bitstream).

In addition, for example, a CABAC decoding section 20 that performs decoding of CABAC includes an arithmetic decoding section 21 and a multi-level formation section 23 as illustrated in B of FIG. 1. The arithmetic decoding section 21 applies arithmetic decoding to encoded data (bitstream) to obtain binary data (bin). The binary data (bin) is accumulated in a buffer 22. The multi-level formation section 23 obtains multi-level data of the binary data (bin) accumulated in the buffer 22 to obtain information of a parameter (prm) and a coefficient (cff).

In the process of CABAC, the encoding efficiency of the arithmetic coding and the arithmetic decoding is excellent. However, the process is slow, and the delay (latency) is large. Therefore, it is difficult to improve the throughput of encoding and decoding of CABAC or to reduce the delay. In addition, variations (fluctuations) in the length of the processing time are large in the arithmetic coding and the arithmetic decoding, and a sufficiently high-capacity buffer needs to be prepared to prevent a failure of the process (to absorb the fluctuations). Therefore, it is difficult to suppress the increase in the cost.

### <Control of Arithmetic Coding and Arithmetic Decoding>

Therefore, flag information indicating whether to apply arithmetic coding to the binary data including binary information regarding the image is set. That is, by providing the flag information, whether or not to perform the arithmetic coding and the arithmetic decoding can be controlled. In this way, the arithmetic coding and the arithmetic decoding can be skipped as necessary. Therefore, the throughput of encoding and decoding can be easily improved, and the delay can be easily reduced. In addition, the increase in the fluctuations can be suppressed. Therefore, the capacity of the buffer can be reduced, and the increase in the cost can be suppressed.

The present technique can be applied to any encoding and decoding using the binarization, the multi-level formation, the arithmetic coding, and the arithmetic decoding as in the CABAC. For example, the present technique can also be applied to the AVC, the HEVC, and the like.

### <Block Partitioning>

Incidentally, the encoding process is executed on the basis of a processing unit called a macroblock in an existing image encoding system, such as MPEG2 (Moving Picture Experts Group 2 (ISO/IEC 13818-2)) and AVC. The macroblock is a block in a uniform size of 16×16 pixels. On the other hand, the encoding process is executed on the basis of a processing unit (encoding unit) called a CU (Coding Unit) in the HEVC. The CU is a block in a variable size formed by recursively partitioning an LCU (Largest Coding Unit) that is a largest encoding unit. The largest selectable size of the CU is 64×64 pixels. The smallest selectable size of the CU is 8×8 pixels. The CU in the smallest size is called an SCU (Smallest Coding Unit).

In this way, as a result of adopting the CU in a variable size, the image quality and the encoding efficiency can be adaptively adjusted in the HEVC according to the content of the image. A prediction process for prediction encoding is executed on the basis of a processing unit (prediction unit) called a PU (Prediction Unit). The PU is formed by using one of some partitioning patterns to partition the CU. Furthermore, an orthogonal transformation process is executed on the basis of a processing unit (transformation unit) called a TU (Transform Unit). The TU is formed by partitioning the CU or the PU up to a certain depth.

### <Recursive Partitioning of Blocks>

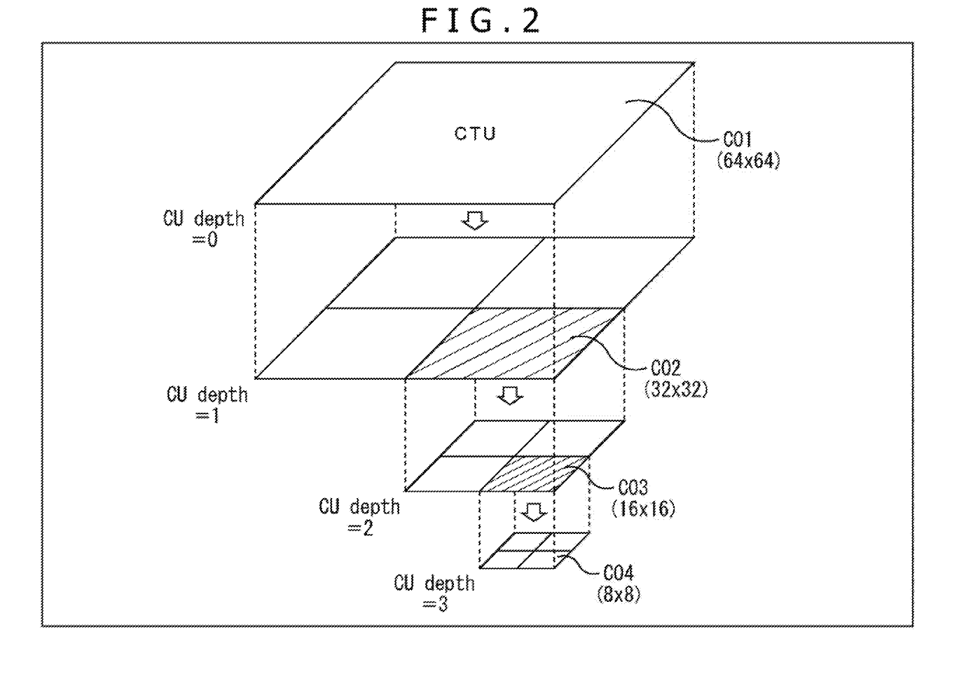

FIG. 2 is an explanatory diagram for describing an overview of recursive block partitioning regarding the CU in the HEVC. The block partitioning of the CU is performed by recursively repeating the partitioning of one block into four (=2×2) sub-blocks, and as a result, a tree structure in a quad-tree shape is formed. One quad-tree as a whole is called a CTB (Coding Tree Block), and a logical unit corresponding to the CTB is called a CTU (Coding Tree Unit).

In the upper part of FIG. 2, an example of C01 as a CU in a size of 64×64 pixels is illustrated. The depth of partitioning of C01 is equal to zero. This indicates that C01 is a root of the CTU and is equivalent to the LCU. The LCU size can be designated by a parameter encoded in an SPS (Sequence Parameter Set) or a PPS (Picture Parameter Set). C02 as a CU is one of the four CUs partitioned from C01 and has a size of 32×32 pixels. The depth of partitioning of C02 is equal to 1. C03 as a CU is one of the four CUs partitioned from C02 and has a size of 16×16 pixels. The depth of partitioning of C03 is equal to 2. C04 as a CU is one of the four CUs partitioned from C03 and has a size of 8×8 pixels. The depth of partitioning of C04 is equal to 3. In this way, the CU can be formed by recursively partitioning the image to be encoded. The depth of partitioning is variable. For example, a CU in a larger size (that is, with a smaller depth) can be set for a flat image region such as a blue sky. On the other hand, a CU in a smaller size (that is, with a larger depth) can be set for a sharp image region including a large number of edges. Then, each of the set CUs becomes a processing unit of the encoding process.

### <Setting of PU for CU>

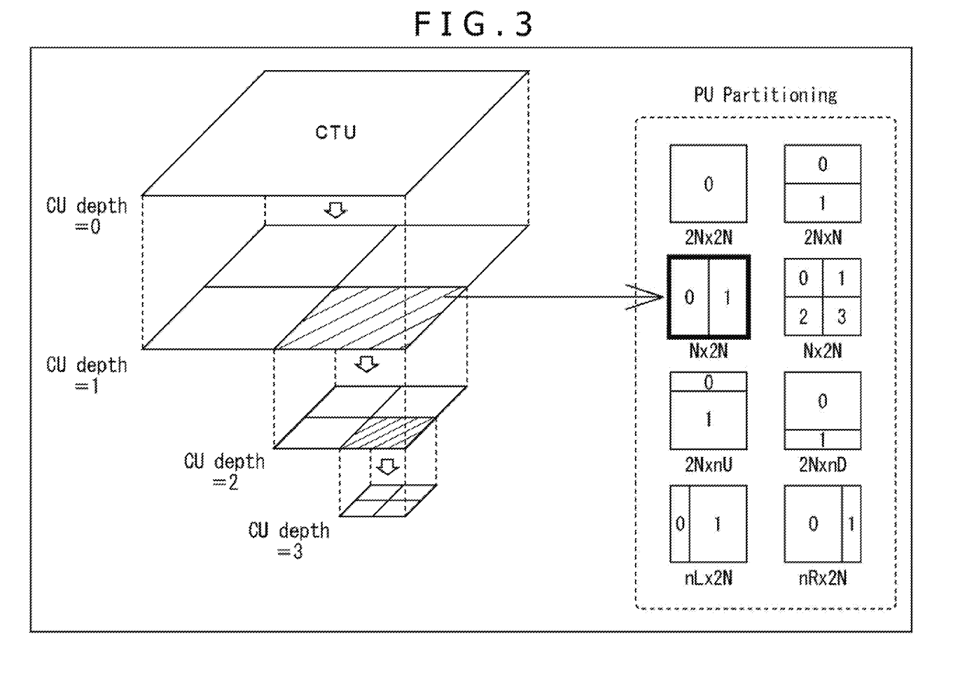

The PU is a processing unit of the prediction process including intra prediction and inter prediction. The PU is formed by using one of some partitioning patterns to partition the CU. FIG. 3 is an explanatory diagram for describing the setting of the PU for the CU illustrated in FIG. 2. Eight types of partitioning patterns are illustrated on the right of FIG. 3 including 2N×2N, 2N×N, N×2N, N×N, 2N×nU, 2N×nD, nL×2N, and nR×2N. Two types of partitioning patterns, that is, 2N×2N and N×N, can be selected in the intra prediction (N×N can be selected only for SCU). On the other hand, all of the eight types of partitioning patterns can be selected in the inter prediction in a case where asymmetric motion partitioning is validated.

### <Setting of TU for CU>

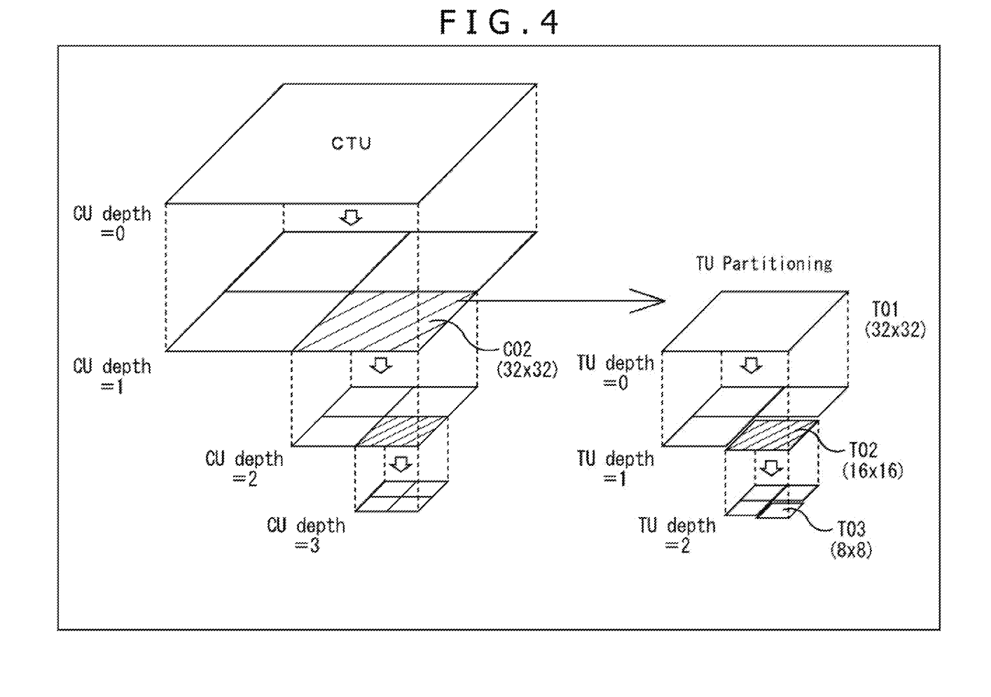

The TU is a processing unit of the orthogonal transformation process. The TU is formed by partitioning the CU (for intra CU, each PU in the CU) up to a certain depth. FIG. 4 is an explanatory diagram for describing the setting of the TU for the CU illustrated in FIG. 3. One or more TUs that can be set for C02 are illustrated on the right of FIG. 4. For example, T01 as a TU has a size of 32×32 pixels, and the depth of the TU partitioning is equal to zero. T02 as a TU has a size of 16×16 pixels, and the depth of the TU partitioning is equal to 1. T03 as a TU has a size of 8×8 pixels, and the depth of the TU partitioning is equal to 2.

What kind of block partitioning is to be performed to set the blocks, such as the CU, the PU, and the TU, in the image is typically decided on the basis of comparison of the costs that affect the encoding efficiency. For example, an encoder compares the costs between one CU with 2M×2M pixels and four CUs with M×M pixels, and if the encoding efficiency in setting four CUs with M×M pixels is higher, the encoder decides to partition the CU with 2M×2M pixels into four CUs with M×M pixels.

### <Scan Orders of CUs and PUs>

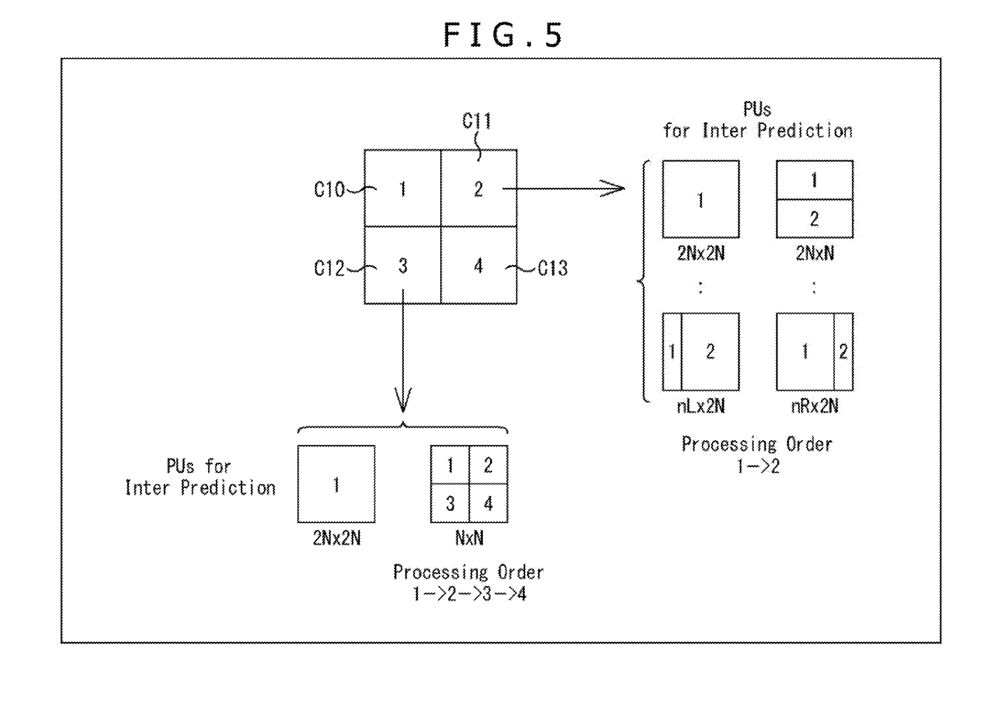

In encoding of an image, the CTBs (or LCUs) set in a grid pattern in the image (or slice or tile) are scanned in a raster scan order. In one CTB, the CUs are scanned from left to right and from top to bottom in the quad-tree. In processing of a current block, information of upper and left adjacent blocks is used as input information. FIG. 5 is an explanatory diagram for describing scanning orders of CUs and PUs. C10, C11, C12, and C13 as four CUs that can be included in one CTB are illustrated on the upper left of FIG. 5. The number in the frame of each CU expresses the processing order. The encoding process is executed in the order of C10 as a CU on the upper left, C11 as a CU on the upper right, C12 as a CU on the lower left, and C13 as a CU on the lower right. One or more PUs for inter prediction that can be set for C11 as a CU are illustrated on the right of FIG. 5. One or more PUs for intra prediction that can be set for C12 as a CU are illustrated at the bottom of FIG. 5. As indicated by the numbers in the frames of the PUs, the PUs are also scanned from left to right and from top to bottom.

In the following description, a “block” will be used as a partial region or a processing unit of an image (picture) in some cases (not a block of processing section). The “block” in this case indicates an arbitrary partial region in the picture, and the size, the shape, the characteristics, and the like are not limited. That is, examples of the “block” in this case include arbitrary partial regions (processing units), such as TU, PU, SCU, CU, LCU (CTB), sub-block, macroblock, tile, and slice.

### <Image Encoding Apparatus>

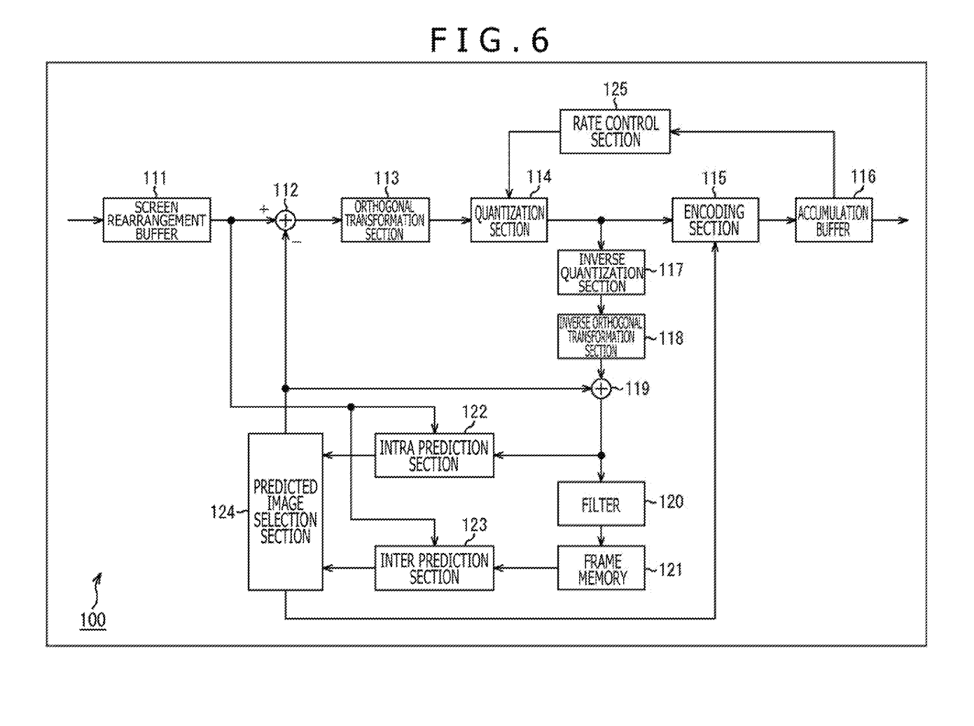

FIG. 6 is a block diagram illustrating an example of a configuration of an image encoding apparatus as an aspect of an image processing apparatus according to the present technique. An image encoding apparatus 100 illustrated in FIG. 6 can use the CABAC to encode image data of moving images as in the AVC and the HEVC. Note that FIG. 6 illustrates main processing sections, flows of data, and the like, and FIG. 6 may not illustrate everything. That is, the image encoding apparatus 100 may include processing sections not illustrated as blocks in FIG. 6, and there may be processes, flows of data, and the like not indicated by arrows and the like in FIG. 6.

As illustrated in FIG. 6, the image encoding apparatus 100 includes a screen rearrangement buffer 111, a computing section 112, an orthogonal transformation section 113, a quantization section 114, an encoding section 115, and an accumulation buffer 116. The image encoding apparatus 100 also includes an inverse quantization section 117, an inverse orthogonal transformation section 118, a computing section 119, a filter 120, a frame memory 121, an intra prediction section 122, an inter prediction section 123, a predicted image selection section 124, and a rate control section 125.

The screen rearrangement buffer 111 stores images of each frame of input image data in the display order, rearranges the stored images of the frames in the order of display to the order of frames for encoding according to a GOP (Group Of Picture), and supplies the images in the rearranged order of frames to the computing section 112. The screen rearrangement buffer 111 also supplies the images in the rearranged order of frames to the intra prediction section 122 and the inter prediction section 123.

The computing section 112 subtracts a predicted image supplied from the intra prediction section 122 or the inter prediction section 123 through the predicted image selection section 124 from an image read from the screen rearrangement buffer 111 to obtain residual information (also referred to as residual data) as a difference between the images. For example, in a case of an image in intra encoding, the computing section 112 subtracts the predicted image supplied from the intra prediction section 122 from the image read from the screen rearrangement buffer 111. In addition, for example, the computing section 112 subtracts the predicted image supplied from the inter prediction section 123 from the image read from the screen rearrangement buffer 111 in a case of an image in inter encoding. The computing section 112 supplies the obtained residual data to the orthogonal transformation section 113.

The orthogonal transformation section 113 uses a predetermined method to perform an orthogonal transformation of the residual data supplied from the computing section 112. The orthogonal transformation section 113 supplies the residual data after the orthogonal transformation (also referred to as orthogonal transformation coefficient) to the quantization section 114.

The quantization section 114 uses a predetermined method to quantize the orthogonal transformation coefficient. The quantization section 114 sets a quantization parameter according to a target value of code amount (target_bitrate) supplied from the rate control section 125 to perform the quantization. The quantization section 114 supplies the residual data after the quantization (also referred to as quantized data) to the encoding section 115 and the inverse quantization section 117.

The encoding section 115 encodes the quantized data supplied from the quantization section 114. The encoding section 115 also acquires information regarding an optimal prediction mode from the predicted image selection section 124. The encoding section 115 can further acquire arbitrary information from an arbitrary processing section. The encoding section 115 encodes these various types of information. In this way, the encoding section 115 encodes information regarding the image to generate encoded data. The encoding section 115 supplies the obtained encoded data to the accumulation buffer 116 to accumulate the encoded data.

The accumulation buffer 116 temporarily holds the encoded data supplied from the encoding section 115. At a predetermined timing, the accumulation buffer 116 outputs, for example, a bit stream or the like of the held encoded data to the outside of the image encoding apparatus 100. For example, the encoded data is transmitted to the decoding side through an arbitrary recording medium, an arbitrary transmission medium, an arbitrary information processing apparatus, or the like. That is, the accumulation buffer 116 is also a transmission section that transmits encoded data.

The inverse quantization section 117 uses a method corresponding to the quantization by the quantization section 114 to perform inverse quantization of the quantized data. The inverse quantization section 117 supplies the quantized data after the inverse quantization (also referred to as orthogonal transformation coefficient) to the inverse orthogonal transformation section 118.

The inverse orthogonal transformation section 118 uses a method corresponding to the orthogonal transformation process by the orthogonal transformation section 113 to perform an inverse orthogonal transformation of the orthogonal transformation coefficient. The inverse orthogonal transformation section 118 supplies the orthogonal transformation coefficient subjected to the inverse orthogonal transformation (also referred to as restored residual data) to the computing section 119.

The computing section 119 adds the predicted image supplied from the intra prediction section 122 or the inter prediction section 123 through the predicted image selection section 124 to the restored residual data to obtain a locally reconstructed image (also referred to as reconstructed image). For example, in the case of the image in intra encoding, the computing section 119 adds the predicted image supplied from the intra prediction section 122 to the restored residual data. In addition, for example, the computing section 119 adds the predicted image supplied from the inter prediction section 123 to the restored residual data in the case of the image in inter encoding. The computing section 119 supplies the obtained reconstructed image to the filter 120 and the intra prediction section 122.

The filter 120 appropriately applies a filtering process, such as, for example, a deblock filter, to the reconstructed image. The filter 120 supplies a filtering process result (referred to as decoded image) to the frame memory 121.

The frame memory 121 stores the decoded image in a storage region of the frame memory 121. The frame memory 121 also supplies the stored decoded image as a reference image to the inter prediction section 123 at a predetermined timing.

The intra prediction section 122 performs intra prediction (prediction in screen) for generating a predicted image by using pixel values in the picture to be processed that is the reconstructed image supplied as a reference image from the computing section 119. For example, the intra prediction section 122 performs the intra prediction in a plurality of intra prediction modes prepared in advance. The intra prediction section 122 generates predicted images in all candidate intra prediction modes and uses the input image supplied from the screen rearrangement buffer 111 to evaluate cost function values of each predicted image to select an optimal mode. After selecting the optimal intra prediction mode, the intra prediction section 122 supplies, to the predicted image selection section 124, intra prediction mode information that is information regarding the intra prediction, such as the predicted image generated in the optimal intra prediction mode and an index indicating the optimal intra prediction mode, the cost function value of the optimal intra prediction mode, and the like that are information regarding the prediction result.

The inter prediction section 123 uses the input image supplied from the screen rearrangement buffer 111 and the reference image supplied from the frame memory 121 to execute an inter prediction process (motion prediction process and compensation process). More specifically, the inter prediction section 123 generates a predicted image (inter predicted image information) by executing a motion compensation process as an inter prediction process according to a motion vector detected by predicting the motion. For example, the inter prediction section 123 performs the inter prediction in a plurality of inter prediction modes prepared in advance. The inter prediction section 123 generates the predicted images in all candidate inter prediction modes. The inter prediction section 123 uses the input image supplied from the screen rearrangement buffer 111, the information of the generated differential motion vector, and the like to evaluate the cost function values of each predicted image to select an optimal mode. After selecting the optimal inter prediction mode, the inter prediction section 123 supplies, to the predicted image selection section 124, inter prediction mode information that is information regarding the inter prediction, such as the predicted image generated in the optimal inter prediction mode, an index indicating the optimal inter prediction mode, and motion information, the cost function value of the optimal inter prediction mode, and the like that are information regarding the prediction result.

The predicted image selection section 124 acquires the information regarding the prediction results from the intra prediction section 122 and the inter prediction section 123. The predicted image selection section 124 selects one of them to select a prediction mode in the region. That is, the predicted image selection section 124 selects one of the intra prediction mode (optimal) and the inter prediction mode (optimal) as an optimal prediction mode. The predicted image selection section 124 supplies the predicted image of the selected mode to the computing section 112 and the computing section 119. The predicted image selection section 124 also supplies part or all of the information regarding the selected prediction result as information regarding the optimal prediction mode to the encoding section 115.

On the basis of the code amount of the encoded data accumulated in the accumulation buffer 116, the rate control section 125 controls the rate of the quantization operation of the quantization section 114 to prevent the occurrence of an overflow or an underflow.

### <Encoding Section>

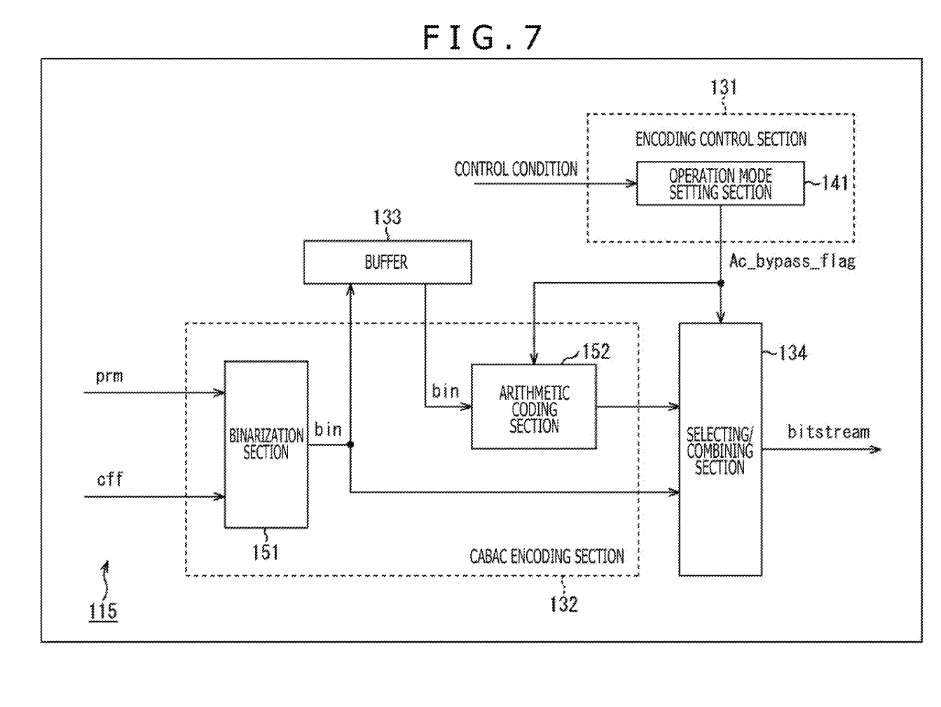

FIG. 7 is a block diagram illustrating a main configuration example of the encoding section 115 of FIG. 6. As illustrated in FIG. 7, the encoding section 115 includes an encoding control section 131, a CABAC encoding section 132, a buffer 133, and a selecting/combining section 134.

The encoding control section 131 executes a process regarding control of encoding by the encoding section 115. The encoding control section 131 includes an operation mode setting section 141. The operation mode setting section 141 sets an operation mode of the encoding section 115 (CABAC encoding section 132 and selecting/combining section 134). For example, the encoding section 115 includes two operation modes including an arithmetic coding mode in which the CABAC encoding section 132 performs so-called CABAC encoding for performing the binarization and the arithmetic coding and a bypass mode in which the CABAC encoding section 132 skips the arithmetic coding and performs only the binarization. The operation mode setting section 141 sets (selects) the operation mode.

The operation mode setting section 141 further generates (sets) flag information (ac_bypass_flag) indicating the set operation mode (operation mode designation information), the information indicating whether to apply arithmetic coding to binary data. That is, the operation mode setting section 141 can serve as a flag information setting section to set the flag information indicating whether to apply arithmetic coding to the binary data including binary information regarding the image. The operation mode setting section 141 then supplies the flag information to the CABAC encoding section 132 and the selecting/combining section 134 to control the operations of the CABAC encoding section 132 and the selecting/combining section 134. The operation mode setting section 141 further supplies the flag information to the selecting/combining section 134 to associate the flag information with the encoded data.

The CABAC encoding section 132 executes a process related to encoding of the information regarding the image. The CABAC encoding section 132 includes a binarization section 151 and an arithmetic coding section 152. The binarization section 151 obtains binary data (bin) by binarizing (Binarization) the information of the parameter (prm) and the coefficient (cff) (that is, information regarding the image) supplied from the quantization section 114 and the like. The binarization section 151 supplies the binary data to the buffer 133 to store (accumulate) the binary data. The binarization section 151 also supplies the binary data as encoded data (bitstream) to the selecting/combining section 134.

The arithmetic coding section 152 executes a process regarding arithmetic coding (Ac) on the basis of the control of the encoding control section 131 (value of flag information (ac_bypass_flag) supplied from the operation mode setting section 141). For example, in the case where the arithmetic coding mode is set, the arithmetic coding section 152 reads the binary data to be processed from the buffer 133 and performs arithmetic coding (Ac) to obtain a bit string. The arithmetic coding section 152 supplies the obtained bit string as encoded data (bitstream) to the selecting/combining section 134. In addition, for example, the arithmetic coding section 152 skips the arithmetic coding process in the case where the bypass mode is set.

That is, on the basis of the flag information set by the operation mode setting section 141, the CABAC encoding section 132 binarizes and applies arithmetic coding to the information regarding the image to generate encoded data (that is, encoded data including binary and arithmetic-coded information regarding the image) or binarizes the information regarding the image to generate encoded data (that is, encoded data including binary information regarding the image).

The selecting/combining section 134 executes a process regarding the selection or the like of the data supplied from the CABAC encoding section 132 on the basis of the control of the encoding control section 131 (value of flag information (ac_bypass_flag) supplied from the operation mode setting section 141). For example, in the case where the arithmetic coding mode is set, the selecting/combining section 134 selects the encoded data including the binary and arithmetic-coded quantized data supplied from the arithmetic coding section 152 and supplies the encoded data to the accumulation buffer 116. In addition, for example, the selecting/combining section 134 selects the encoded data including the binary quantized data supplied from the binarization section 151 and supplies the encoded data to the accumulation buffer 116 in the case where the bypass mode is set. As a result, the encoded data can be transmitted to the decoding side.

The selecting/combining section 134 further associates the flag information (ac_bypass_flag) supplied from the operation mode setting section 141 with the encoded data. For example, the selecting/combining section 134 combines (adds) the flag information so as to store the flag information at a predetermined location of the encoded data (for example, so as to include the flag information in the slice header or the like) and supplies the flag information to the accumulation buffer 116. As a result, the flag information (ac_bypass_flag) can be transmitted to the decoding side. That is, the encoding section 115 can cause the decoding side to decode the encoded data on the basis of the flag information. Therefore, the encoding section 115 can cause the decoding side to properly decode the encoded data. The encoding section 115 can also cause the decoding side to improve the throughput of decoding.

Note that “combine” denotes grouping of the flag information and the encoded data of the quantized data that is information regarding the image (information of parameter (prm) and coefficient (cff)). In the present specification, an arbitrary expression with similar meaning, such as, for example, “multiplex,” “add,” “integrate,” “include,” “store,” “put in,” “place into,” and “insert,” is used in some cases in place of “combine.”

### <Comparison of Throughput>

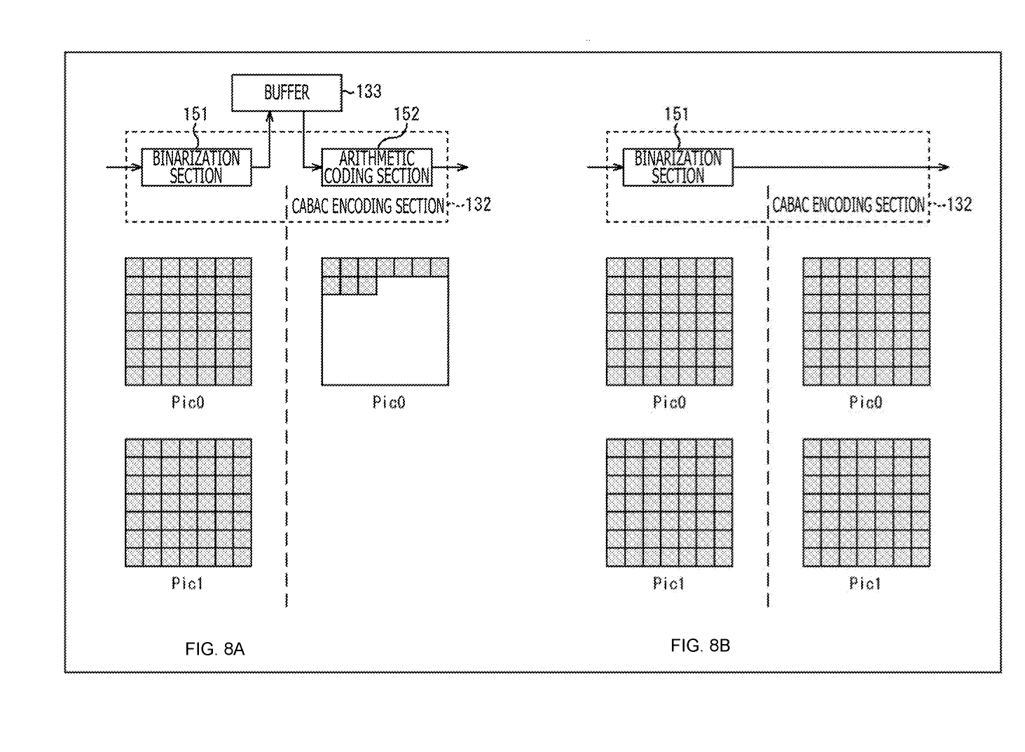

As described, in the case of the arithmetic coding mode, the binarization process by the binarization section 151 and the arithmetic coding process by the arithmetic coding section 152 are applied to the information regarding the image in the CABAC encoding section 132 as illustrated in the upper part of A of FIG. 8. That is, the CABAC encoding section 132 uses the so-called CABAC encoding system to encode the information regarding the image. Therefore, in the case of the mode, the encoding efficiency (compression ratio) is higher than in the case of the bypass mode.

However, the load of the arithmetic coding process is larger than in the binarization process, and the processing time is also longer. Therefore, in the case of the mode, the throughput (amount of processing) of the CABAC encoding section 132 may be reduced compared to the case of the bypass mode. For example, if the throughput is too low in a case where moving images are instantaneously (in real time) encoded, the encoding process may not catch up with the rate of the moving images, and the encoding process may fail. If the encoding process fails, there may be a lack of data or the like, and the image quality of the decoded images may be reduced. To improve the throughput of the arithmetic coding process, a plurality of arithmetic coding processes can be executed in parallel, for example. However, in that case, the circuit scale and the load may increase, and the cost may increase.

In addition, the processing time of the arithmetic coding process is longer than the binarization process, and the buffer 133 for holding the binary data is necessary. For example, as indicated by gray rectangles in A of FIG. 8, even when the binarization section 151 finishes processing all CUs in a picture 0 (Pic0) and a picture 1 (Pic1), the arithmetic coding section 152 may still be processing the CUs in the middle of the picture 0. Therefore, the binary data obtained in the binarization process needs to be held in the buffer 133. Furthermore, the processing time of the arithmetic coding process depends on the image, and variations (fluctuations) in the processing time are large. Therefore, the capacity of the buffer 133 needs to be sufficiently large, and this may increase the cost.

On the other hand, in the case of the bypass mode, only the binarization process by the binarization section 151 is applied to the information regarding the image in the CABAC encoding section 132 as illustrated in the upper part of B of FIG. 8. Therefore, in the case of the mode, the code amount is approximately 33% greater than in the case of the arithmetic coding mode. That is, the encoding efficiency (compression ratio) is reduced. However, in a case of, for example, context-adaptive variable length coding (CAVLC), the code amount is approximately 20% greater than in the CABAC. That is, the encoding process of the bypass mode can also attain a compression ratio on a level sufficiently meaningful for image encoding.

Then, the arithmetic coding process is skipped in the case of the mode, and the output of the binarization section 151 obviously becomes the output of the CABAC encoding section 132 as indicated by gray rectangles in B of FIG. 8. This can suppress the reduction in the throughput caused by the arithmetic coding section 152. Therefore, the throughput of the CABAC encoding section 132 can be the same as the throughput of the binarization section 151, and the throughput can be improved compared to the case of the arithmetic coding mode. As a result, the failure of the encoding process can be suppressed, and the reduction in the image quality of the decoded image can be suppressed. In addition, in the case of the mode, the circuit scale and the load do not have to be increased unlike in the method of executing a plurality of arithmetic coding processes in parallel, and the buffer 133 is also unnecessary. Therefore, the cost can be reduced.

### <Comparison of Delay (Latency)>

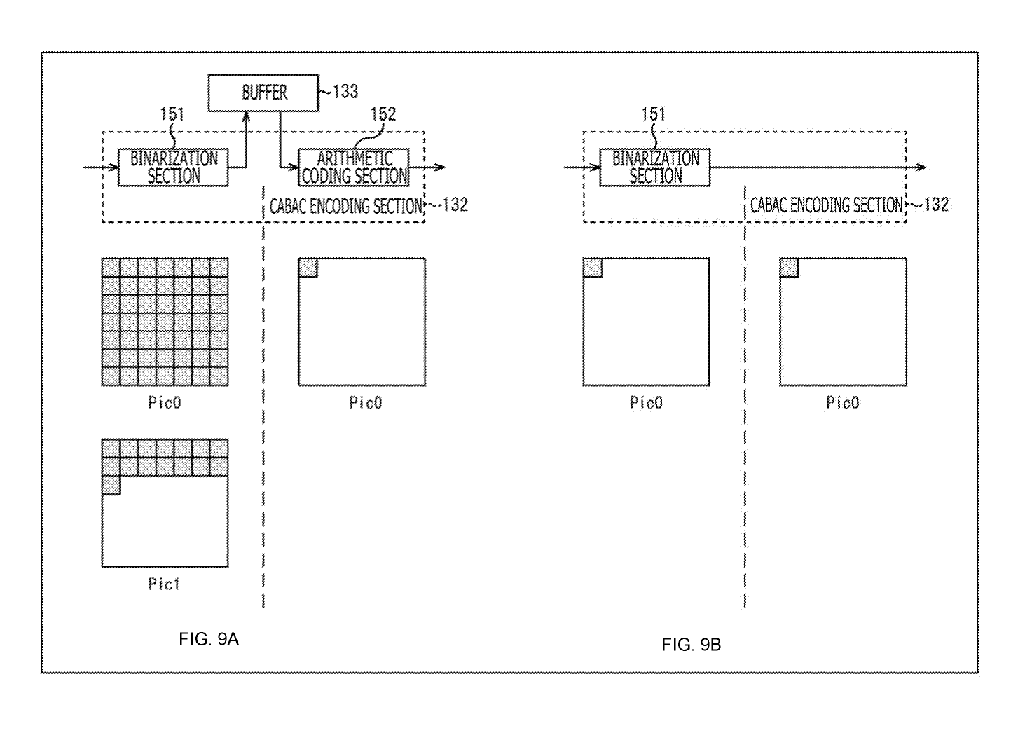

In addition, in the case of the arithmetic coding mode, the processing time of the arithmetic coding process by the arithmetic coding section 152 is longer than in the processing time of the binarization process by the binarization section 151, and the delay (latency) in the encoding process by the CABAC encoding section 132 may be greater than in the case of the bypass mode. For example, as indicated by gray rectangles in A of FIG. 9, the arithmetic coding section 152 may still be executing the first CU of the picture 0 when the binarization section 151 is processing the CUs of the picture 1 (Pic1), and there may be a delay.

For example, in a case of a video conference system, a terminal apparatus A takes images of a user, encodes the image data, and transmits the encoded data to a terminal apparatus B at another location. The terminal apparatus B decodes the transmitted encoded data and displays the decoded images on a monitor. The process is executed in real time in both directions, and a user A of the terminal apparatus A and a user B of the terminal apparatus B can view the images of each other and talk to each other as if the users A and B are in the same location. In the case of the system, the time (time lag) from the imaging to the display needs to be reduced to improve the usability (operability) of the user. Therefore, the delay (latency) caused by encoding and decoding also needs to be reduced.

In this way, if the delay occurs in the system in which the processing delay is not allowed (restriction on delay is strict), the process may fail due to the delay (or realization of the system may become difficult). The failure of the process may reduce not only the image quality of the decoded images due to a lack of data or the like, but also the usability (operability) of the user.

On the other hand, the arithmetic coding process is skipped in the case of the bypass mode, and there is obviously no delay caused by the arithmetic coding process. That is, for example, the data output timing of the binarization section 151 becomes the output timing of the CABAC encoding section 132 as indicated by gray rectangles in B of FIG. 9. Therefore, in the case of the mode, the increase in the delay can be suppressed more than in the case of the arithmetic coding mode. Therefore, the failure of the process caused by the delay can be suppressed, and the system requiring a low delay can be more easily realized.

### <Control of Operation Mode>

In addition, the operation mode setting section 141 can control the operation mode (switch the arithmetic coding mode and the bypass mode) as described above. Therefore, the operation mode setting section 141 can select an appropriate one of the arithmetic coding mode and the bypass mode with different features in accordance with the situation as described above. That is, the operation mode setting section 141 can select and set an optimal mode among a plurality of operation modes with different features in accordance with the situation (such as control condition). Therefore, the encoding section 115 can suppress an unnecessary reduction in the encoding efficiency and can improve the throughput of encoding.

### <Flow of Image Encoding Process>

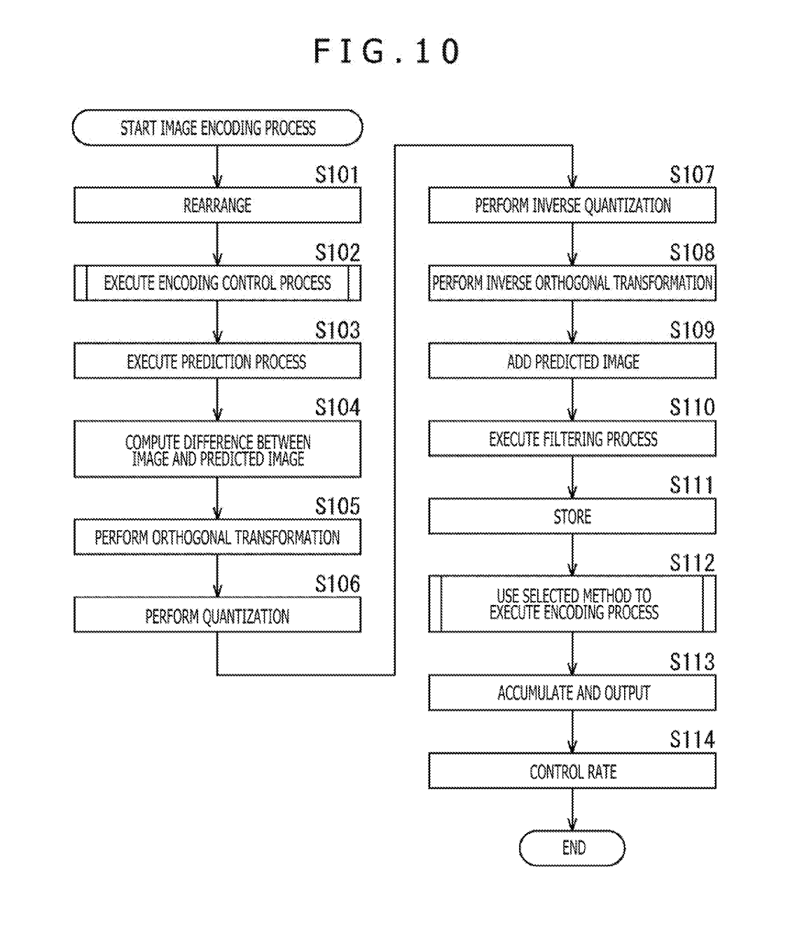

Next, an example of a flow of each process executed by the image encoding apparatus 100 will be described. First, an example of a flow of an image encoding process will be described with reference to a flow chart of FIG. 10.

Once the encoding process is started, the screen rearrangement buffer 111 stores images of each frame (picture) of input moving images in the order of display and rearranges the images from the order of display of each picture to the order of encoding in step S101.

In step S102, the encoding section 115 executes an encoding control process and executes a process regarding control of the encoding process. For example, the encoding section 115 selects the operation mode (for example, arithmetic coding mode or bypass mode) of the encoding process for the information regarding the image in the encoding control process. The encoding section 115 executes the encoding control process (sets the operation mode) for, for example, each slice of the image.

In step S103, the intra prediction section 122, the inter prediction section 123, and the predicted image selection section 124 execute a prediction process and generates a predicted image or the like of the optimal prediction mode. That is, in the prediction process, the intra prediction section 122 performs intra prediction to generate a predicted image or the like of the optimal intra prediction mode, and the inter prediction section 123 performs inter prediction to generate a predicted image or the like of the optimal inter prediction mode. The predicted image selection section 124 selects an optimal one of the optimal intra prediction mode and the optimal inter prediction mode on the basis of the cost function value or the like.

In step S104, the computing section 112 computes a difference between the input image with the frame order rearranged in the process of step S101 and the predicted image of the optimal mode selected in the prediction process of step S103. That is, the computing section 112 generates residual data of the input image and the predicted image. The amount of data of the residual data obtained in this way is smaller than the original image data. Therefore, the amount of data can be compressed more than in the case of just encoding the image.

In step S105, the orthogonal transformation section 113 performs an orthogonal transformation of the residual data obtained in the process of step S104.

In step S106, for example, the quantization section 114 uses a quantization parameter calculated by the rate control section 125 to quantize the orthogonal transformation coefficient obtained in the process of step S105.

In step S107, the inverse quantization section 117 performs inverse quantization of the quantized data obtained in the process of step S106 on the basis of characteristics corresponding to the characteristics of the quantization in step S106.

In step S108, the inverse orthogonal transformation section 118 uses a method corresponding to the orthogonal transformation of step S105 to perform inverse orthogonal transformation of the orthogonal transformation coefficient obtained in the process of step S107.

In step S109, the computing section 119 adds the predicted image obtained in the prediction process of step S103 to the residual data restored in the process of step S108 to generate image data of a reconstructed image.

In step S110, the filter 120 applies a filtering process, such as a deblocking filter, to the image data of the reconstructed image obtained in the process of step S109.

In step S111, the frame memory 121 stores the locally decoded image obtained in the process of step S110.

In step S112, the encoding section 115 uses a method according to the processing result of step S102 to apply an encoding process to the information regarding the image. That is, the encoding section 115 encodes the information regarding the image, such as quantized data, obtained in the process of step S106 in the operation mode (for example, arithmetic coding mode or bypass mode) selected in the encoding control process of step S102.

In step S113, the accumulation buffer 116 accumulates the encoded data or the like obtained in the process of step S112. The encoded data or the like accumulated in the accumulation buffer 116 is appropriately read as, for example, a bit stream and transmitted to the decoding side through a transmission path or a recording medium.

In step S114, on the basis of the code amount (generated code amount) of the encoded data or the like accumulated in the accumulation buffer 116 in the process of step S113, the rate control section 125 controls the rate of the quantization process of step S106 to prevent the occurrence of an overflow or an underflow.

Once the process of step S114 is finished, the image encoding process ends.

Note that the processing units of the respective processes are arbitrary and may not be the same. Therefore, the process of each step can be appropriately executed in parallel with the process of another step or the like or can be executed by switching the processing order.

### <Encoding Control Process>

Next, the encoding control process executed in step S102 of FIG. 10 will be described. In the encoding control process, the encoding control section 131 (operation mode setting section 141) sets the operation mode of the encoding section 115 (CABAC encoding section 132 and selecting/combining section 134). For example, the operation mode setting section 141 can set the operation mode on the basis of the control condition. In this way, the operation mode setting section 141 can appropriately improve the throughput of encoding according to the control condition.

The supply source of the control condition is arbitrary. For example, another processing section in the image encoding apparatus 100 may supply the control condition. In addition, information input by another apparatus outside of the image encoding apparatus 100, the user, or the like may be the control condition. In addition, the details of the control condition are arbitrary. For example, the control condition may include information regarding the encoding of the image. By setting the operation mode on the basis of the information regarding the encoding of the image, the operation mode setting section 141 can appropriately improve the throughput of the encoding according to the situation and the like of the encoding of the image.

Although the information regarding the encoding of the image may be any information, the information may include, for example, information regarding the throughput of the encoding of the image. By setting the operation mode on the basis of the information regarding the throughput, the operation mode setting section 141 can appropriately improve the throughput according to the situation and the like of the throughput of the encoding.

### <Flow of Encoding Control Process (Bit Generation Amount)>

The information regarding the throughput may be any information, and for example, the information may include information regarding the code amount generated by encoding (also referred to as bit generation amount). An example of a flow of the encoding control process in this case will be described with reference to a flow chart of FIG. 11.

In this case, once the encoding control process is started, the operation mode setting section 141 acquires the information regarding the bit generation amount as a control condition in step S121 and determines whether the bit generation amount is large or small on the basis of the information regarding the bit generation amount.

The information regarding the bit generation amount may be any information. For example, the information regarding the bit generation amount may include information indicating the most recent bit generation amount, may include information indicating an expected bit generation mount, may include information indicating an upper limit of the expected bit generation amount, or may include information indirectly indicating the bit generation amount, such as, for example, a slice type. In addition, the information regarding the bit generation amount may include a plurality of types of information.

In addition, the method of determining whether the bit generation amount is large or small is arbitrary. That is, how to use the information regarding the bit generation amount and how to determine whether the bit generation amount is large or small may be determined. For example, the information regarding the bit generation amount may be compared with a threshold, and whether the bit generation amount is large or small may be determined on the basis of the comparison result. In this case, the threshold may be a fixed value or may be a variable value. In addition, the threshold may be calculated by some kind of computation. For example, the threshold may be set according to the situation of encoding, such as on the basis of a value of a certain parameter. In addition, a plurality of thresholds may be set. In addition, instead of the comparison with the threshold, whether the bit generation amount is large or small may be determined by a value of a certain parameter included in the information regarding the bit generation amount. For example, whether the bit generation amount is large or small may be determined by the slice type. Note that whether the bit generation amount is large or small may be determined by values of a plurality of parameters.

If the operation mode setting section 141 determines that the bit generation amount is large (that is, further increase in the bit generation amount is not allowed, or the bit generation amount needs to be suppressed) on the basis of an arbitrary method, the process proceeds to step S122. In this case, the improvement in the encoding efficiency (compression ratio) is prioritized. Therefore, the operation mode setting section 141 selects the arithmetic coding mode as the operation mode in step S122. Then, in step S123, the operation mode setting section 141 sets the value of the flag information (ac_bypass_flag) indicating whether to bypass the arithmetic coding of the binary data to a value “0” (ac_bypass_flag=0) indicating that the arithmetic code is to be performed. In other words, the case where the value of the flag information is “0” indicates that the arithmetic coding mode is selected. The flag information is supplied to the arithmetic coding section 152 and the selecting/combining section 134. When the process of step S123 is finished, the encoding control process ends, and the process returns to FIG. 10.

Furthermore, if the operation mode setting section 141 determines that the bit generation amount is not large in step S121 (that is, an increase in the bit generation amount is allowed), the process proceeds to step S124. In this case, the improvement in the throughput is prioritized. Therefore, the operation mode setting section 141 selects the bypass mode as the operation mode in step S124. Then, in step S125, the operation mode setting section 141 sets the value of the flag information (ac_bypass_flag) to a value “1” (ac_bypass_flag=1) indicating that the arithmetic coding is to be skipped. In other words, the case where the value of the flag information is “1” indicates that the bypass mode is selected. The flag information is supplied to the arithmetic coding section 152 and the selecting/combining section 134. When the process of step S125 is finished, the encoding control process ends, and the process returns to FIG. 10.

The encoding control process is executed in this way, and the operation mode setting section 141 can appropriately improve the throughput on the basis of the situation of the bit generation amount or the like. Therefore, the operation mode setting section 141 can improve the throughput while preventing an inconvenience, such as a failure in the encoding process due to an excessive increase in the bit generation amount.

### <Flow of Encoding Control Process (Processing Time)>

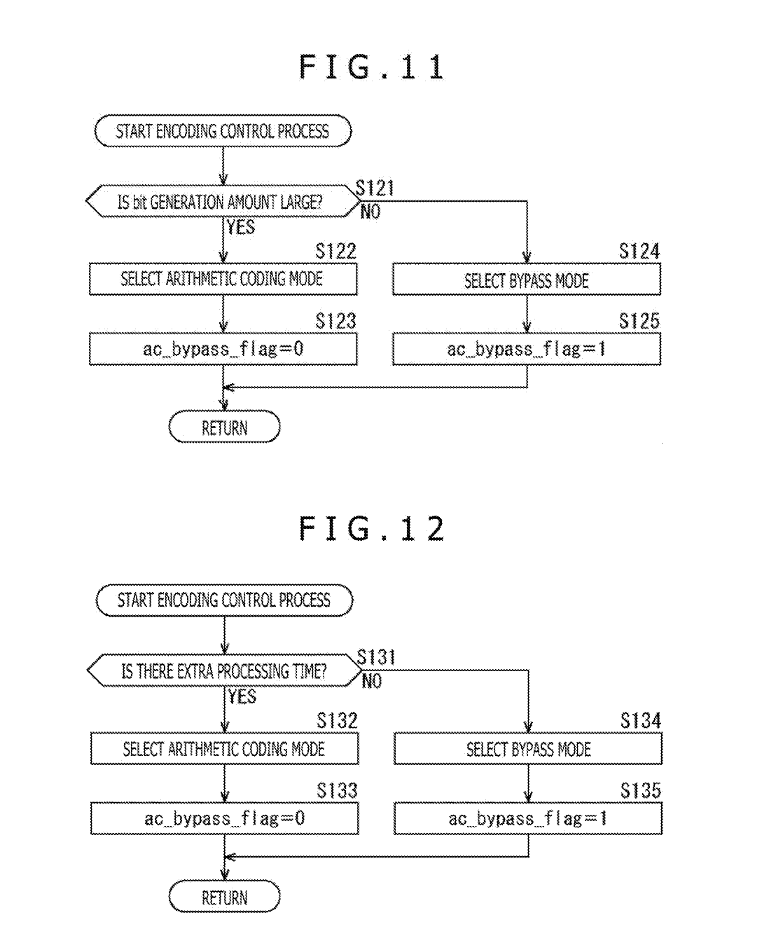

In addition, the information regarding the throughput may include, for example, information regarding the processing time of encoding. An example of a flow of the encoding control process in this case will be described with reference to a flow chart of FIG. 12.

In this case, once the encoding control process is started, the operation mode setting section 141 acquires the information regarding the processing time as a control condition and determines whether or not there is extra processing time on the basis of the information regarding the processing time in step S131.

The information regarding the processing time may be any information. For example, the information regarding the processing time may include information indicating the upper limit of the processing time allowed for encoding, may include information indicating expected processing time of encoding, or may include information indicating a comparison result of the expected processing time of encoding and the upper limit of the processing time allowed. In addition, the information regarding the processing time may include, for example, information indirectly indicating the processing time or the like, such as information indicating the amount of data (also referred to as amount of buffer) of the binary data accumulated in the buffer 133, prediction of increase or decrease in the amount of buffer, and the free space of the buffer 133. In addition, the information regarding the processing time may include a plurality of types of information.

In addition, the method of determining whether or not there is extra processing time is arbitrary. That is, how to use the information regarding the processing time and how to determine whether or not there is extra processing time may be determined. For example, the information regarding the processing time may be compared with a threshold to determine whether or not there is extra processing time on the basis of the comparison result. In this case, the threshold is arbitrary as in the case of the bit generation amount described above. In addition, instead of the comparison with the threshold, whether or not there is extra processing time may be determined by a value of a certain parameter included in the information regarding the processing time, or whether or not there is extra processing time may be determined by values of a plurality of parameters.

If the operation mode setting section 141 determines that there is extra processing time (that is, an increase in the processing time of encoding is allowed) on the basis of an arbitrary method, the process proceeds to step S132. In this case, the improvement in the encoding efficiency (compression ratio) is prioritized. Therefore, the operation mode setting section 141 selects the arithmetic coding mode as the operation mode in step S132. Then, in step S133, the operation mode setting section 141 sets the value of the flag information (ac_bypass_flag) to the value “0” (ac_bypass_flag=0) indicating that the arithmetic coding is to be performed. The flag information is supplied to the arithmetic coding section 152 and the selecting/combining section 134. When the process of step S133 is finished, the encoding control process ends, and the process returns to FIG. 10.

In addition, if the operation mode setting section 141 determines that there is no extra processing time (that is, further increase in the processing time is not allowed, or the processing time needs to be suppressed) in step S131, the process proceeds to step S134. In this case, the improvement in the throughput is prioritized. Therefore, the operation mode setting section 141 selects the bypass mode as the operation mode in step S134. Then, in step S135, the operation mode setting section 141 sets the value of the flag information (ac_bypass_flag) to the value “1” (ac_bypass_flag=1) indicating that the arithmetic coding is to be skipped. The flag information is supplied to the arithmetic coding section 152 and the selecting/combining section 134. When the process of step S125 is finished, the encoding control process ends, and the process returns to FIG. 10.

The encoding control process is executed in this way, and the operation mode setting section 141 can appropriately improve the throughput on the basis of the situation of the processing time of encoding or the like. Therefore, the operation mode setting section 141 can improve the throughput while preventing an inconvenience, such as generation of an overflow of the buffer 133.

### <Control Condition (Compression Ratio)>

Note that the information regarding the throughput may include, for example, information regarding the compression ratio of encoding. The information regarding the compression ratio may be any information, and for example, the information may include information regarding a target bit rate. In addition, the information regarding the compression ratio may include, for example, information indirectly indicating the compression ratio or the like, such as a quantization parameter. In addition, the information regarding the compression ratio may include a plurality of types of information.

For example, the operation mode setting section 141 may determine, on the basis of an arbitrary method, whether the target bit rate (target_bitrate) obtained by the rate control section 125 is high or low. The operation mode setting section 141 may set the arithmetic coding mode if the operation mode setting section 141 determines that the target bit rate is low (compression ratio is to be increased) and may set the bypass mode if the operation mode setting section 141 determines that the target bit rate is high (compression ratio is to be decreased). In this way, the operation mode setting section 141 can appropriately improve the throughput on the basis of the situation of the compression ratio or the like. Therefore, the operation mode setting section 141 can improve the throughput while attaining the target bit rate.

Note that the method of determining whether the obtained target bit rate is high or low is arbitrary. That is, how to use the information regarding the compression ratio and how to determine whether the target bit rate is high or low may be determined. For example, the information regarding the compression ratio may be compared with the threshold, and whether the target bit rate is high or low may be determined on the basis of the comparison result. In this case, the threshold is arbitrary as in the case of the bit generation amount described above. In addition, instead of the comparison with the threshold, whether the target bit rate is high or low may be determined by a value of a certain parameter included in the information regarding the compression ratio, or whether the target bit rate is high or low may be determined by values of a plurality of parameters.

### <Combination of Control Conditions>

The control conditions may include a plurality of pieces of information regarding the throughput. For example, the control conditions may include at least one of the information regarding the code amount generated by the encoding of the image, the information regarding the compression ratio of the encoding of the image, and the information regarding the processing time of the encoding of the image. Obviously, the control conditions may include other information regarding the throughput.

### <Control Condition (Delay)>

In addition, the information regarding the encoding of the image may include, for example, information regarding the delay (latency) in the encoding of the image. The information regarding the delay may be any information. For example, the information regarding the delay may include information indicating an upper limit of the amount of delay (delay time) allowed in the system or the like, may include information indicating an expected amount of delay, or may include information indicating a comparison result of the expected amount of delay and the upper limit of the amount of delay allowed. In addition, the information regarding the delay may include information indirectly indicating the amount of delay or the like, such as, for example, the slice type. In addition, the information regarding the delay may include a plurality of types of information.

For example, the operation mode setting section 141 may use an arbitrary method to determine whether or not the delay due to the arithmetic coding is allowed on the basis of the information regarding the delay. The operation mode setting section 141 may set the arithmetic coding mode if the operation mode setting section 141 determines that the delay is allowed and may set the bypass mode if the operation mode setting section 141 determines that the delay is not allowed. In this way, the operation mode setting section 141 can appropriately improve the throughput on the basis of the situation of the delay in encoding or the like. Therefore, the operation mode setting section 141 can improve the throughput while suppressing the increase in the delay.

Note that the method of determining whether or not the delay due to the arithmetic coding is allowed is arbitrary. That is, how to use the information regarding the delay and how to determine whether or not the delay is allowed may be determined. For example, the information regarding the delay may be compared with a threshold, and whether or not the delay is allowed may be determined on the basis of the comparison result. In that case, the threshold is arbitrary as in the case of the bit generation amount described above. In addition, instead of the comparison with the threshold, whether or not the delay is allowed may be determined by a value of a certain parameter included in the information regarding the delay, or whether or not the delay is allowed may be determined by values of a plurality of parameters.

### <Flow of Encoding Control Process (Plural Pieces of Information)>

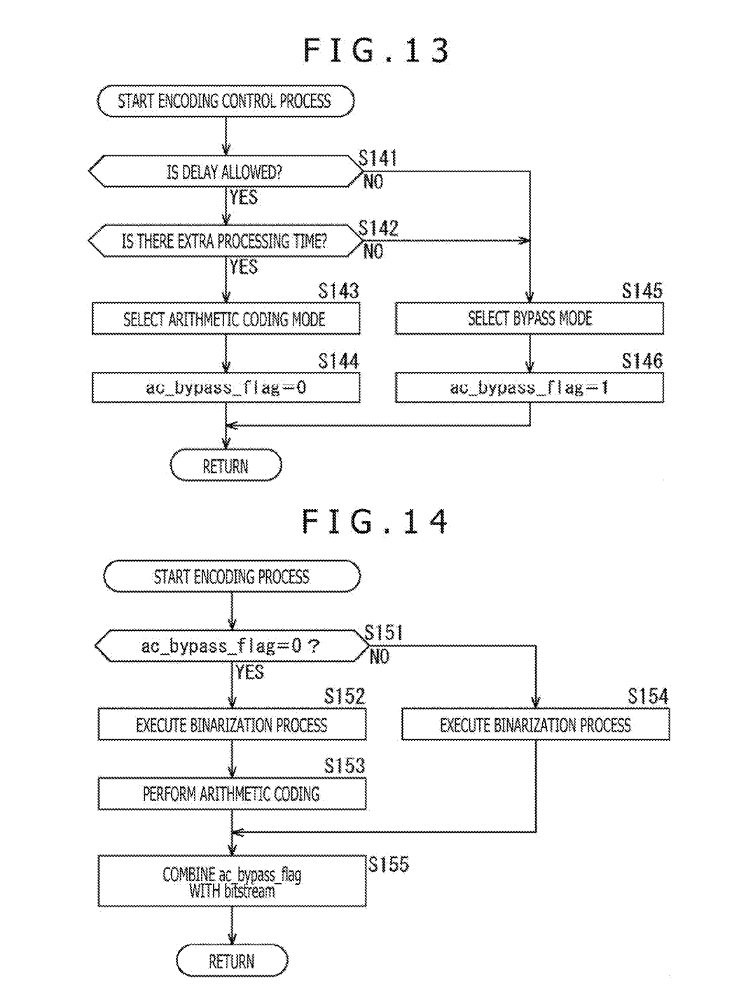

Note that the control conditions may include a plurality of pieces of information. For example, both information regarding the throughput and the information regarding the delay described above may be included in the control conditions. Obviously, a plurality of pieces of information regarding the delay may be included in the control conditions, or other information may be included in the control conditions. For example, the operation mode setting section 141 may set the operation mode on the basis of the information regarding the delay in encoding and the information regarding the processing time of encoding. An example of a flow of the encoding control process in this case will be described with reference to a flow chart of FIG. 13.

In this case, once the encoding control process is started, the operation mode setting section 141 acquires the information regarding the delay in encoding as a control condition and determines whether or not the delay due to the arithmetic coding is allowed on the basis of the information regarding the delay in step S141.

If the operation mode setting section 141 determines that the delay is allowed on the basis of an arbitrary method, the process proceeds to step S142. In step S142, the operation mode setting section 141 further acquires the information regarding the processing time of encoding as a control condition and determines whether or not there is extra processing time on the basis of the information regarding the processing time.

If the operation mode setting section 141 determines that there is extra processing time on the basis of an arbitrary method, the process proceeds to step S143. In this case, the delay is allowed, and there is extra processing time. Therefore, the improvement in the encoding efficiency (compression ratio) is prioritized. Thus, the operation mode setting section 141 selects the arithmetic coding mode as the operation mode in step S143. The operation mode setting section 141 then sets in step S144 the value of the flag information (ac_bypass_flag) to the value “0” (ac_bypass_flag=0) indicating that the arithmetic coding is to be performed. The flag information is supplied to the arithmetic coding section 152 and the selecting/combining section 134. When the process of step S144 is finished, the encoding control process ends, and the process returns to FIG. 10.

In addition, if the operation mode setting section 141 determines that the delay is not allowed in step S141, the process proceeds to step S145. The process also proceeds to step S145 if the operation mode setting section 141 determines that there is no extra processing time in step S142. In this case, the delay is not allowed and/or there is no extra processing time. Therefore, the improvement in the throughput is prioritized. Thus, the operation mode setting section 141 selects the bypass mode as the operation mode in step S145. Then, in step S146, the operation mode setting section 141 sets the value of the flag information (ac_bypass_flag) to the value “1” (ac_bypass_flag=1) indicating that the arithmetic coding is to be skipped. The flag information is supplied to the arithmetic coding section 152 and the selecting/combining section 134. When the process of step S146 is finished, the encoding control process ends, and the process returns to FIG. 10.

The encoding control process is executed in this way, and the operation mode setting section 141 can appropriately improve the throughput on the basis of a plurality of pieces of information. Therefore, for example, the operation mode setting section 141 can suppress the increase in the delay and improve the throughput while preventing an inconvenience, such as generation of an overflow of the buffer 133.

### <Flow of Encoding Process>

Next, an example of a flow of the encoding process executed in step S112 of FIG. 10 will be described with reference to a flow chart of FIG. 14.

Once the encoding process is started, the arithmetic coding section 152 and the selecting/combining section 134 determine in step S151 whether or not the value of the flag information (ac_bypass_flag) indicating whether to bypass the arithmetic coding of the binary data is the value “0” indicating that the arithmetic coding is to be performed.

If the arithmetic coding section 152 and the selecting/combining section 134 determine that the value of the flag information is “0” (ac_bypass_flag=0), the process proceeds to step S152. In this case, the arithmetic coding mode is set as the operation mode in the encoding control process (step S102 of FIG. 10). Therefore, the binarization section 151 applies the binarization process to the information regarding the image and obtains the binary data in step S152. In addition, the arithmetic coding section 152 acquires the binary data through the buffer 133 and applies the arithmetic coding in step S153. When the process of step S153 is finished, the process proceeds to step S155.

In addition, if the arithmetic coding section 152 and the selecting/combining section 134 determine in step S151 that the value of the flag information is the value “1” (ac_bypass_flag=1) indicating that the arithmetic coding is to be skipped, the process proceeds to step S154. In this case, the bypass mode is set as the operation mode in the encoding control process (step S102 of FIG. 10). Therefore, the binarization section 151 applies the binarization process to the information regarding the image and obtains the binary data in step S154. The arithmetic coding is skipped. When the process of step S154 is finished, the process proceeds to step S155.

In step S155, the selecting/combining section 134 combines the flag information (ac_bypass_flag) with the encoded data so as to store the flag information at a predetermined position (for example, slice header) of the encoded data (bitstream).

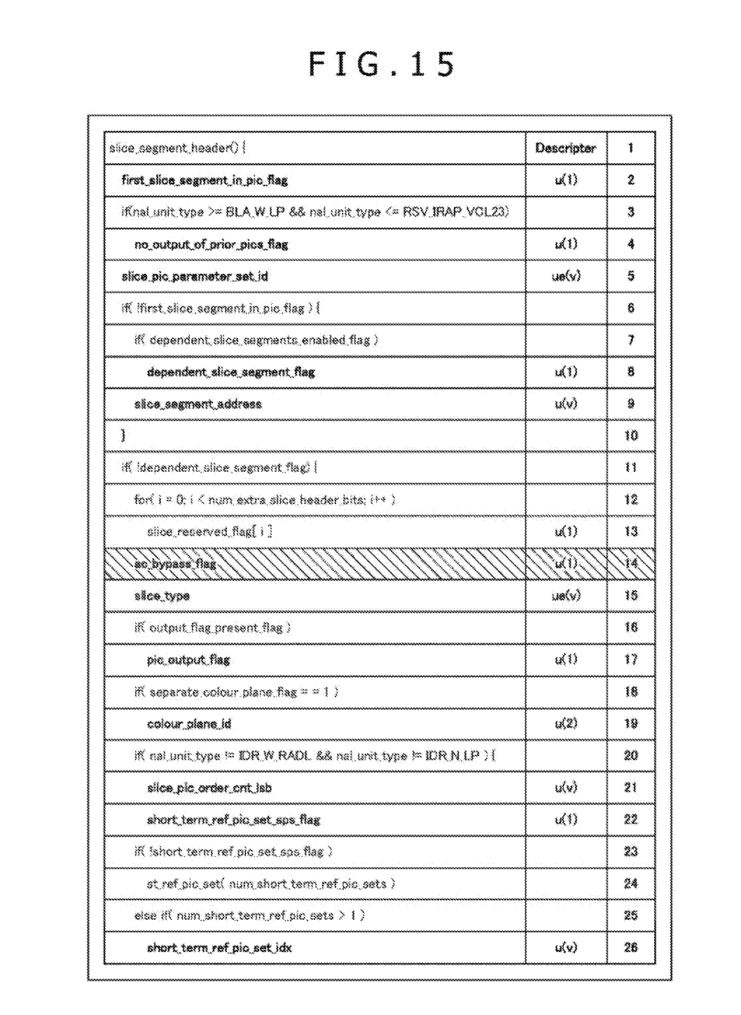

FIG. 15 illustrates an example of syntax of the slice header. In FIG. 15, the numbers on the right end indicate line numbers. In the case of the syntax of the example in FIG. 15, the flag information (ac_bypass_flag) is set in a fourteenth line.

For example, in the case of the CABAC such as HEVC, the learning in the arithmetic coding is initialized for each slice. Therefore, the operation mode can be switched on a slice-by-slice basis (that is, the operation mode can be switched at the timing of the initialization of learning), and the operation mode can be easily switched (arithmetic coding can be easily started and finished).

When the process of step S155 is finished, the encoding process ends, and the process returns to FIG. 10.

The encoding process can be executed in this way, and the encoding section 115 can perform the encoding in the operation mode set in the encoding control process. In addition, the flag information (ac_bypass_flag) can be combined with the encoded data to provide the flag information to the decoding side. That is, the encoding section 115 can cause the decoding side to perform the decoding on the basis of the flag information. Therefore, the encoding section 115 can cause the decoding side to properly decode the encoded data. The encoding section 115 can also cause the decoding side to improve the throughput of the decoding.

### <Control Unit>

Although the operation mode is set for each slice in the description above, the data unit (also referred to as control unit) in controlling the operation mode is arbitrary, and the data unit may be a unit other than the slice. For example, a block, a picture, a GOP, a sequence, a component, or the like may be the control unit. In addition, for example, in a case of multi-view encoding and multi-view decoding that are encoding and decoding of images from a plurality of viewpoints (views) with parallax, the operation mode may be set for each view (that is, the view may be the control unit). In addition, for example, in a case of tier encoding and tier decoding in which the images are tiered into a plurality of tiers (layers) to encode and decode the images, the operation mode may be set for each layer (that is, the layer may be the control unit). Obviously, a plurality of blocks, a plurality of pictures, a plurality of GOPs, a plurality of sequences, a plurality of components, a plurality of views, a plurality of layers, or the like may be the control unit.

In general, the smaller the control unit, the more adaptive the control (switch) of the operation mode. On the other hand, the larger the control unit, the smaller the load of the process regarding the control. In addition, the amount of information of the flag information combined with the encoded data can be reduced, and the reduction in the encoding efficiency can be suppressed.

Note that the control unit may be determined in advance or may be able to be arbitrarily set. Furthermore, the control unit may be able to be changed in the middle of moving images. In the case of setting or updating the control unit, information indicating the set (updated) control unit, information indicating the update of the control unit, information for controlling the setting of the control unit (for example, permission information), or the like may be associated with the encoded data. That is, the information may be provided to the decoding side.

A plurality of control units may be tiered. For example, the operation mode may be controlled for each slice, and the operation mode may also be controlled for each CU. In this way, the operation mode may be controlled in each of a plurality of tiers as control units. In that case, the control of a lower layer may be prioritized.

### <Flow of Encoding Process for Executing Encoding Control Process>

In addition, the encoding control process may be executed at any timing before the encoding process. In addition, for example, the control unit of the operation mode may be brought into line with the processing unit of encoding, and the encoding control process may be executed in the encoding process. For example, the encoding control process may be executed after the binarization process, before the execution of the arithmetic coding.

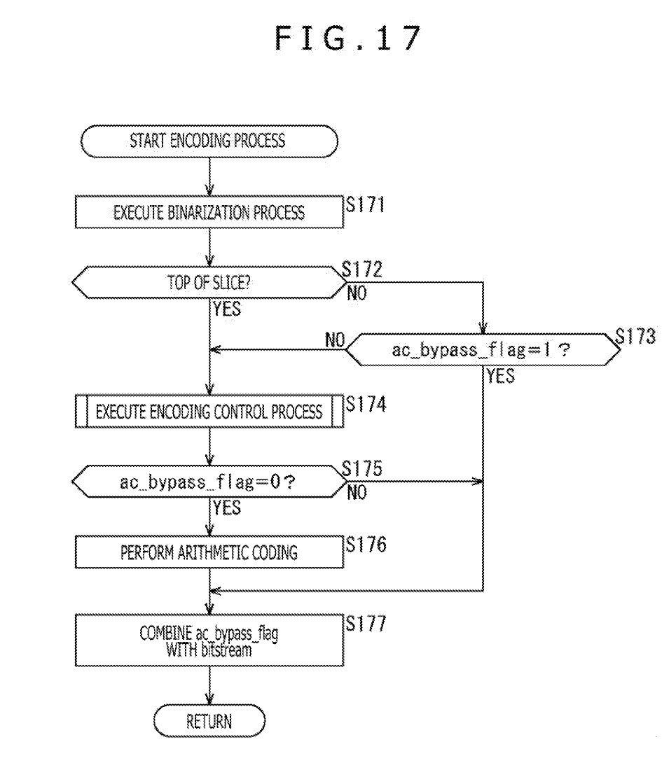

An example of a flow of the encoding process executed in step S112 of FIG. 10 in this case will be described with reference to a flow chart of FIG. 17. Note that in this case, the encoding control process of step S102 in FIG. 10 is skipped.

Once the encoding process is started, the binarization section 151 applies the binarization process to the information regarding the image in step S161 and obtains binary data.

In step S162, the operation mode setting section 141 executes the encoding control process and sets the operation mode to generate flag information (ac_bypass_flag) indicating whether to bypass the arithmetic coding of the binary data. The encoding control process is similar to the process of step S102 in FIG. 10 described above, and for example, the processes as described with reference to the flow charts and the like of FIGS. 11 to 13 are executed.

In step S163, the arithmetic coding section 152 and the selecting/combining section 134 determine whether or not the value of the flag information (ac_bypass_flag) obtained in the process of step S162 is the value “0” indicating that the arithmetic coding is to be performed.

If the arithmetic coding section 152 and the selecting/combining section 134 determine that the value of the flag information is “0” (ac_bypass_flag=0), the arithmetic coding mode is set as the operation mode. Therefore, in this case, the arithmetic coding section 152 acquires the binary data obtained in the process of step S161 through the buffer 133 and applies the arithmetic coding in step S164. When the process of step S164 is finished, the process proceeds to step S165.

In addition, if the arithmetic coding section 152 and the selecting/combining section 134 determine in step S163 that the value of the flag information is the value “1” (ac_bypass_flag=1) indicating that the arithmetic coding is to be skipped, the bypass mode is set as the operation mode. Therefore, the process of step S164 is skipped in this case, and the process proceeds to step S165.

In step S165, the selecting/combining section 134 combines the flag information (ac_bypass_flag) with the encoded data so as to store the flag information at a predetermined position of the encoded data (bitstream).

When the process of step S165 is finished, the encoding process ends, and the process returns to FIG. 10.

The encoding process is executed in this way, and the encoding section 115 can execute the encoding control process after the binarization process. Therefore, the encoding section 115 can reflect the binarization process result on the encoding control process by, for example, setting the operation mode on the basis of the amount of data of the binary data.

### <Control Unit Independent in Each Switch Direction>

Note that the timing (control unit) of switching the operation mode from the arithmetic coding mode to the bypass mode and the timing (control unit) of switching the bypass mode to the arithmetic coding mode may be different from each other. That is, the control unit of the operation mode may be independent in each switch direction.

As described above, the learning is performed in the arithmetic coding process. Therefore, if the operation mode is switched to the arithmetic coding mode (that is, arithmetic coding is started) at a timing different from the timing of the initialization of learning, the control of the arithmetic coding may become more complicated and more difficult. In other words, it is desirable to bring the timing of the initialization of learning into line with the switch timing of the operation mode to easily realize the switch of the direction.

On the other hand, in the case of switching the operation mode to the bypass mode, the arithmetic coding process can be simply stopped to set the binary data as the encoded data, and the control is easy even if the switch does not coincide with the timing of the initialization of learning. That is, the switch in the direction can be easily realized at an arbitrary timing.

Therefore, for example, the bypass mode may be switched to the arithmetic coding mode according to the timing of the initialization of learning of the arithmetic coding, and the arithmetic coding mode may be able to be switched to the bypass mode on the basis of a smaller control unit. For example, in a case where the learning is initialized on the basis of a slice unit, the control unit of the operation mode may be a data unit (for example, CU or the like) smaller than the slice, and the switch from the bypass mode to the arithmetic coding mode may be limited to only the top of the slice. That is, the arithmetic coding mode may also be able to be switched to the bypass mode at parts other than the top of the slice.

Then, the encoding control process can also be executed during the encoding process in this case. An example of a flow of the encoding process in this case will be described with reference to a flow chart of FIG. 17. Note that in this case, the encoding control process of step S102 in FIG. 10 is skipped.

Once the encoding process is started, the binarization section 151 applies the binarization process to the information regarding the image and obtains binary data in step S171.

In step S172, the operation mode setting section 141 determines whether or not the information regarding the image to be processed is information at the top of the slice. If the operation mode setting section 141 determines that the information is not information at the top of the slice, the process proceeds to step S173.

In step S173, the operation mode setting section 141 determines whether or not the value of the current flag information (ac_bypass_flag) is “1” indicating the bypass mode. If the operation mode setting section 141 determines that the current operation mode is the arithmetic coding mode (ac_bypass_flag=0), the next switch of the operation mode is a switch from the arithmetic coding mode to the bypass mode, and the switch is possible even at positions other than the top of the slice. Therefore, the process proceeds to step S174 in this case.

In addition, if the operation mode setting section 141 determines that the information is information at the top of the slice in step S172, the operation mode can be switched regardless of the switch direction. That is, the arithmetic coding mode can be switched to the bypass mode, and the bypass mode can be switched to the arithmetic coding mode. Therefore, the process proceeds to step S174 in this case.

In step S174, the operation mode setting section 141 executes the encoding control process and sets the operation mode to generate flag information (ac_bypass_flag) indicating whether to bypass the arithmetic coding of the binary data. The encoding control process is similar to the process of step S102 in FIG. 10 described above, and for example, the processes as described with reference to the flow charts and the like of FIGS. 11 to 13 are executed.

In step S175, the arithmetic coding section 152 and the selecting/combining section 134 determine whether or not the value of the flag information (ac_bypass_flag) obtained in the process of step S174 is the value “0” indicating that the arithmetic coding is to be performed.

If the arithmetic coding section 152 and the selecting/combining section 134 determine that the value of the flag information is “0” (ac_bypass_flag=0), the arithmetic coding mode is set as the operation mode. Therefore, in this case, the arithmetic coding section 152 acquires the binary data obtained in the process of step S171 through the buffer 133 and applies the arithmetic coding to the binary data in step S176. When the process of step S176 is finished, the process proceeds to step S177.

In addition, if the arithmetic coding section 152 and the selecting/combining section 134 determine in step S175 that the value of the flag information is the value “1” (ac_bypass_flag=1) indicating that the arithmetic coding is to be skipped, the bypass mode is set as the operation mode. Therefore, the process of step S176 is skipped in this case, and the process proceeds to step S177.

In addition, if the operation mode setting section 141 determines that the current operation mode is the bypass mode (ac_bypass_flag=1) in step S173, the next switch of the operation mode is a switch from the bypass mode to the arithmetic coding mode, and the switch is not possible even at positions other than the top of the slice. Therefore, the operation mode is not switched (value of the flag information is not updated) in this case, and the process proceeds to step S177.

In step S177, the selecting/combining section 134 combines the flag information (ac_bypass_flag) with the encoded data so as to store the flag information at a predetermined position of the encoded data (bitstream). Note that if the operation mode setting section 141 determines that the current operation mode is the bypass mode (ac_bypass_flag=1) in step S173, the flag information is not updated, and the flag information may not be combined with the encoded data. That is, the process of step S177 may be skipped in this case.

When the process of step S177 is finished, the encoding process ends, and the process returns to FIG. 10.

The encoding process is executed in this way, and the encoding section 115 can more easily realize adaptive control of the operation mode.

### <Control Conditions According to Control Units>

Various control units can be applied as described above, and information according to the control units may also be applied for the control conditions. For example, in the case where the control unit is a block, the control conditions may include the prediction type (for example, intra, inter, or the like), the size (for example, resolution, aspect ratio, or the like) and the type (for example, I, P, B, or the like) of block, the size and the type of picture, the GOP structure, the type of component, the number of views of multi-view encoding and multi-view decoding, the layers of tier encoding and tier decoding, the number of layers, and the like.

For example, in a case where a data unit higher than the GOP is the control unit, the operation mode may be set according to the GOP structure. For example, in a case where all pictures are I pictures, the code amount is expected to be large. Therefore, the improvement of the encoding efficiency may be prioritized, and the arithmetic coding mode may be selected.

Note that the control conditions may include not only the information of the control unit (such as block and picture) to be processed, but also information of control units near the control unit (temporally and/or spatially near the control unit).

### <Setting of Control Conditions>

Note that the information set as the control conditions may be determined in advance or may be able to be arbitrarily set. Furthermore, the control conditions (information set as the control conditions) may be able to be changed in the middle of moving images. In the case where the control conditions are set or updated, the information indicating the set (updated) control conditions, the information indicating the update of the control conditions, the information for controlling the setting of the control conditions (for example, permission information), and the like may be associated with the encoded data. That is, the information may be provided to the decoding side.

### <Combining Flag Information>

Although the flag information (ac_bypass_flag) indicating whether to bypass the arithmetic coding of the binary data is stored in the slice header of the encoded data in the description above, the storage position of the flag information is arbitrary. For example, the flag information may be stored in a parameter set, such as a sequence parameter set (SPS (Sequence Parameter Set) or PPS (Picture Parameter Set)) and a picture parameter set (PPS (Picture Parameter Set)), or various headers. The flag information may be stored in the information of the same tier as the control unit or may be stored and grouped together with the information of a tier higher than the control unit.

### <Transmission Information>

In addition, although the flag information (ac_bypass_flag) indicating whether to bypass the arithmetic coding of the binary data is transmitted as the information indicating the set operation to the decoding side in the description above, the information transmitted from the encoding side to the decoding side (transmission information) may be any information. For example, the information indicating the set operation mode may be transmitted to the decoding side by using, for example, flag information (slice_reserved_flag) in compliance with the HEVC.

In addition, the encoding section 115 may be able to further execute a plurality of times of arithmetic coding in parallel, and information indicating the number of times of arithmetic coding to be executed may be transmitted as the information indicating the set operation mode to the decoding side. For example, in the information transmitted to the decoding side, a value indicating the number of times of arithmetic coding to be executed may be set in the case of the arithmetic coding mode, and a value “0” may be set in the case of the bypass mode.

Obviously, information other than the information indicating the operation mode may be the transmission information. For example, information indicating the switch of the operation mode may be the transmission information. For example, the operation mode is not updated (the same operation mode is maintained) in a case where the value is “0,” and the operation mode is updated (switched to a different operation mode) in a case where the value is “1.” Such flag information may be transmitted as the transmission information to the decoding side.

### <Configuration of Image Encoding Apparatus>

Although FIGS. 6 and 7 illustrate the main configuration example of the image encoding apparatus 100, the configuration of the image encoding apparatus to which the present technique can be applied is not limited to this.

For example, although the frames are encoded after the frames in the display order are rearranged to the encoding order in the description, the frames may not be rearranged. In that case, the screen rearrangement buffer 111 may be eliminated.

In addition, although the residual data of the input image and the predicted image is encoded in the description, the input image may be encoded without using the predicted image. In that case, the generation of the predicted image can be skipped, and for example, the computing section 112 and the components from the inverse quantization section 117 to the predicted image selection section 124 may be eliminated.

In addition, the method of the orthogonal transformation and the inverse orthogonal transformation is arbitrary. For example, orthogonal transformation and inverse orthogonal transformation, such as discrete cosine transform and Karhunen-Loeve transform, may be performed. In addition, the orthogonal transformation and the inverse orthogonal transformation may be skipped. In that case, the orthogonal transformation section 113 and the inverse orthogonal transformation section 118 may be eliminated.

In addition, the method of the quantization and the inverse quantization is also arbitrary. In addition, the quantization and the inverse quantization may be skipped. In that case, the quantization section 114 and the inverse quantization section 117 may be eliminated.

In addition, the accumulation of the encoded data may be skipped. In that case, the accumulation buffer 116 may be eliminated.

In addition, the filter 120 may execute any filtering process. For example, the filter 120 may use a Wiener filter to execute adaptive loop filter processing to improve the image quality. In addition, for example, the filter 120 may execute sample adaptive offset (SAO) processing to improve the image quality by reducing the ringing caused by a motion compensation filter or correcting the deviation in pixel values that may occur in the decode screen. In addition, other filtering processes may be executed. In addition, a plurality of filtering processes may be executed. In addition, the filtering process may be skipped. In that case, the filter 120 may be eliminated.

In addition, the method of the prediction process of generating the predicted image is arbitrary. A method other than the intra prediction and the inter prediction may be used to generate the predicted image. In addition, the intra prediction may not be performed. In that case, the intra prediction section 122 may be eliminated. In addition, the inter prediction may not be performed. In that case, the inter prediction section 123 may be eliminated.

In addition, the number of prediction processes of generating the predicted image is arbitrary, and the number of prediction processes may be one or may be three or more. For example, the image encoding apparatus 100 may include three or more prediction sections that execute prediction processes by using prediction methods different from each other, and the predicted image selection section 124 may select an optimal one from three or more predicted images generated by the prediction sections.

In addition, the rate may not be controlled. In that case, the rate control section 125 may be eliminated.

In addition, the encoding section 115 may be able to use an arbitrary encoding method other than the CABAC (including the arithmetic coding mode and the bypass mode) to encode the information regarding the image.

### 2. Second Embodiment

### <Image Decoding Apparatus>

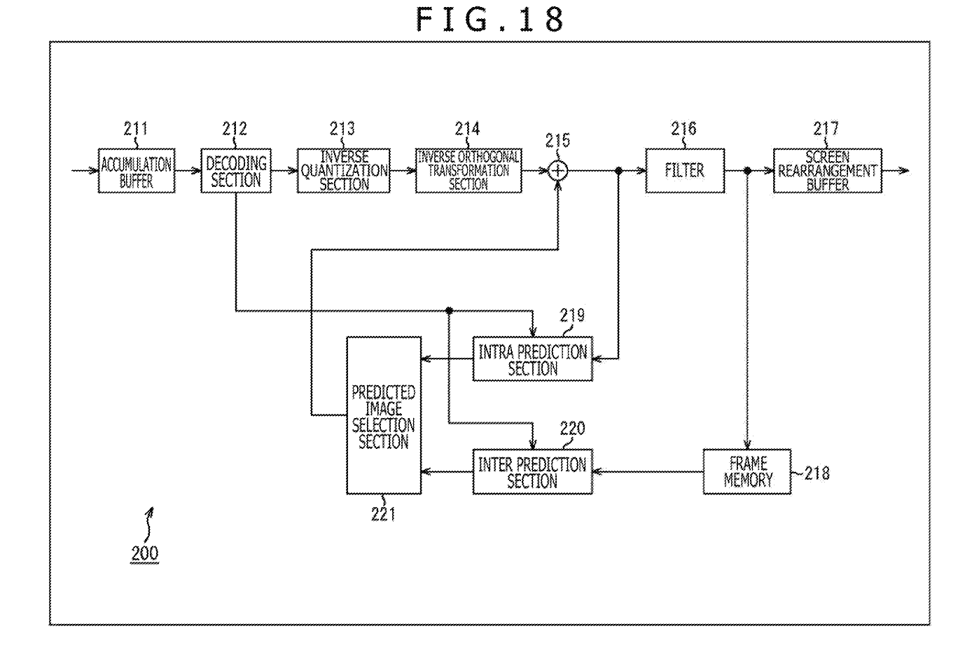

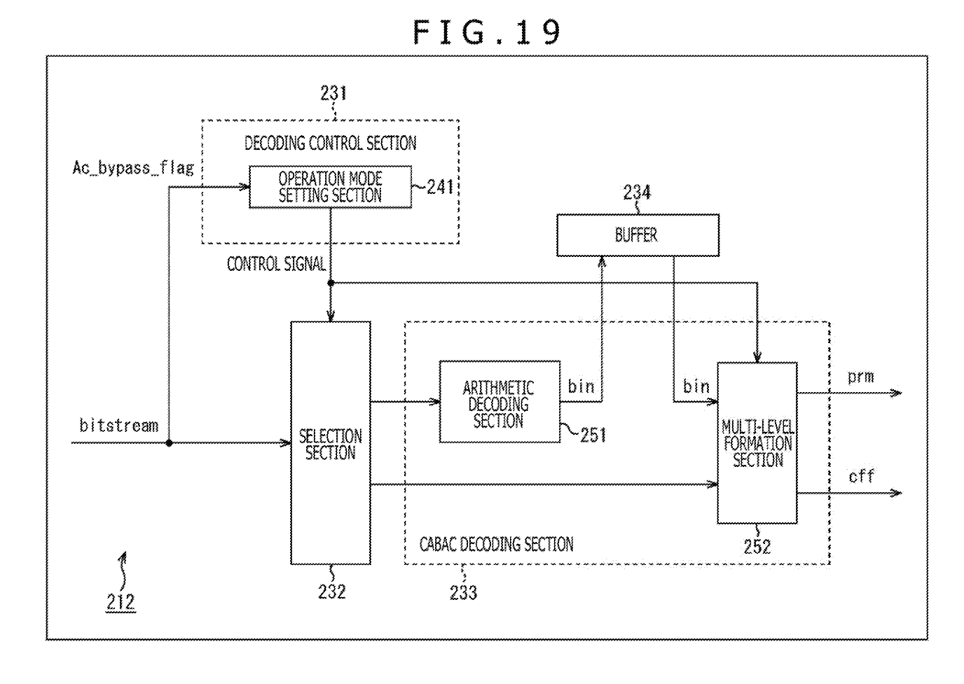

Next, decoding of the encoded data encoded as described above will be described. FIG. 18 is a block diagram illustrating an example of a configuration of an image decoding apparatus as an aspect of the image processing apparatus according to the present technique. An image decoding apparatus 200 illustrated in FIG. 18 is an image decoding apparatus corresponding to the image encoding apparatus 100 of FIG. 6, and the image decoding apparatus 200 uses a decoding method corresponding to the encoding method to decode the encoded data generated by the image encoding apparatus 100. Note that FIG. 18 illustrates main processing sections, flows of data, and the like, and FIG. 18 may not illustrate everything. That is, the image decoding apparatus 200 may include processing sections not illustrated as blocks in FIG. 18, and there may be processes and flows of data not indicated by arrows and the like in FIG. 18.

As illustrated in FIG. 18, the image decoding apparatus 200 includes an accumulation buffer 211, a decoding section 212, an inverse quantization section 213, an inverse orthogonal transformation section 214, a computing section 215, a filter 216, and a screen rearrangement buffer 217. The image decoding apparatus 200 also includes a frame memory 218, an intra prediction section 219, an inter prediction section 220, and a predicted image selection section 221.

Encoded data generated by the image encoding apparatus 100 or the like is supplied as, for example, a bit stream or the like to the image decoding apparatus 200 through, for example, a transmission medium, a recording medium, or the like. The accumulation buffer 211 accumulates the encoded data and supplies the encoded data to the decoding section 212 at a predetermined timing.

The decoding section 212 uses a system (operation mode) corresponding to the encoding system of the encoding section 115 in FIG. 6 to decode the encoded data supplied from the accumulation buffer 211. Once the decoding section 212 decodes the encoded data and obtains quantized data, the decoding section 212 supplies the quantized data to the inverse quantization section 213. The decoding section 212 also supplies information regarding an optimal prediction mode obtained by decoding the encoded data to the intra prediction section 219 or the inter prediction section 220. For example, in the case where the intra prediction is performed, the decoding section 212 supplies information regarding the prediction result of the optimal intra prediction mode to the intra prediction section 219. In addition, for example, in the case where the inter prediction is performed, the decoding section 212 supplies information regarding the prediction result of the optimal inter prediction mode to the inter prediction section 220. Similarly, the decoding section 212 can appropriately supply various types of information obtained by decoding the encoded data to various processing sections that require the information.

The inverse quantization section 213 performs inverse quantization of the quantized data supplied from the decoding section 212. That is, the inverse quantization section 213 uses a system corresponding to the quantization system of the quantization section 114 in FIG. 6 (that is, system similar to the inverse quantization section 117) to perform the inverse quantization. The inverse quantization section 213 supplies an orthogonal transformation coefficient obtained by the inverse quantization to the inverse orthogonal transformation section 214.

The inverse orthogonal transformation section 214 performs an inverse orthogonal transformation of the orthogonal transformation coefficient supplied from the inverse quantization section 213. That is, the inverse orthogonal transformation section 214 uses a system corresponding to the orthogonal transformation system of the orthogonal transformation section 113 in FIG. 6 (that is, system similar to the inverse orthogonal transformation section 118) to perform the inverse orthogonal transformation. The inverse orthogonal transformation section 214 supplies residual data (restored residual data) obtained by the inverse orthogonal transformation process to the computing section 215.

The computing section 215 adds the predicted image supplied from the predicted image selection section 221 to the restored residual data supplied from the inverse orthogonal transformation section 214 to obtain a reconstructed image. The computing section 215 supplies the reconstructed image to the filter 216 and the intra prediction section 219.

The filter 216 executes a filtering process (for example, a deblock filter or the like) similar to the process executed by the filter 120 of FIG. 6. The filter 216 supplies decoded images as filtering process results to the screen rearrangement buffer 217 and the frame memory 218.

The screen rearrangement buffer 217 rearranges the supplied decoded images. That is, the order of frames rearranged for the order of encoding by the screen rearrangement buffer 111 of FIG. 6 is rearranged to the original order of display. The screen rearrangement buffer 217 outputs the decoded image data in the rearranged order of frames to the outside of the image decoding apparatus 200.

The frame memory 218 stores the supplied decoded images. The frame memory 218 also supplies the stored decoded images and the like to the inter prediction section 220 at a predetermined timing or on the basis of a request from the outside such as the inter prediction section 220.

The intra prediction section 219 uses the information regarding the prediction result of the optimal intra prediction mode supplied from the decoding section 212 and the reconstructed image supplied from the computing section 215 to perform intra prediction and generates a predicted image. The intra prediction section 219 supplies the generated predicted image to the predicted image selection section 221.

The inter prediction section 220 uses the information regarding the prediction result of the optimal inter prediction mode supplied from the decoding section 212 and the decoded image supplied from the frame memory 218 to perform inter prediction and generates a predicted image. The inter prediction section 220 supplies the generated predicted image to the predicted image selection section 221.

The predicted image selection section 221 supplies the predicted image supplied from the intra prediction section 219 or the inter prediction section 220 to the computing section 215. For example, in a case where the macroblock to be processed is a macroblock subjected to the intra prediction in the encoding, the intra prediction section 219 performs the intra prediction, and the predicted image (intra predicted image) is generated. Therefore, the predicted image selection section 221 supplies the intra predicted image to the computing section 215. In addition, for example, in a case where the macroblock to be processed is a macroblock subjected to the inter prediction in the encoding, the inter prediction section 220 performs the inter prediction, and the predicted image (inter predicted image) is generated. Therefore, the predicted image selection section 221 supplies the inter predicted image to the computing section 215.

### <Decoding Section>

FIG. 19 is a block diagram illustrating a main configuration example of the decoding section 212. As illustrated in FIG. 19, the decoding section 212 includes a decoding control section 231, a selection section 232, a CABAC decoding section 233, and a buffer 234.

The decoding control section 231 executes a process regarding the control of the decoding by the decoding section 212. The decoding control section 231 includes an operation mode setting section 241. The operation mode setting section 241 sets an operation mode of the decoding section 212 (selection section 232 and CABAC decoding section 233). For example, the decoding section 212 includes two operation modes including an arithmetic decoding mode corresponding to the arithmetic coding mode of the encoding section 115 and a bypass mode corresponding to the bypass mode of the encoding section 115. The arithmetic decoding mode is an operation mode in which the CABAC decoding section 233 performs so-called CABAC decoding for performing arithmetic decoding and multi-level formation. The bypass mode is an operation mode in which the CABAC decoding section 233 skips the arithmetic decoding and performs only the multi-level formation. The operation mode setting section 241 sets (selects) the operation mode.

For example, the operation mode setting section 241 acquires flag information (ac_bypass_flag) associated with the encoded data (bitstream) and indicating whether to perform the arithmetic coding of the binary data and sets the operation mode on the basis of the flag information. For example, the flag information is added to the encoded data, and the operation mode setting section 241 extracts the flag information from the encoded data. As described in the first embodiment, the flag information may be stored at any location of the encoded data. Therefore, for example, the location for storing the flag information may be determined in advance, and the operation mode setting section 241 may extract the flag information from the predetermined position (for example, slice header or the like) of the encoded data determined in advance. In addition, information indicating the location for storing the flag information may be included in the encoded data, and the operation mode setting section 241 may extract the flag information on the basis of the information. Furthermore, the operation mode setting section 241 may uniquely specify the location for storing the flag information on the basis of the situation of decoding, the information regarding the encoded data and the decoded image, or the like and extract the flag information from the location.

In addition, for example, the operation mode setting section 241 supplies a control signal for the control of the operation in the set operation mode to the selection section 232 and the CABAC decoding section 233 to control the operations of the selection section 232 and the CABAC decoding section 233.

The selection section 232 selects the supply destination of the encoded data on the basis of the control of the decoding control section 231 (value of the flag information (ac_bypass_flag) supplied from the operation mode setting section 241). The CABAC decoding section 233 includes an arithmetic decoding section 251 and a multi-level formation section 252. For example, in the case of the control of the operation in the arithmetic decoding mode, the selection section 232 supplies the encoded data to the arithmetic decoding section 251. In addition, for example, in the case of the control of the operation in the bypass mode, the selection section 232 supplies the encoded data to the multi-level formation section 252.

The CABAC decoding section 233 decodes the encoded data in the arithmetic decoding mode or the bypass mode as described above. The arithmetic decoding section 251 executes a process regarding arithmetic decoding (Ac). For example, the arithmetic decoding section 251 performs arithmetic decoding of the encoded data supplied from the selection section 232 to obtain binary data. The encoded data is encoded data obtained by the binarization and the arithmetic coding of the information regarding the image on the encoding side. The arithmetic decoding section 251 supplies the binary data to the buffer 234 to store (accumulate) the binary data.

The multi-level formation section 252 executes a process regarding multi-level formation on the basis of the control of the decoding control section 231 (control signal supplied from the operation mode setting section 241). For example, in the case of the control of the operation in the arithmetic decoding mode, the multi-level formation section 252 reads the binary data to be processed from the buffer 234 and obtains multi-level data of the binary data to obtain information of the parameter (prm) and the coefficient (cff) (that is, information regarding the image). In addition, for example, in the case of the control of the operation in the bypass mode, the multi-level formation section 252 obtains multi-level data of the encoded data supplied from the selection section 232 to obtain the information of the parameter (prm) and the coefficient (cff). The encoded data is encoded data in which the information regarding the image is binarized on the encoding side. The multi-level formation section 252 supplies the obtained information regarding the image to the inverse quantization section 213 and the like.

As in the case of the encoding, the encoding efficiency higher than in the bypass mode can be realized in the case of the arithmetic decoding mode. In addition, as in the case of the encoding, the throughput of decoding can be improved more than in the arithmetic decoding mode in the case of the bypass mode. As a result, the failure of the decoding process can be suppressed, and the reduction in the image quality of the decoded image can be suppressed. In addition, in the case of the mode, the circuit scale and the load do not have to be increased unlike in the method of executing a plurality of arithmetic coding processes in parallel, and the buffer 234 is also unnecessary. Therefore, the cost can be reduced.

In addition, as in the case of the encoding, the increase in the delay can be suppressed more in the case of the bypass mode than in the case of the arithmetic coding mode. Therefore, the failure of the process caused by the delay can be suppressed, and the system requiring a low delay can be more easily realized.

In addition, the operation mode setting section 241 can control the operation mode (switch the arithmetic decoding mode and the bypass mode) as described above. Therefore, as in the case of the encoding, the operation mode setting section 241 can select and set the optimal mode from a plurality of operation modes with different features in accordance with the situation (control condition or the like). Therefore, the decoding section 212 can suppress an unnecessary reduction in the encoding efficiency and can improve the throughput of decoding.

### <Flow of Image Decoding Process>

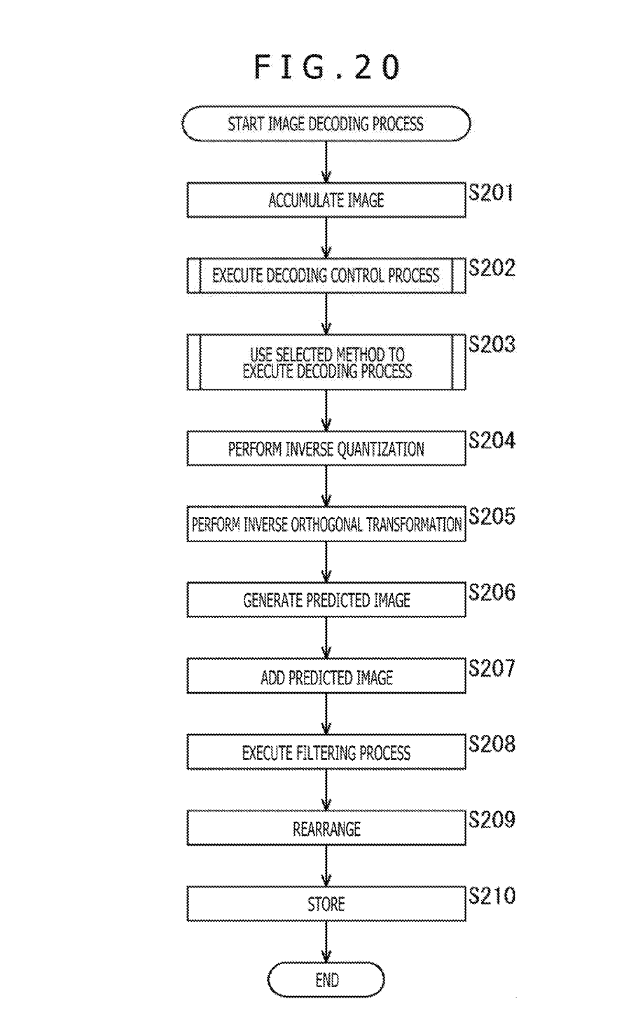

Next, an example of a flow of each process executed by the image decoding apparatus 200 will be described. First, an example of a flow of an image decoding process will be described with reference to a flow chart of FIG. 20.

Once the image decoding process is started, the accumulation buffer 211 accumulates the encoded data supplied to the image decoding apparatus 200 in step S201. In step S202, the decoding section 212 executes a decoding control process and sets (selects) the operation mode of the decoding process.

In step S203, the decoding section 212 uses a method according to the processing result of step S202 to apply a decoding process to the encoded data. That is, the decoding section 212 acquires the encoded data accumulated in the accumulation buffer 211 in the process of step S201 and decodes the encoded data in the operation mode (for example, arithmetic decoding mode or bypass mode) selected in the decoding control process of step S202 to obtain quantized data.

In step S204, the inverse quantization section 213 performs inverse quantization of the quantized data obtained in the process of step S203 and obtains an orthogonal transformation coefficient. In step S205, the inverse orthogonal transformation section 214 performs an inverse orthogonal transformation of the orthogonal transformation coefficient obtained in the process of step S204 and obtains restored residual data.

In step S206, the intra prediction section 219, the inter prediction section 220, and the predicted image selection section 221 execute a prediction process in the prediction mode at the time of the encoding and generates a predicted image. For example, in the case where the macroblock to be processed is a macroblock subjected to the intra prediction in the encoding, the intra prediction section 219 generates an intra predicted image, and the predicted image selection section 221 selects the intra predicted image as the predicted image. In addition, for example, in the case where the macroblock to be processed is a macroblock subjected to the inter prediction in the encoding, the inter prediction section 220 generates an inter predicted image, and the predicted image selection section 221 selects the inter predicted image as the predicted image.

In step S207, the computing section 215 adds the predicted image obtained in the process of step S206 to the restored residual data obtained in the process of step S205 and obtains a reconstructed image.

In step S208, the filter 216 applies a filtering process, such as a deblocking filter, to the reconstructed image obtained in the process of step S207 and obtains decoded images.

In step S209, the screen rearrangement buffer 217 rearranges the decoded images obtained in the process of step S208 and rearranges the order of frames to the original order of display (order before the rearrangement by the screen rearrangement buffer 111 of the image encoding apparatus 100).

In step S210, the frame memory 218 stores the decoded images obtained in the process of step S208. The decoded images are used as reference images in the inter prediction.

When the process of step S210 is finished, the image decoding process ends.

Note that the processing units of the processes are arbitrary, and the processing units may not be the same. Therefore, the processes of the steps may be appropriately executed in parallel with the processes of other steps, or the processes may be executed by switching the processing order.

### <Flow of Decoding Control Process>

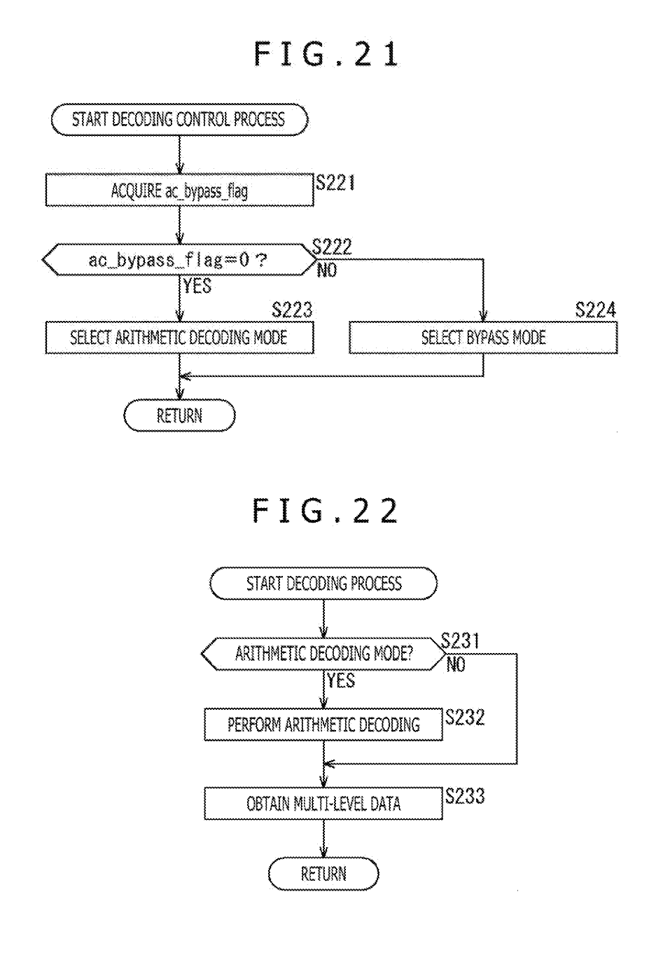

Next, an example of a flow of the decoding control process executed in step S202 of FIG. 20 will be described with reference to a flow chart of FIG. 21.

When the decoding control process is started, the operation mode setting section 241 acquires the flag information (ac_bypass_flag) in step S221. In step S222, the operation mode setting section 241 determines whether or not the value is “0” (ac_bypass_flag=0?).

If the operation mode setting section 241 determines that the value of the flag information is “0” (ac_bypass_flag=0), the process proceeds to step S223. In this case, the arithmetic coding mode is adopted in the encoding. That is, the encoded data to be decoded is encoded data including the binary and arithmetic-coded information regarding the image. Therefore, the operation mode setting section 241 sets the operation mode of the decoding process to the arithmetic decoding mode in step S223. That is, the operation mode setting section 241 performs arithmetic decoding of the encoded data to obtain multi-level data. When the process of step S223 is finished, the decoding control process ends, and the process returns to FIG. 20.

In addition, if the operation mode setting section 241 determines that the value of the flag information is “1” (ac_bypass_flag=1) in step S221 of FIG. 21, the process proceeds to step S224. In this case, the bypass mode is adopted in the encoding. That is, the encoded data to be decoded is encoded data including the binary information regarding the image. Therefore, the operation mode setting section 241 sets the operation mode of the decoding process to the bypass mode in step S224. That is, the operation mode setting section 241 obtains multi-level data of the encoded data. When the process of step S224 is finished, the decoding control process ends, and the process returns to FIG. 20.

The operation mode of the decoding process is controlled in this way, and the operation mode setting section 241 can adaptively control the operation mode of the decoding process according to the value of the flag information (ac_bypass_flag). That is, the operation mode setting section 241 can select the operation mode corresponding to the operation mode of the encoding, and the decoding section 212 can properly decode the encoded data and improve the throughput of the decoding.

### <Flow of Decoding Process>

Next, an example of a flow of the decoding process executed in step S203 of FIG. 20 will be described with reference to a flow chart of FIG. 22.

Once the decoding process is started, the selection section 232 determines whether or not the operation mode set in step S202 of FIG. 20 is the arithmetic decoding mode in step S231. If the selection section 232 determines that the operation mode is the arithmetic decoding mode, the process proceeds to step S232.

In step S232, the arithmetic decoding section 251 performs arithmetic decoding of the encoded data encoded in the arithmetic coding mode (that is, encoded data including the binary and arithmetic-coded information regarding the image) and obtains binary data. When the process of step S232 is finished, the process proceeds to step S233. In this case, the multi-level formation section 252 in step S233 acquires the binary data obtained in the process of step S232 through the buffer 234 and applies a multi-level formation process to the binary data. When the process of step S233 is finished, the decoding process ends, and the process returns to FIG. 20.

In addition, if the selection section 232 determines that the operation mode set in step S202 of FIG. 20 is the bypass mode in step S231, the process of step S232 is skipped, and the process proceeds to step S233. In this case, the multi-level formation section 252 applies a multi-level formation process to the encoded data encoded in the bypass mode (that is, the encoded data including the binary information regarding the image) in step S233. When the process of step S233 is finished, the decoding process ends, and the process returns to FIG. 20.

The decoding process is executed in this way, and the decoding section 212 can decode the encoded data according to the control of the encoding control process (in the set operation mode).

### <Control Unit, Control Condition, and Transmission Information>

In the present embodiment, the control unit, the control condition, and the transmission information transmitted from the encoding side are arbitrary as in the case of the encoding described in the first embodiment.

### <Configuration of Image Decoding Apparatus>

Although FIGS. 18 and 19 illustrate the main configuration example of the image decoding apparatus 200, the configuration of the image decoding apparatus to which the present technique can be applied is not limited to this.

For example, the accumulation of the encoded data may be skipped. In that case, the accumulation buffer 211 may be eliminated.

In addition, the method of inverse quantization by the inverse quantization section 213 is arbitrary as long as the method corresponds to the method of quantization in the encoding. In addition, if the quantization is not performed in the encoding, the inverse quantization can also be skipped. In that case, the inverse quantization section 213 may be eliminated.

In addition, the method of inverse orthogonal transformation by the inverse orthogonal transformation section 214 is arbitrary as long as the method corresponds to the method of orthogonal transformation in the encoding. For example, an inverse orthogonal transformation, such as discrete cosine transform and Karhunen-Loeve transform, may be performed. In addition, if the orthogonal transformation is not performed in the encoding, the inverse orthogonal transformation can also be skipped. In that case, the inverse orthogonal transformation section 214 may be eliminated.

In addition, in a case where the encoded data is obtained by encoding the image to be encoded instead of encoding the residual data of the image to be encoded and the predicted data, the image decoding apparatus 200 can also skip the generation of the predicted image. In that case, for example, the computing section 215 and the components from the frame memory 218 to the predicted image selection section 221 may be eliminated.

In addition, the prediction method in generating the predicted image is arbitrary as long as the method corresponds to the prediction method in the encoding. For example, prediction other than the intra prediction and the inter prediction may be performed. In that case, a new prediction section that performs the prediction may be provided. In addition, for example, one of or both the intra prediction and the inter prediction may be eliminated. In that case, for example, the intra prediction section 219 and the inter prediction section 220 may be eliminated.

In addition, any filtering process may be executed as long as the filtering process corresponds to the filtering process executed in the encoding. In addition, if the filtering process is not executed in the encoding, the filtering process may be skipped. In that case, the filter 216 may be eliminated.

In addition, if the frames in the display order are not rearranged in the encoding, the rearrangement of the frames can also be skipped in the decoding. In that case, the screen rearrangement buffer 217 may be eliminated.

In addition, the decoding section 212 may be able to use an arbitrary decoding method other than the CABAC (including the arithmetic decoding mode and the bypass mode) to decode the encoded data.

### 3. Third Embodiment

### <Control of Operation Mode Setting>

Although the operation mode of encoding and decoding is controlled in the description of the first and second embodiments, the control of the operation mode of encoding and decoding (the setting of the operation mode and the use of the flag information (for example, ac_bypass_flag) indicating the set operation mode) may be controlled. Note that the “use” of the flag information here includes any process regarding the flag information, such as generation of the flag information, supply of the flag information (to the encoding section and the decoding section), and transmission of the flag information from the encoding side to the decoding side.

### <Encoding Section>

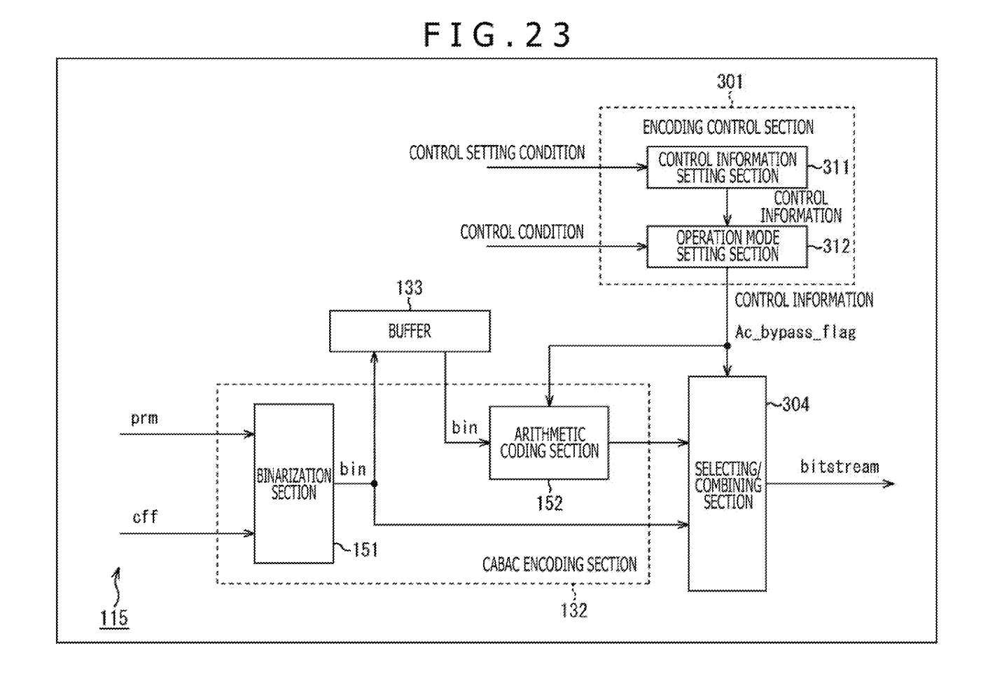

FIG. 23 illustrates a main configuration example of the encoding section 115 of the image encoding apparatus 100 in this case. As illustrated in FIG. 23, the encoding section 115 in this case includes an encoding control section 301, the CABAC encoding section 132, the buffer 133, and a selecting/combining section 304.

The encoding control section 301 executes a process regarding the control of the encoding by the encoding section 115. The encoding control section 301 includes a control information setting section 311 and an operation mode setting section 312. The control information setting section 311 generates control information for controlling the setting of the operation mode (the use of the flag information) by the operation mode setting section 312. For example, the control information setting section 311 generates the control information on the basis of a control setting condition. The supply source of the control setting condition is arbitrary. For example, another processing section in the image encoding apparatus 100 may supply the control setting condition. In addition, information input by another apparatus outside of the image encoding apparatus 100, the user, or the like may be the control setting condition. In addition, the details of the control setting condition are arbitrary. The control information setting section 311 supplies the generated control information to the operation mode setting section 312 to control the setting of the operation mode (the use of the flag information) by the operation mode setting section 312.

The operation mode setting section 312 sets the operation mode according to the control condition under the control of the control information setting section 311. The operation mode setting section 312 further generates (sets), as information indicating the set operation mode (operation mode designation information), flag information (ac_bypass_flag) indicating whether to apply arithmetic coding to the binary data. That is, the operation mode setting section 312 can serve as a flag information setting section to set the flag information indicating whether to apply arithmetic coding to the binary data including the binary information regarding the image. The operation mode setting section 312 then supplies the flag information to the CABAC encoding section 132 (arithmetic coding section 152) and the selecting/combining section 304 to control the operations. The operation mode setting section 312 further supplies the flag information and the control information to the selecting/combining section 304 to associate the flag information and the control information with the encoded data.

As in the case of the selecting/combining section 134, the selecting/combining section 304 executes a process regarding the selection and the like of the data supplied from the CABAC encoding section 132 on the basis of the control of the encoding control section 301 (value of the flag information (ac_bypass_flag) supplied from the operation mode setting section 312).

The selecting/combining section 304 further associates the flag information (ac_bypass_flag) and the control information supplied from the operation mode setting section 312 with the encoded data. For example, the selecting/combining section 304 combines the flag information and the control information at a predetermined location of the encoded data and supplies the data to the accumulation buffer 116. As a result, the flag information (ac_bypass_flag) and the control information can be transmitted to the decoding side. That is, the encoding section 115 can cause the decoding side to decode the encoded data on the basis of the flag information and the control information. Therefore, the encoding section 115 can cause the decoding side to properly decode the encoded data. The encoding section 115 can also cause the decoding side to improve the throughput of decoding. The encoding section 115 can further cause the decoding side to suppress the increase in the load of decoding.

### <Control Information>

The data unit of the control information set by the control information setting section 311 (control unit of the setting of the operation mode) is arbitrary as in the case of the control unit of the operation mode.

In addition, the content of the control information is arbitrary as long as the control information controls the setting of the operation mode (the use of the flag information). For example, the control information may include information that permits (or prohibits) to set the operation mode (use the flag information). For example, an enabled flag (enabled_flag) may be provided as the control information, and the switch of the operation mode may be permitted only in a case where the value of the flag is “1.” In addition, for example, a disabled flag (disabled_flag) may be provided as the control information, and the switch of the operation mode may be prohibited only in a case where the value of the flag is “1.”

In addition, the control information may include, for example, information that permits (or prohibits) to adopt a predetermined operation mode (use the flag information with the value indicating the predetermined operation mode). For example, the information may be information designating the operation mode that can be adopted (or cannot be adopted), or the information may be information designating whether each candidate operation mode can be (or cannot be) adopted.

In addition, the control information may include, for example, information designating a default operation mode (initial value of flag information). For example, in a case where the operation mode is not set (switched) by the operation mode setting section 312, the default operation mode may be set (the flag information with the initial value may be used).

In addition, the control information may include, for example, information designating a range of the data unit (for example, one of or both a smallest value and a largest value) that permits (or prohibits) to set the operation mode (use the flag information). For example, in a case where the control unit of the operation mode is a block, the control information may include information designating the smallest CU size, the largest CU size, and the like that allow to set (or that do not allow to set) the operation mode. That is, in a case where the information is set, the setting of the operation mode (switching of the operation mode) is permitted (prohibited) only with the data unit in the range.

In addition, the control information may include, for example, information designating a range (for example, one of or both a smallest value and a largest value) of the size of the data unit that permits (or prohibits) to adopt a predetermined operation mode (use the flag information with the value indicating the predetermined operation mode). For example, in a case where the control unit of the operation mode is a block, the control information may include information designating the smallest CU size, the largest CU size, and the like that allow to adopt (that do not allow to adopt) the predetermined operation mode. That is, in a case where the information is set, the adoption (designation) of the predetermined operation is permitted (prohibited) only with the data unit in the range. The information may be, for example, information designating the operation mode that can be (or cannot be) adopted and further designating the range of the size of the data unit that permits (or prohibits) to adopt the operation mode. The information may also be information designating the range of the size of the data unit that permits (or prohibits) to adopt each candidate operation mode.

Note that the control information setting section 311 may be able to appropriately set the control information on the basis of data units in a plurality of tiers. For example, the control information setting section 311 may be able to appropriately set the control information for the sequences, the pictures, and the slices. Then, in the case where the control information is set on the basis of the data units in a plurality of tiers, the content of the control information of a lower layer may be prioritized.

### <Flow of Encoding Control Process>

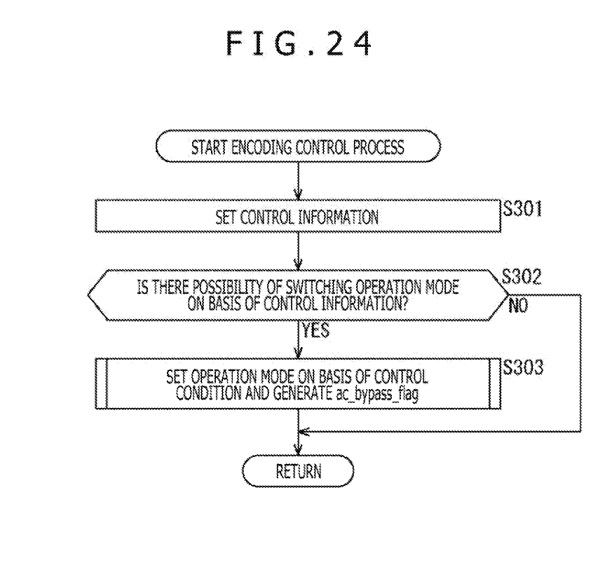

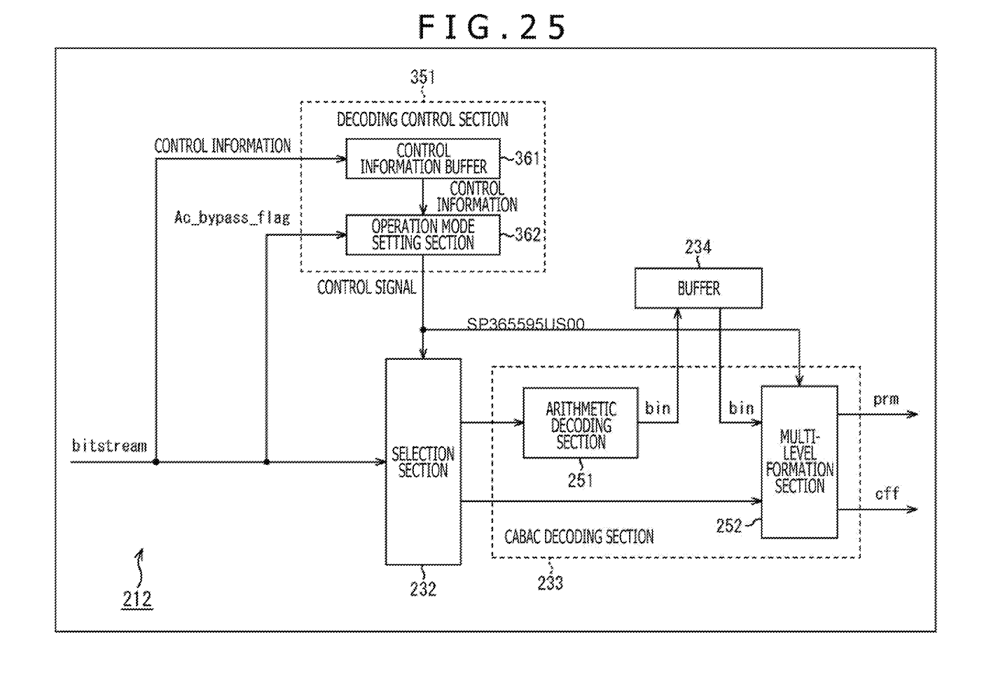

An example of a flow of the encoding control process in this case will be described with reference to a flow chart of FIG. 24. Once the encoding control process is started, the control information setting section 311 sets the control information in step S301.

In step S302, the operation mode setting section 312 determines whether or not there is a possibility of switching the operation mode on the basis of the control information set in step S301. For example, the operation mode setting section 312 determines that there is a possibility of switching the operation mode in the case where the control information permits to set the operation mode (use the flag information) and determines that there is no possibility of switching the operation mode in the case where the control information does not permit to set the operation mode (use the flag information). If the operation mode setting section 312 determines that there is a possibility of switching the operation mode, the process proceeds to step S303.

In step S303, the operation mode setting section 312 executes the encoding control process as described in the first embodiment to set the operation mode on the basis of the control condition and sets the flag information (ac_bypass_flag) for designating the operation mode. When the process of step S303 is finished, the encoding control process ends, and the process returns to FIG. 10.

In addition, if the operation mode setting section 312 determines that there is no possibility of switching the operation mode in step S302 of FIG. 24, the process of step S303 is skipped. The encoding control process ends, and the process returns to FIG. 10.

In this way, the operation mode setting section 312 sets the operation mode (uses the flag information) in this case only if there is a possibility of switching the operation mode according to the control information. Therefore, the encoding section 115 can reduce unnecessary processing regarding the encoding control process and can suppress the increase in the load of encoding. In addition, unnecessary transmission of the flag information can be suppressed, and the reduction in the encoding efficiency can be suppressed.

### 4. Fourth Embodiment

### <Decoding Section>

FIG. 25 illustrates a main configuration example of the decoding section 212 of the image decoding apparatus 200 corresponding to the encoding apparatus 115 of the third embodiment. As illustrated in FIG. 25, the decoding section 212 in this case includes a decoding control section 351, the selection section 232, the CABAC decoding section 233, and the buffer 234.

The decoding control section 351 executes a process regarding the control of the decoding by the decoding section 212. The decoding control section 351 includes a control information buffer 361 and an operation mode setting section 362. The control information buffer 361 acquires and stores the control information associated with the encoded data. The control information is the information regarding the control of the setting of the operation mode described above in the third embodiment.

For example, the control information is added to the encoded data, and the control information buffer 361 extracts the control information from the encoded data. As described in the third embodiment, the control information may be stored at any location of the encoded data. Therefore, for example, the location for storing the control information may be determined in advance, and the control information buffer 361 may acquire the control information from the predetermined position of the encoded data determined in advance and store the control information. In addition, information indicating the location for storing the control information may be included in the encoded data, and the control information buffer 361 may acquire the control information on the basis of the information and store the control information. Furthermore, the control information buffer 361 may uniquely specify the location for storing the control information on the basis of the situation of decoding, the information regarding the encoded data or the decoded image, or the like to acquire the control information from the location and store the control information.

The control information buffer 361 supplies the stored control information to the operation mode setting section 362 at a predetermined timing or on the basis of a request from the operation mode setting section 362 or other processing sections.

The operation mode setting section 362 executes processes (that is, processes using the flag information), such as acquiring the flag information (ac_bypass_flag), setting the operation mode according to the flag information, and supplying a control signal for the control of the operation in the set operation mode, according to the control information acquired from the control information buffer 361. The processes can be similarly executed as in the case described in the second embodiment. Therefore, the components from the selection section 232 to the buffer 234 can also similarly execute the processes of the components as in the case described in the second embodiment.

In this way, the operation mode setting section 362 can set the operation mode (use the flag information) as in the encoding side. That is, for example, the operation mode setting section 362 can skip the processes using the flag information, such as acquiring the flag information, setting the operation mode, and generating and supplying the control signal, in the case where it is clear that there is no possibility of switching the operation mode according to the control information. As a result, the decoding section 212 can suppress the increase in the load of decoding. In addition, on the basis of the control of the setting of the operation mode (use of the flag information), the decoding section 212 can properly decode the encoded data for which the setting of the operation mode (use of the flag information) is controlled in the encoding.

### <Flow of Decoding Control Process>

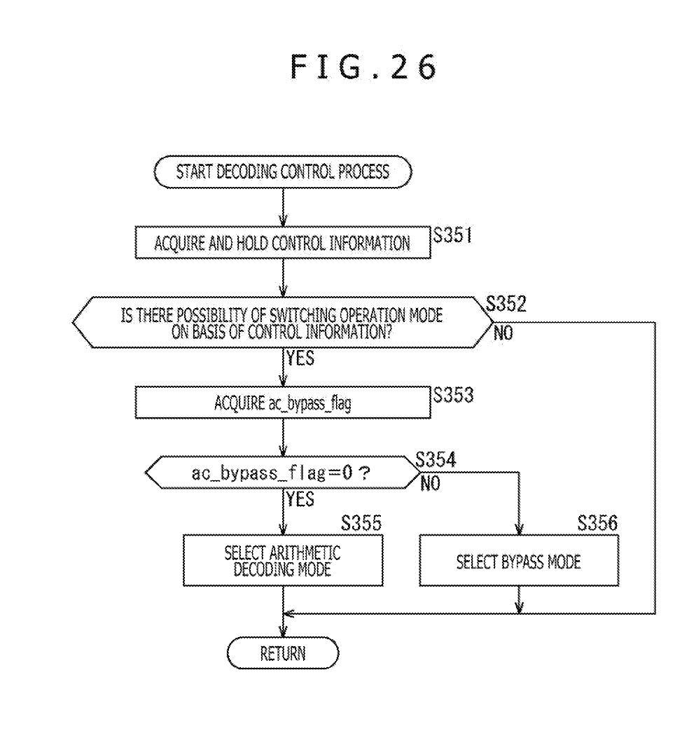

An example of a flow of the decoding control process in this case will be described with reference to a flow chart of FIG. 26. Once the decoding control process is started, the control information buffer 361 acquires the control information from, for example, the encoded data and holds the control information in step S351.

In step S352, the operation mode setting section 362 determines whether or not there is a possibility of switching the operation mode on the basis of the control information set in step S351. For example, the operation mode setting section 362 determines that there is a possibility of switching the operation mode in the case where the setting of the operation mode (use of the flag information) is permitted by the control information and determines that there is no possibility of switching the operation mode in the case where the setting of the operation mode (use of the flag information) is not permitted by the control information. If the operation mode setting section 362 determines that there is a possibility of switching the operation mode, the process proceeds to step S353.

Processes from step S353 to step S356 are executed similarly to the processes from step S221 to step S224 in FIG. 21. When the process of step S355 or the process of step S356 is finished, the decoding control process ends, and the process returns to FIG. 20.

In addition, if the operation mode setting section 362 determines that there is no possibility of switching the operation mode in step S352 of FIG. 26, the processes from step S353 to step S356 are skipped. The decoding control process ends, and the process returns to FIG. 20.

The decoding control process is executed in this way, and the decoding section 212 can suppress the increase in the load of the process of decoding.

### 5. Fifth Embodiment

### <Bypass Mode>

Note that in the description above, the arithmetic coding mode and the bypass mode are provided as the operation modes of encoding and decoding, and the operation modes are adaptively switched. However, the modes are not limited to these, and modes other than the two modes may be able to be set as the operation modes of encoding and decoding.

In addition, the operation mode of encoding and decoding may be only the bypass mode.

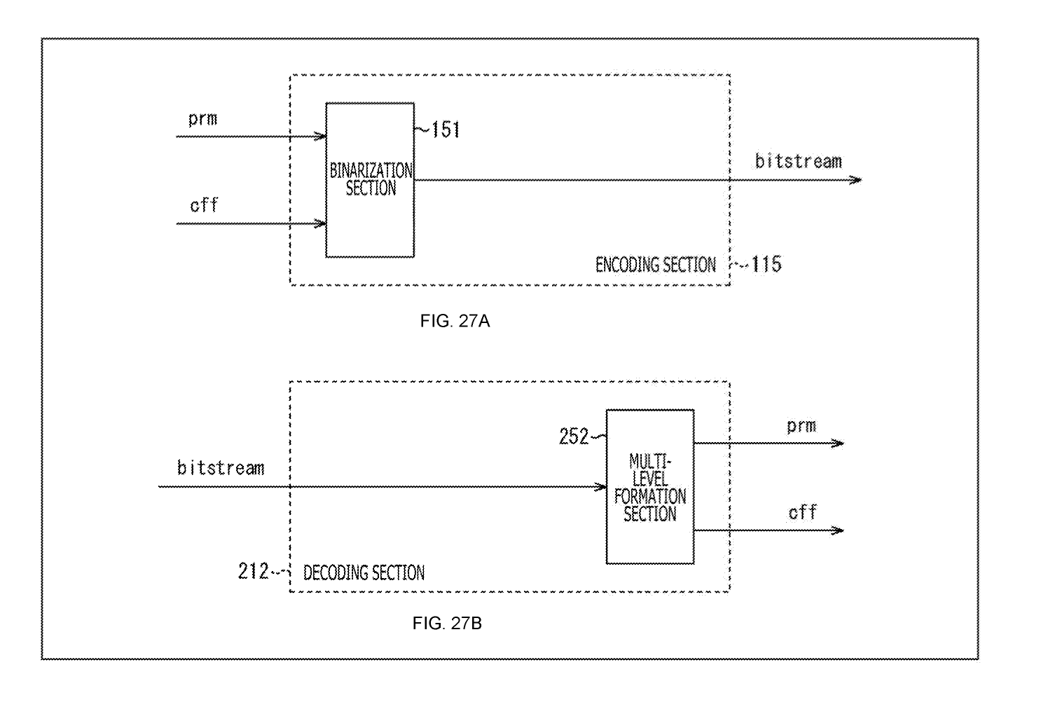

A main configuration example of the encoding section 115 in this case is illustrated in A of FIG. 27. As illustrated in A of FIG. 27, the encoding section 115 includes only the binarization section 151 in this case. As described in the first embodiment, the binarization section 151 binarizes the information regarding the image (information of parameter (prm) and coefficient (cff)) to obtain binary data. Then, the binary data is supplied as encoded data to the accumulation buffer 116 in this case.

That is, the operation mode is not switched in this case. Therefore, compared to the case of encoding in the arithmetic coding mode, the encoding section 115 can always improve the throughput of encoding and can reduce the delay in encoding.

A main configuration example of the decoding section 212 corresponding to the encoding section 115 is illustrated in B of FIG. 27. As illustrated in B of FIG. 27, the decoding section 212 includes only the multi-level formation section 252 in this case. As described in the second embodiment, the multi-level formation section 252 obtains information regarding the image (information of parameter (prm) and coefficient (cff)) by obtaining multi-level data of the encoded data that is supplied from the accumulation buffer 211 and that includes the information regarding the image binarized on the encoding side. The multi-level formation section 252 supplies the obtained information regarding the image to the inverse quantization section 213 and the like.

That is, the operation mode is not switched in this case. Therefore, compared to the case of decoding in the arithmetic decoding mode, the decoding section 212 can always improve the throughput of decoding and can reduce the delay in decoding.

The present technique can be applied to, for example, an image processing apparatus used to perform orthogonal transformation, such as discrete cosine transform, and motion compensation to compress image information as in MPEG, H.26x, or the like and transmit the bit stream of the image information through a network medium, such as satellite broadcasting, cable television, the Internet, and a mobile phone. The present technique can also be applied to, for example, an image processing apparatus used for processing on a storage medium, such as optical and magnetic disks and a flash memory.

### 6. Sixth Embodiment

### <Application to Multi-View Image Encoding/Decoding System>

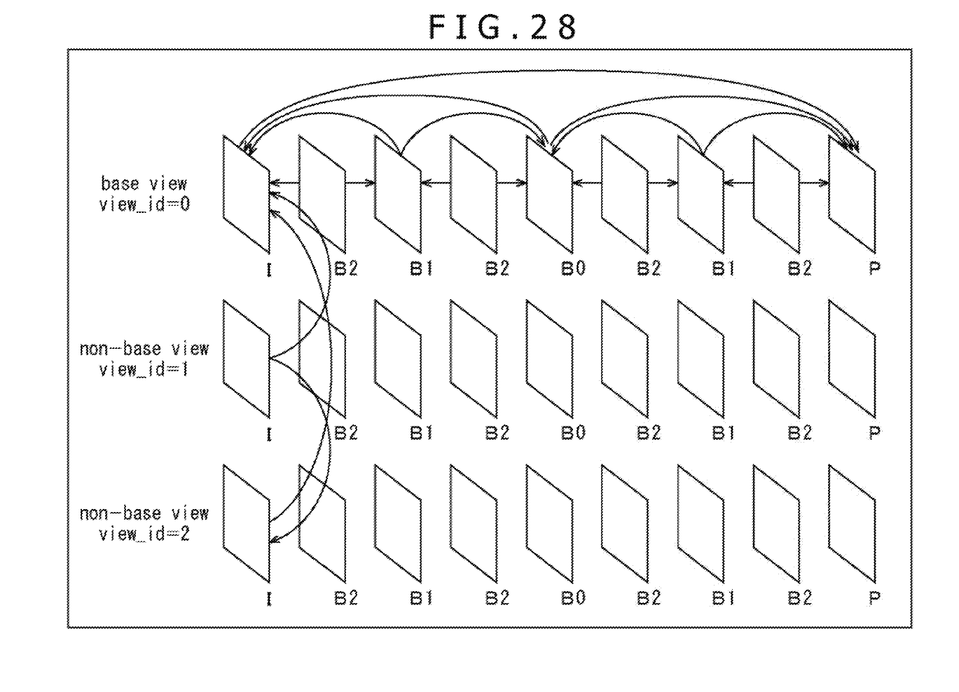

The series of processes can be applied to a multi-view image encoding/decoding system. FIG. 28 illustrates an example of a multi-view image encoding system.

As illustrated in FIG. 28, multi-view images include images from a plurality of viewpoints (views). The plurality of views of the multi-view images include a base view for performing encoding and decoding by using only the images of the base view without using the information of other views and include non-base views for performing encoding and decoding by using the information of other views. In the encoding and decoding of the non-base views, the information of the base view may be used, or the information of the other non-base views may be used.

In the case of encoding and decoding the multi-view images as in the example of FIG. 28, the multi-view images are encoded for each viewpoint. Then, in the case of decoding the encoded data obtained in this way, the encoded data of each viewpoint is decoded (that is, for each viewpoint). The methods described in the respective embodiments may be applied to the encoding and decoding for each viewpoint. In this way, the throughput of encoding and decoding can be improved. That is, the throughput of encoding and decoding can also be improved as in the case of multi-view images.

### <Multi-View Image Encoding/Decoding System>

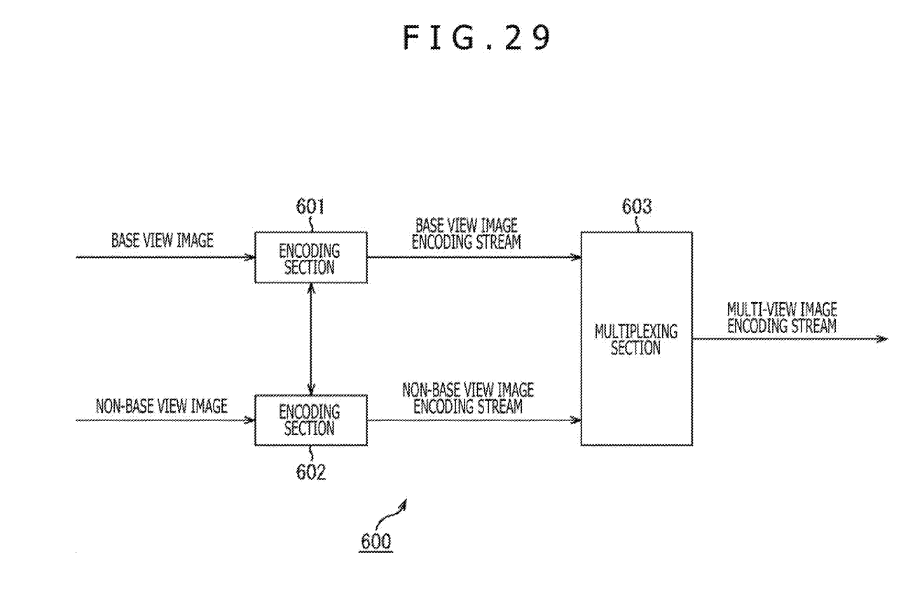

FIG. 29 is a diagram illustrating a multi-view image encoding apparatus of the multi-view image encoding/decoding system that performs the multi-view image encoding/decoding described above. As illustrated in FIG. 29, a multi-view image encoding apparatus 600 includes an encoding section 601, an encoding section 602, and a multiplexing section 603.

The encoding section 601 encodes a base view image to generate a base view image encoding stream. The encoding section 602 encodes a non-base view image to generate a non-base view image encoding stream. The multiplexing section 603 multiplexes the base view image encoding stream generated by the encoding section 601 and the non-base view image encoding stream generated by the encoding section 602 to generate a multi-view image encoding stream.

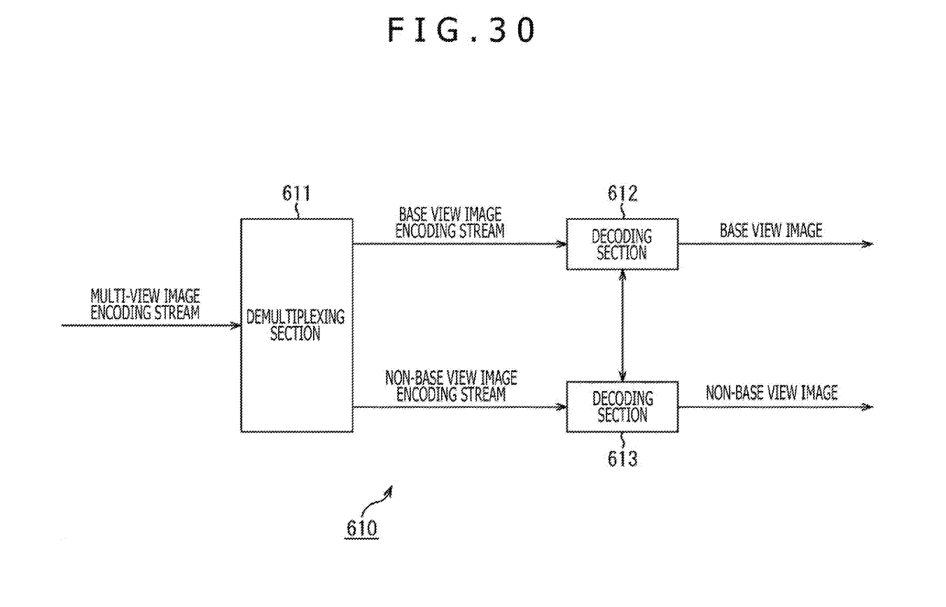

FIG. 30 is a diagram illustrating a multi-view image decoding apparatus that performs the multi-view image decoding described above. As illustrated in FIG. 30, a multi-view image decoding apparatus 610 includes a demultiplexing section 611, a decoding section 612, and a decoding section 613.

The demultiplexing section 611 demultiplexes a multi-view image encoding stream including multiplexed base view image encoding stream and non-base view image encoding stream and extracts a base view image encoding stream and a non-base view image encoding stream. The decoding section 612 decodes the base view image encoding stream extracted by the demultiplexing section 611 and obtains a base view image. The decoding section 613 decodes the non-base view image encoding stream extracted by the demultiplexing section 611 and obtains a non-base view image.

For example, in the multi-view image encoding/decoding system, the image encoding apparatus 100 described in each of the embodiments may be applied as the encoding section 601 and the encoding section 602 of the multi-view image encoding apparatus 600. In this way, the methods described in the respective embodiments can also be applied to the encoding of multi-view images. That is, the throughput of encoding can be improved. In addition, for example, the image decoding apparatus 200 described in each of the embodiments may be applied as the decoding section 612 and the decoding section 613 of the multi-view image decoding apparatus 610. In this way, the methods described in the respective embodiments can also be applied to the decoding of the encoded data of multi-view images. That is, the throughput of decoding can be improved.

### <Application to Tiered Image Encoding/Decoding System>

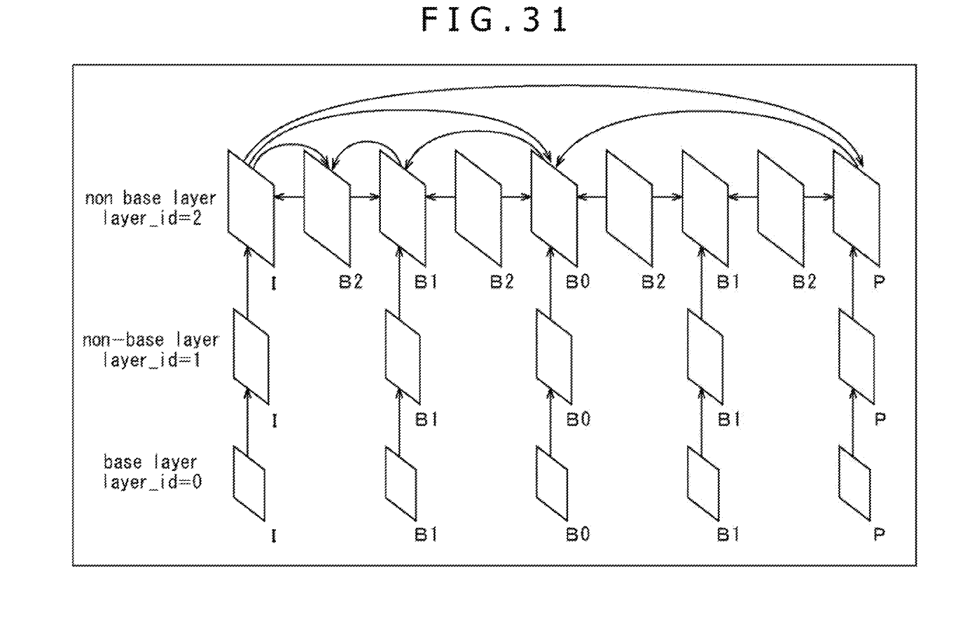

In addition, the series of processes can be applied to a tiered image encoding (scalable encoding) and decoding system. FIG. 31 illustrates an example of a tiered image encoding system.

In the tiered image encoding (scalable encoding), an image is divided into a plurality of layers (image is tiered) to provide a scalability function for a predetermined parameter, and the image data is encoded for each layer. The tiered image decoding the tiered image encoding (scalable decoding) is decoding corresponding to the tiered image encoding.

As illustrated in FIG. 31, in the image tiering, one image is partitioned into a plurality of images (layers) on the basis of the predetermined parameter with the scalability function. That is, the images after tiering (tiered images) include images of a plurality of tiers (layers) with different values of the predetermined parameter. The plurality of layers of the tiered images include a base layer for encoding and decoding by using only the images of the base layer without using the images of other layers and include non-base layers (also referred to as enhancement layers) for encoding and decoding by using the images of other layers. In the non-base layers, the images of the base layer may be used, or the images of the other non-base layers may be used.

In general, the non-base layer includes data of a difference image (difference data) of an image of the non-base layer and an image of another layer in order to reduce the redundancy. For example, in a case where one image is divided into two tiers including a base layer and a non-base layer (also referred to as enhancement layer), an image with lower quality than the original image can be obtained from only the data of the base layer, and the data of the base layer and the data of the non-base layer can be combined to obtain the original image (that is, high-quality image).

The images are tiered in this way, and images with a variety of quality can be easily obtained according to the situation. For example, image compression information of only the base layer can be transmitted to a terminal with low processing capability, such as a mobile phone, and moving images with low spatial-temporal resolution or low image quality can be reproduced. Image compression information of the enhancement layers in addition to the base layer can be transmitted to a terminal with high processing capability, such as a TV and a personal computer, and moving images with high spatial temporal resolution or high image quality can be reproduced. In this way, the image compression information according to the capability of the terminal or the network can be transmitted from the server without executing a transcoding process.

In the case of encoding and decoding the tiered images as in the example of FIG. 31, the tiered images are encoded for each layer. Then, in the case of decoding the encoded data obtained in this way, the encoded data of each layer is decoded (that is, on a layer-by-layer basis). The methods described in the respective embodiments may be applied to the encoding and decoding of each layer. In this way, the throughput of encoding and decoding can be improved. That is, the throughput of encoding and decoding can also be similarly improved in the case of the tiered images.

### <Scalable Parameter>

In the tiered image encoding and the tiered image decoding (scalable encoding and scalable decoding), the parameter with the scalability function is arbitrary. For example, the spatial resolution may be the parameter (spatial scalability). In the case of the spatial scalability, the resolution of the image is different in each layer.

In addition, another example of the parameter with scalability includes the temporal resolution (temporal scalability). In the case of the temporal scalability, the frame rate is different in each layer.

Furthermore, another example of the parameter with scalability includes the signal to noise ratio (SNR) (SNR scalability). In the case of the SNR scalability, the SN ratio is different in each layer.

Obviously, the parameter with scalability can be a parameter other than the parameters described in the examples. For example, there is bit-depth scalability in which the base layer includes an 8-bit image, and the enhancement layer is added to the 8-bit image to obtain a 10-bit image.

In addition, there is chroma scalability in which the base layer includes a component image in a 4:2:0 format, and the enhancement layer is added to the component image to obtain a component image in a 4:2:2 format.

### <Tiered Image Encoding/Decoding System>

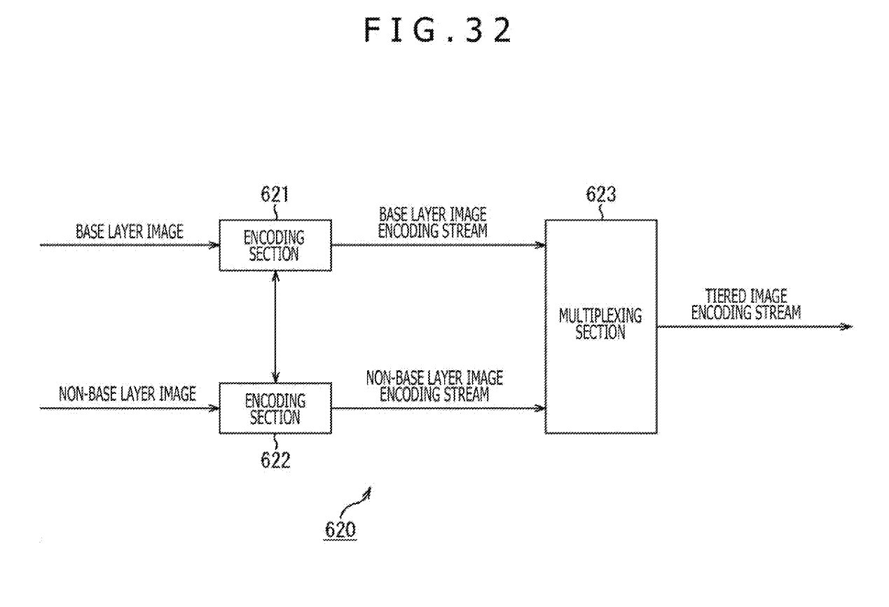

FIG. 32 is a diagram illustrating a tiered image encoding apparatus of the tiered image encoding/decoding system that performs the tiered image encoding/decoding described above. As illustrated in FIG. 32, a tiered image encoding apparatus 620 includes an encoding section 621, an encoding section 622, and a multiplexing section 623.

The encoding section 621 encodes a base layer image to generate a base layer image encoding stream. The encoding section 622 encodes a non-base layer image to generate a non-base layer image encoding stream. The multiplexing section 623 multiplexes the base layer image encoding stream generated by the encoding section 621 and the non-base layer image encoding stream generated by the encoding section 622 to generate a tiered image encoding stream.

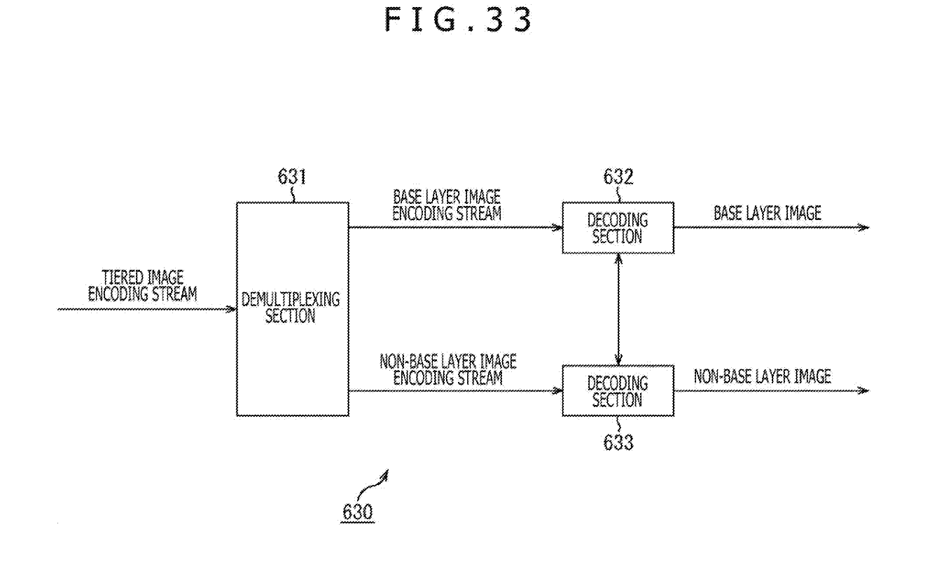

FIG. 33 is a diagram illustrating a tiered image decoding apparatus that performs the tiered image decoding described above. As illustrated in FIG. 33, a tiered image decoding apparatus 630 includes a demultiplexing section 631, a decoding section 632, and a decoding section 633.

The demultiplexing section 631 demultiplexes a tiered image encoding stream including multiplexed base layer image encoding stream and non-base layer image encoding stream and extracts a base layer image encoding stream and a non-base layer image encoding stream. The decoding section 632 decodes the base layer image encoding stream extracted by the demultiplexing section 631 and obtains a base layer image. The decoding section 633 decodes the non-base layer image encoding stream extracted by the demultiplexing section 631 and obtains a non-base layer image.

For example, in the tiered image encoding/decoding system, the image encoding apparatus 100 described in each of the embodiments may be applied as the encoding section 621 and the encoding section 622 of the tiered image encoding apparatus 620. In this way, the methods described in the respective embodiments can also be applied to the encoding of tiered images. That is, the throughput of encoding can be improved. In addition, for example, the image decoding apparatus 200 described in each of the embodiments may be applied as the decoding section 632 and the decoding section 633 of the tiered image decoding apparatus 630. In this way, the methods described in the respective embodiments can also be applied to the decoding of the encoded data of tiered images. That is, the throughput of decoding can be improved.

### <Computer>

The series of processes can be executed by hardware or can be executed by software. In the case where the series of processes are executed by software, a program included in the software is installed on a computer. Here, examples of the computer include a computer incorporated into dedicated hardware and a general-purpose personal computer that can execute various functions by installing various programs.

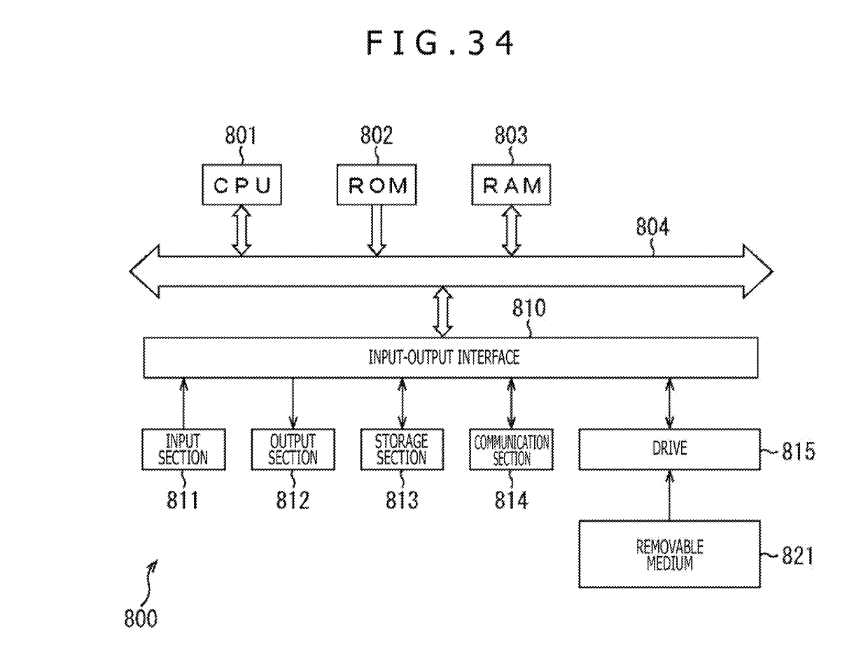

FIG. 34 is a block diagram illustrating a configuration example of the hardware of the computer that uses a program to execute the series of processes.

In a computer 800 illustrated in FIG. 34, a CPU (Central Processing Unit) 801, a ROM (Read Only Memory) 802, and a RAM (Random Access Memory) 803 are connected to each other through a bus 804.

An input-output interface 810 is also connected to the bus 804. An input section 811, an output section 812, a storage section 813, a communication section 814, and a drive 815 are connected to the input-output interface 810.

The input section 811 includes, for example, a keyboard, a mouse, a microphone, a touch panel, an input terminal, and the like. The output section 812 includes, for example, a display, a speaker, an output terminal, and the like. The storage section 813 includes, for example, a hard disk, a RAM disk, a non-volatile memory, and the like. The communication section 814 includes, for example, a network interface. The drive 815 drives a removable medium 821, such as a magnetic disk, an optical disk, a magneto-optical disk, and a semiconductor memory.

In the computer configured in this way, the CPU 801 loads, for example, a program stored in the storage section 813 to the RAM 803 through the input-output interface 810 and the bus 804 to execute the program to thereby execute the series of processes. Data and the like necessary for the CPU 801 to execute various processes are also appropriately stored in the RAM 803.

The program executed by the computer (CPU 801) can be applied by, for example, recording the program in the removable medium 821 as a package medium or the like. In this case, the removable medium 821 can be mounted on the drive 815 to install the program on the storage section 813 through the input-output interface 810.

The program can also be provided through a wired or wireless transmission medium, such as a local area network, the Internet, and digital satellite broadcasting. In this case, the program can be received by the communication section 814 and installed on the storage section 813.

In addition, the program can also be installed in advance on the ROM 802 or the storage section 813.

### <Application of the Present Technique>

The image encoding apparatus 100 and the image decoding apparatus 200 according to the embodiments described above can be applied to, for example, various electronic devices, such as a transmitter and a receiver in distribution in satellite broadcasting, cable broadcasting like cable TV, or the Internet or in distribution to a terminal through cellular communication, a recording apparatus that records images in a medium like an optical disk, a magnetic disk, or a flash memory, and a reproduction apparatus that reproduces images from these storage media. Hereinafter, four application examples will be described.

### FIRST APPLICATION EXAMPLE

### Television Receiver

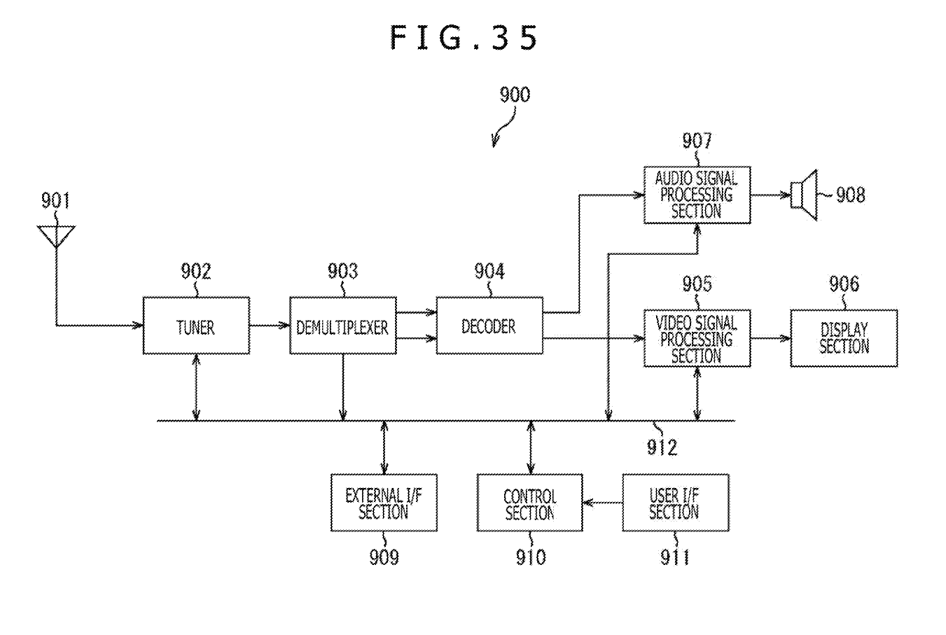

FIG. 35 illustrates an example of a schematic configuration of a television apparatus according to the embodiments described above. A television apparatus 900 includes an antenna 901, a tuner 902, a demultiplexer 903, a decoder 904, a video signal processing section 905, a display section 906, an audio signal processing section 907, a speaker 908, an external interface (I/F) section 909, a control section 910, a user interface (I/F) section 911, and a bus 912.

The tuner 902 extracts a signal of a desired channel from a broadcast signal received through the antenna 901 and demodulates the extracted signal. The tuner 902 then outputs an encoded bit stream obtained by the demodulation to the demultiplexer 903. That is, the tuner 902 plays a role of a transmission section in the television apparatus 900 that receives an encoded stream in which an image is encoded.

The demultiplexer 903 separates a video stream and an audio stream of a program to be viewed from the encoded bit stream and outputs each of the separated streams to the decoder 904. The demultiplexer 903 also extracts auxiliary data, such as EPG (Electronic Program Guide), from the encoded bit stream and supplies the extracted data to the control section 910. Note that in a case where the encoded bit stream is scrambled, the demultiplexer 903 may descramble the encoded bit stream.

The decoder 904 decodes the video stream and the audio stream input from the demultiplexer 903. The decoder 904 then outputs video data generated in a decoding process to the video signal processing section 905. The decoder 904 also outputs audio data generated in the decoding process to the audio signal processing section 907.

The video signal processing section 905 reproduces the video data input from the decoder 904 and causes the display section 906 to display the video. The video signal processing section 905 may also cause the display section 906 to display an application screen supplied through a network. The video signal processing section 905 may also apply, for example, an additional process, such as noise removal, to the video data according to the setting. The video signal processing section 905 may further generate, for example, an image of GUI (Graphical User Interface), such as a menu, a button, and a cursor, and superimpose the generated image on the output image.

The display section 906 is driven by a drive signal supplied from the video signal processing section 905, and the display section 906 displays a video or an image on a video screen of a display device (for example, liquid crystal display, plasma display, OELD (Organic ElectroLuminescence Display) (organic EL display), or the like).

The audio signal processing section 907 applies a reproduction process, such as D/A conversion and amplification, to the audio data input from the decoder 904 and causes the speaker 908 to output the sound. The audio signal processing section 907 may also apply an additional process, such as noise removal, to the audio data.

The external interface section 909 is an interface for connecting the television apparatus 900 and an external device or a network. For example, the decoder 904 may decode a video stream or an audio stream received through the external interface section 909. That is, the external interface section 909 also plays a role of a transmission section in the television apparatus 900 that receives an encoded stream in which an image is encoded.

The control section 910 includes a processor, such as a CPU, and a memory, such as a RAM and a ROM. The memory stores a program executed by the CPU, program data, EPG data, data acquired through the network, and the like. The CPU reads and executes the program stored in the memory at, for example, the start of the television apparatus 900. The CPU executes the program to control the operation of the television apparatus 900 according to, for example, an operation signal input from the user interface section 911.

The user interface section 911 is connected to the control section 910. The user interface section 911 includes, for example, a button and a switch for the user to operate the television apparatus 900, a reception section of a remote control signal, and the like. The user interface section 911 detects an operation by the user through these constituent elements to generate an operation signal and outputs the generated operation signal to the control section 910.

The bus 912 mutually connects the tuner 902, the demultiplexer 903, the decoder 904, the video signal processing section 905, the audio signal processing section 907, the external interface section 909, and the control section 910.

In the television apparatus 900 configured in this way, the decoder 904 may have the function of the image decoding apparatus 200 described above. That is, the decoder 904 may use the methods described in the respective embodiments to decode the encoded data. As a result, the television apparatus 900 can improve the throughput of the decoding.

In addition, in the television apparatus 900 configured in this way, the video signal processing section 905 may be able to, for example, encode the image data supplied from the decoder 904 and output the obtained encoded data to the outside of the television apparatus 900 through the external interface section 909. Then, the video signal processing section 905 may have the function of the image encoding apparatus 100 described above. That is, the video signal processing section 905 may use the methods described in the respective embodiments to encode the image data supplied from the decoder 904. As a result, the television apparatus 900 can improve the throughput of the encoding.

### SECOND APPLICATION EXAMPLE

### Mobile Phone

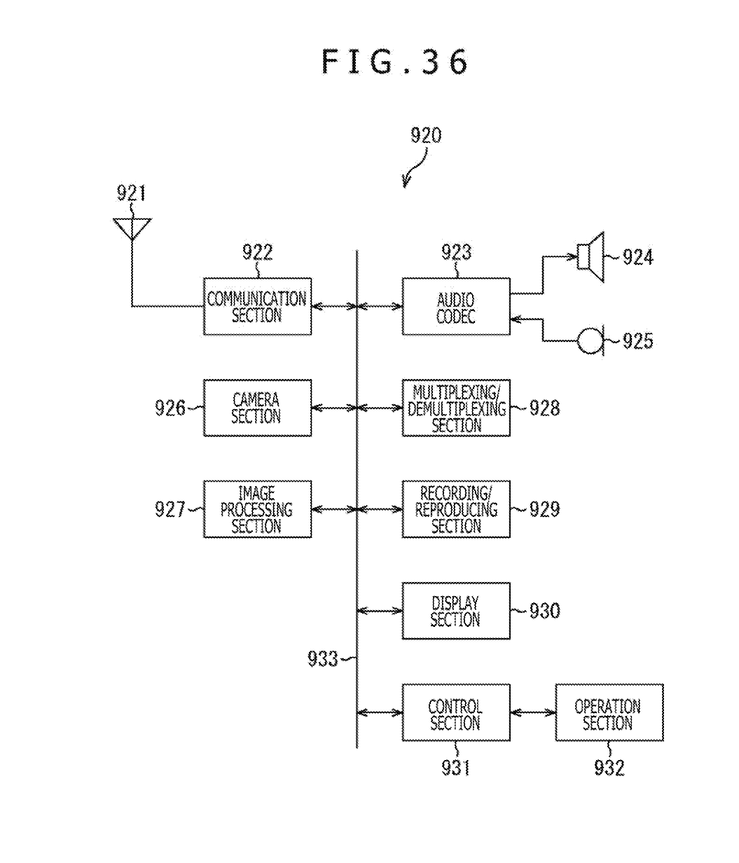

FIG. 36 illustrates an example of a schematic configuration of a mobile phone according to the embodiments described above. A mobile phone 920 includes an antenna 921, a communication section 922, an audio codec 923, a speaker 924, a microphone 925, a camera section 926, an image processing section 927, a multiplexing/demultiplexing section 928, a recording/reproducing section 929, a display section 930, a control section 931, an operation section 932, and a bus 933.

The antenna 921 is connected to the communication section 922. The speaker 924 and the microphone 925 are connected to the audio codec 923. The operation section 932 is connected to the control section 931. The bus 933 mutually connects the communication section 922, the audio codec 923, the camera section 926, the image processing section 927, the multiplexing/demultiplexing section 928, the recording/reproducing section 929, the display section 930, and the control section 931.

The mobile phone 920 performs operations, such as transmitting and receiving an audio signal, transmitting and receiving email or image data, taking an image, and recording data, in various operation modes including a voice call mode, a data communication mode, an imaging mode, and a TV phone mode.

In the voice call mode, an analog audio signal generated by the microphone 925 is supplied to the audio codec 923. The audio codec 923 converts the analog audio signal into audio data and performs A/D conversion to compress the converted audio data. The audio codec 923 then outputs the audio data after the compression to the communication section 922. The communication section 922 encodes and modulates the audio data to generate a transmission signal. The communication section 922 then transmits the generated transmission signal to a base station (not illustrated) through the antenna 921. The communication section 922 also amplifies a wireless signal received through the antenna 921 and converts the frequency to acquire a reception signal. The communication section 922 then demodulates and decodes the reception signal to generate audio data and outputs the generated audio data to the audio codec 923. The audio codec 923 expands and performs D/A conversion of the audio data to generate an analog audio signal. The audio codec 923 then supplies the generated audio signal to the speaker 924 to output the sound.

In addition, for example, the control section 931 generates character data of an email according to an operation by the user through the operation section 932 in the data communication mode. The control section 931 also causes the display section 930 to display the characters. The control section 931 also generates email data according to a transmission instruction from the user through the operation section 932 and outputs the generated email data to the communication section 922. The communication section 922 encodes and modulates the email data to generate a transmission signal. The communication section 922 then transmits the generated transmission signal to a base station (not illustrated) through the antenna 921. The communication section 922 also amplifies a wireless signal received through the antenna 921 and converts the frequency to acquire a reception signal. The communication section 922 then demodulates and decodes the reception signal to restore email data and outputs the restored email data to the control section 931. The control section 931 causes the display section 930 to display the content of the email and supplies the email data to the recording/reproducing section 929 to write the email data to a storage medium of the recording/reproducing section 929.

The recording/reproducing section 929 includes an arbitrary read/write storage medium. For example, the storage medium may be a built-in storage medium, such as a RAM and a flash memory, or may be an externally mounted storage medium, such as a hard disk, a magnetic disk, a magneto-optical disk, an optical disk, a USB (Universal Serial Bus) memory, and a memory card.

In addition, for example, the camera section 926 takes an image of a subject to generate image data and outputs the generated image data to the image processing section 927 in the imaging mode. The image processing section 927 encodes the image data input from the camera section 926 and supplies the encoded stream to the recording/reproducing section 929 to write the encoded stream to the storage medium of the recording/reproducing section 929.

Furthermore, the recording/reproducing section 929 reads an encoded stream recorded in the storage medium and outputs the encoded stream to the image processing section 927 in the image display mode. The image processing section 927 decodes the encoded stream input from the recording/reproducing section 929 and supplies the image data to the display section 930 to display the image.

In addition, for example, the multiplexing/demultiplexing section 928 multiplexes a video stream encoded by the image processing section 927 and an audio stream input from the audio codec 923 and outputs a multiplexed stream to the communication section 922 in the TV phone mode. The communication section 922 encodes and modulates the stream to generate a transmission signal. The communication section 922 then transmits the generated transmission signal to a base station (not illustrated) through the antenna 921. The communication section 922 also amplifies a wireless signal received through the antenna 921 and converts the frequency to acquire a reception signal. The transmission signal and the reception signal can include encoded bit streams. The communication section 922 then demodulates and decodes the reception signal to restore the stream and outputs the restored stream to the multiplexing/demultiplexing section 928. The multiplexing/demultiplexing section 928 separates a video stream and an audio stream from the input stream, outputs the video stream to the image processing section 927, and outputs the audio stream to the audio codec 923. The image processing section 927 decodes the video stream to generate video data. The video data is supplied to the display section 930, and the display section 930 displays a series of images. The audio codec 923 expands and performs D/A conversion of the audio stream to generate an analog audio signal. The audio codec 923 then supplies the generated audio signal to the speaker 924 to output the sound.

In the mobile phone 920 configured in this way, the image processing section 927 may have, for example, the function of the image encoding apparatus 100 described above. That is, the image processing section 927 may use the methods described in the respective embodiments to encode the image data. As a result, the mobile phone 920 can improve the throughput of the encoding.

In addition, in the mobile phone 920 configured in this way, the image processing section 927 may have, for example, the function of the image decoding apparatus 200 described above. That is, the image processing section 927 may use the methods described in the respective embodiments to decode the encoded data. As a result, the mobile phone 920 can improve the throughput of the decoding.

### THIRD APPLICATION EXAMPLE

### Recording/Reproducing Apparatus

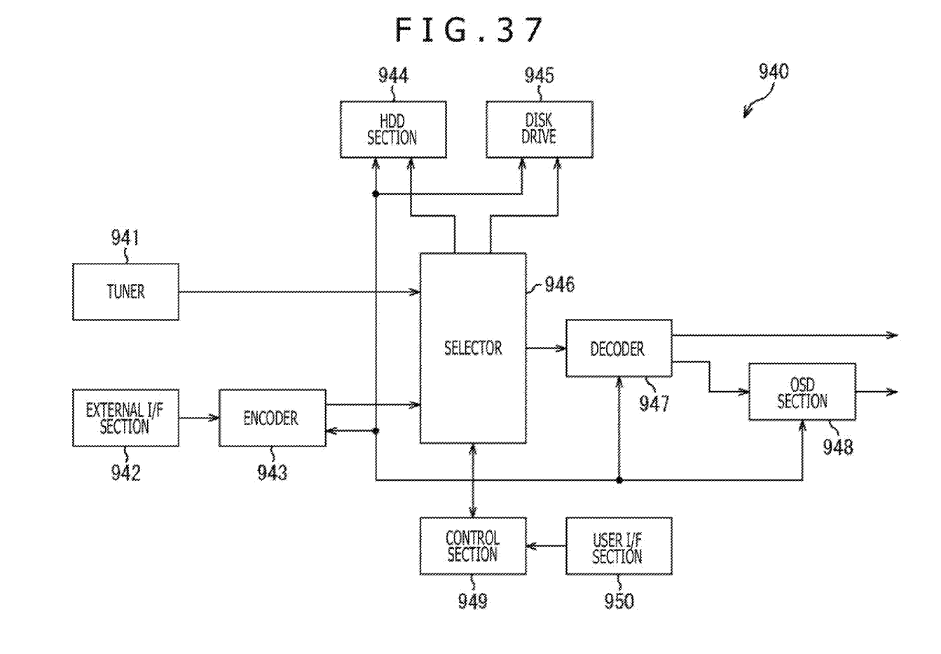

FIG. 37 illustrates an example of a schematic configuration of a recording/reproducing apparatus according to the embodiments described above. For example, a recording/reproducing apparatus 940 encodes audio data and video data of a received broadcast program and records the audio data and the video data in a recording medium. The recording/reproducing apparatus 940 may also encode audio data and video data acquired from another apparatus and record the audio data and the video data in the recording medium, for example. The recording/reproducing apparatus 940 also reproduces data recorded in the recording medium on a monitor and a speaker according to an instruction of the user, for example. In this case, the recording/reproducing apparatus 940 decodes audio data and video data.

The recording/reproducing apparatus 940 includes a tuner 941, an external interface (I/F) section 942, an encoder 943, an HDD (Hard Disk Drive) section 944, a disk drive 945, a selector 946, a decoder 947, an OSD (On-Screen Display) section 948, a control section 949, and a user interface (I/F) section 950.

The tuner 941 extracts a signal of a desired channel from a broadcast signal received through an antenna (not illustrated) and demodulates the extracted signal. The tuner 941 then outputs an encoded bit stream obtained by the demodulation to the selector 946. That is, the tuner 941 plays a role of a transmission section in the recording/reproducing apparatus 940.

The external interface section 942 is an interface for connecting the recording/reproducing apparatus 940 and an external device or a network. The external interface section 942 may be, for example, an IEEE (Institute of Electrical and Electronic Engineers) 1394 interface, a network interface, a USB interface, a flash memory interface, or the like. For example, video data and audio data received through the external interface section 942 are input to the encoder 943. That is, the external interface section 942 plays a role of a transmission section in the recording/reproducing apparatus 940.

The encoder 943 encodes video data and audio data in a case where the video data and the audio data input from the external interface section 942 are not encoded. The encoder 943 then outputs an encoded bit stream to the selector 946.

The HDD section 944 records encoded bit streams including compressed content data of video, sound, and the like, various programs, and other data in an internal hard disk. The HDD section 944 also reads the data from the hard disk at the reproduction of the video and the sound.

The disk drive 945 records and reads data to and from a mounted recording medium. The recording medium mounted on the disk drive 945 may be, for example, a DVD (Digital Versatile Disc) disk (DVD-Video, DVD-RAM (DVD-Random Access Memory), DVD−R (DVD−Recordable), DVD−RW (DVD−Rewritable), DVD+R (DVD+Recordable), DVD+RW (DVD+Rewritable), or the like), a Blu-ray (registered trademark) disk, or the like.

At the recording of the video and the sound, the selector 946 selects an encoded bit stream input from the tuner 941 or the encoder 943 and outputs the selected encoded bit stream to the HDD 944 or the disk drive 945. In addition, at the reproduction of the video and the sound, the selector 946 outputs the encoded bit stream input from the HDD 944 or the disk drive 945 to the decoder 947.

The decoder 947 decodes the encoded bit stream to generate video data and audio data. The decoder 947 then outputs the generated video data to the OSD section 948. In addition, the decoder 947 outputs the generated audio data to an external speaker.

The OSD section 948 reproduces the video data input from the decoder 947 and displays the video. The OSD section 948 may also superimpose, for example, an image of GUI, such as a menu, a button, and a cursor, on the displayed video.

The control section 949 includes a processor, such as a CPU, and a memory, such as a RAM and a ROM. The memory stores a program executed by the CPU, program data, and the like. The CPU reads and executes the program stored in the memory at, for example, the start of the recording/reproducing apparatus 940. The CPU executes the program to control the operation of the recording/reproducing apparatus 940 according to, for example, an operation signal input from the user interface section 950.

The user interface section 950 is connected to the control section 949. The user interface section 950 includes, for example, a button and a switch for the user to operate the recording/reproducing apparatus 940, a reception section of a remote control signal, and the like. The user interface section 950 detects an operation by the user through these constituent elements to generate an operation signal and outputs the generated operation signal to the control section 949.

In the recording/reproducing apparatus 940 configured in this way, the encoder 943 may have, for example, the function of the image encoding apparatus 100 described above. That is, the encoder 943 may use the methods described in the respective embodiments to encode the image data. As a result, the recording/reproducing apparatus 940 can improve the throughput of the encoding.

Furthermore, in the recording/reproducing apparatus 940 configured in this way, the decoder 947 may have, for example, the function of the image decoding apparatus 200 described above. That is, the decoder 947 may use the methods described in the respective embodiments to decode the encoded data. As a result, the recording/reproducing apparatus 940 can improve the throughput of the decoding.

### FOURTH APPLICATION EXAMPLE

### Imaging Apparatus

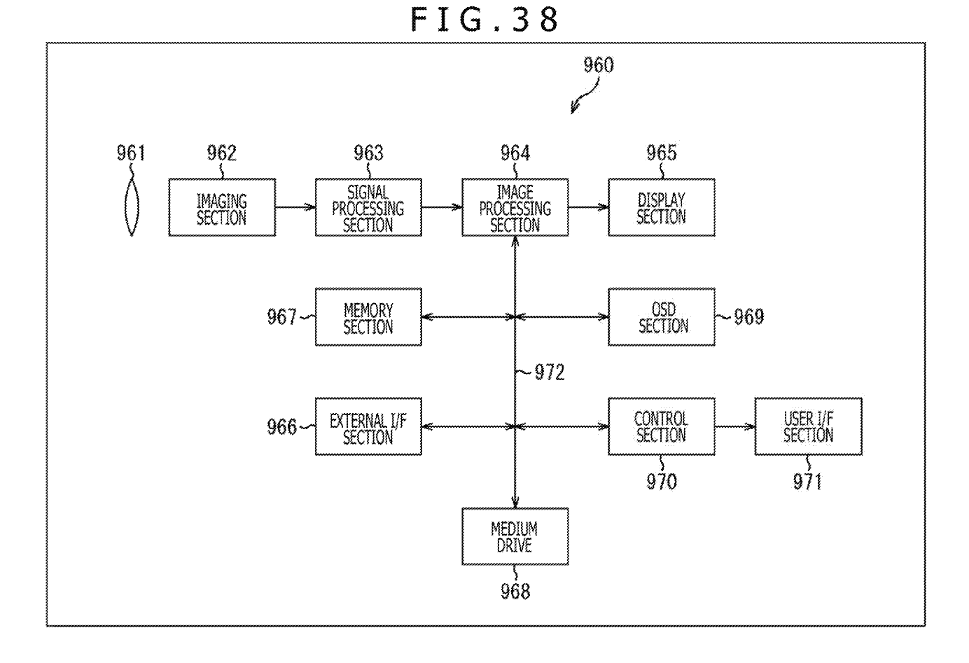

FIG. 38 illustrates an example of a schematic configuration of an imaging apparatus according to the embodiments described above. An imaging apparatus 960 images a subject, generates an image, encodes image data, and records the image data in a recording medium.

The imaging apparatus 960 includes an optical block 961, an imaging section 962, a signal processing section 963, an image processing section 964, a display section 965, an external interface (I/F) section 966, a memory section 967, a medium drive 968, an OSD section 969, a control section 970, a user interface (I/F) section 971, and a bus 972.

The optical block 961 is connected to the imaging section 962. The imaging section 962 is connected to the signal processing section 963. The display section 965 is connected to the image processing section 964. The user interface section 971 is connected to the control section 970. The bus 972 mutually connects the image processing section 964, the external interface section 966, the memory section 967, the medium drive 968, the OSD section 969, and the control section 970.

The optical block 961 includes a focus lens, a diaphragm mechanism, and the like. The optical block 961 forms an optical image of the subject on an imaging surface of the imaging section 962. The imaging section 962 includes an image sensor, such as a CCD (Charge Coupled Device) and a CMOS (Complementary Metal Oxide Semiconductor), and performs photoelectric conversion of the optical image formed on the imaging surface to convert the optical image into an image signal as an electrical signal. The imaging section 962 then outputs the image signal to the signal processing section 963.

The signal processing section 963 applies various types of camera signal processing, such as knee correction, gamma correction, and color correction, to the image signal input from the imaging section 962. The signal processing section 963 outputs the image data after the camera signal processing to the image processing section 964.

The image processing section 964 encodes the image data input from the signal processing section 963 to generate encoded data. The image processing section 964 then outputs the generated encoded data to the external interface section 966 or the medium drive 968. The image processing section 964 also decodes encoded data input from the external interface section 966 or the medium drive 968 to generate image data. The image processing section 964 then outputs the generated image data to the display section 965. The image processing section 964 may also output the image data input from the signal processing section 963 to the display section 965 to display the image. The image processing section 964 may also superimpose display data acquired from the OSD section 969 on the image output to the display section 965.

The OSD section 969 generates, for example, an image of GUI, such as a menu, a button, and a cursor, and outputs the generated image to the image processing section 964.

The external interface section 966 is provided as, for example, a USB input/output terminal. The external interface section 966 connects, for example, the imaging apparatus 960 and a printer at the printing of an image. A drive is also connected to the external interface section 966 as necessary. The drive is provided with, for example, a removable medium, such as a magnetic disk and an optical disk, and a program read from the removable medium can be installed on the imaging apparatus 960. Furthermore, the external interface section 966 may be provided as a network interface connected to a network, such as a LAN and the Internet. That is, the external interface section 966 plays a role of a transmission section in the imaging apparatus 960.

A recording medium mounted on the medium drive 968 may be, for example, an arbitrary read/write removable medium, such as a magnetic disk, a magneto-optical disk, an optical disk, and a semiconductor memory. In addition, the recording medium may be fixed and mounted on the medium drive 968 to provide, for example, a non-portable storage section, such as a built-in hard disk drive and an SSD (Solid State Drive).

The control section 970 includes a processor, such as a CPU, and a memory, such as a RAM and a ROM. The memory stores a program executed by the CPU, program data, and the like. The CPU reads and executes the program stored in the memory at, for example, the start of the imaging apparatus 960. The CPU executes the program to control the operation of the imaging apparatus 960 according to, for example, an operation signal input from the user interface section 971.

The user interface section 971 is connected to the control section 970. The user interface section 971 includes, for example, a button, a switch, and the like for the user to operate the imaging apparatus 960. The user interface section 971 detects an operation by the user through these constituent elements to generate an operation signal and outputs the generated operation signal to the control section 970.

In the imaging apparatus 960 configured in this way, the image processing section 964 may have, for example, the function of the image encoding apparatus 100 described above. That is, the image processing section 964 may use the methods described in the respective embodiments to encode the image data. As a result, the imaging apparatus 960 can improve the throughput of the encoding.

In addition, in the imaging apparatus 960 configured in this way, the image processing section 964 may have, for example, the function of the image decoding apparatus 200 described above. That is, the image processing section 964 may use the methods described in the respective embodiments to decode the encoded data. As a result, the imaging apparatus 960 can improve the throughput of the decoding.

### OTHER APPLICATION EXAMPLES

Note that the present technique can also be applied to, for example, HTTP streaming, such as MPEG DASH, in which appropriate data is used by selecting the data on a segment-by-segment basis from a plurality of pieces of encoded data with different resolutions or the like prepared in advance. That is, information regarding encoding and decoding can also be shared between the plurality of pieces of encoded data.

In addition, although the examples of the apparatus, the system, and the like according to the present technique are described above, the present technique is not limited to these. The present technique can also be carried out in any configuration mounted on an apparatus included in the apparatus or the system, such as, for example, a processor as system LSI (Large Scale Integration) or the like, a module using a plurality of processors or the like, a unit using a plurality of modules or the like, and a set provided with other functions in addition to the unit (that is, configuration of part of an apparatus).

### <Video Set>

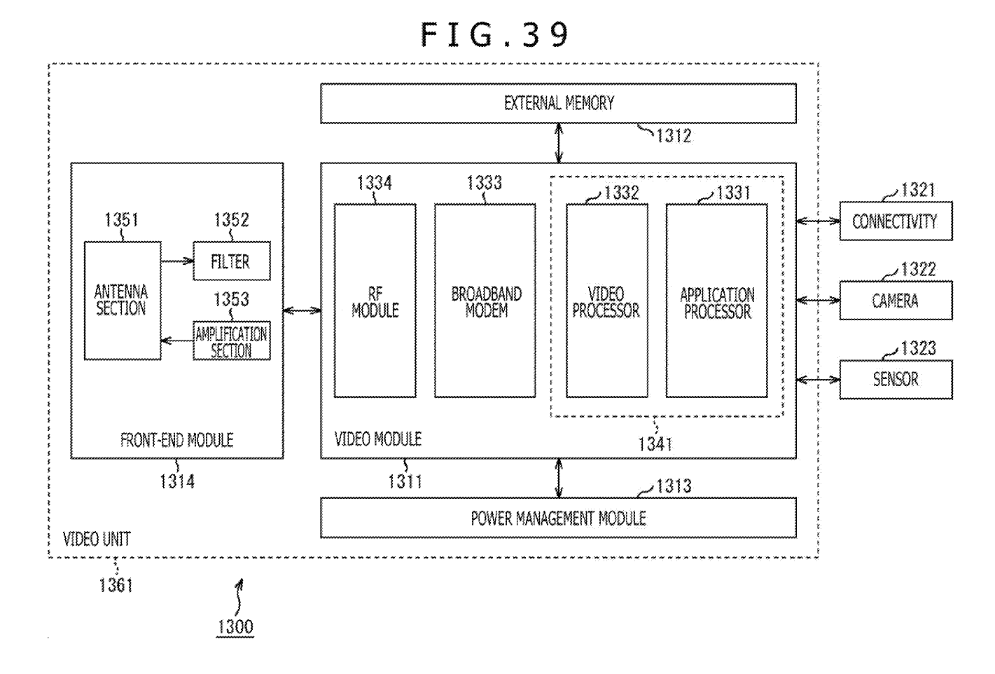

An example of a case where the present technique is carried out in a set will be described with reference to FIG. 39. FIG. 39 illustrates an example of a schematic configuration of a video set according to the present technique.

In recent years, electronic devices are provided with more functions, and in the development or manufacturing of the electronic devices, there is a case where the configuration of part of the electronic devices is implemented by selling or providing the configuration. Instead of implementing the configuration as a configuration having one function, a plurality of configurations with related functions are often combined to implement the configurations as one set provided with a plurality of functions.

A video set 1300 illustrated in FIG. 39 has such a configuration with multiple functions, and a device having functions regarding encoding or decoding (one of or both encoding and decoding) of images is combined with a device having other functions related to the functions.

As illustrated in FIG. 39, a video set 1300 includes a module group, such as a video module 1311, an external memory 1312, a power management module 1313, and a front-end module 1314, and a device having related functions, such as a connectivity 1321, a camera 1322, and a sensor 1323.

The modules are components with integrated functions, in which some functions of components related to each other are integrated. The specific physical configuration is arbitrary, and for example, a plurality of processors with respective functions, electronic circuit elements, such as resistors and capacitors, and other devices can be arranged and integrated on a wiring board or the like. In addition, other modules, processors, and the like can be combined with the modules to provide new modules.

In the case of the example of FIG. 39, components with functions regarding image processing are combined in the video module 1311, and the video module 1311 includes an application processor, a video processor, a broadband modem 1333, and an RF module 1334.

The processor includes components with predetermined functions integrated on a semiconductor chip on the basis of SoC (System On a Chip), and the processor is called, for example, system LSI (Large Scale Integration) or the like. The components with predetermined functions may be a logic circuit (hardware configuration), may be a CPU, a ROM, a RAM, and a program executed by using them (software configuration), or may be a combination of them. For example, the processor may include the logic circuit, the CPU, the ROM, the RAM, and the like, and part of the functions may be realized by the logic circuit (hardware configuration). The other functions may be realized by the program executed by the CPU (software configuration).

An application processor 1331 of FIG. 39 is a processor that executes an application regarding image processing. The application executed by the application processor 1331 can not only execute a computing process, but can also control, for example, components inside and outside of the video module 1311, such as a video processor 1332, as necessary in order to realize a predetermined function.

The video processor 1332 is a processor with a function regarding encoding or decoding (one of or both encoding and decoding) of an image.

The broadband modem 1333 performs digital modulation or the like of data (digital signal) to be transmitted in wired or wireless (or both wired and wireless) broadband communication performed through a broadband circuit, such as the Internet and a public phone network, to convert the data into an analog signal and demodulates an analog signal received in the broadband communication to convert the analog signal into data (digital signal). The broadband modem 1333 processes, for example, arbitrary information, such as image data to be processed by the video processor 1332, a stream including encoded image data, an application program, and configuration data.

The RF module 1334 is a module that applies frequency conversion, modulation and demodulation, amplification, a filtering process, and the like to an RF (Radio Frequency) signal transmitted and received through an antenna. For example, the RF module 1334 applies frequency conversion or the like to a baseband signal generated by the broadband modem 1333 to generate an RF signal. In addition, the RF module 1334 applies, for example, frequency conversion or the like to an RF signal received through the front-end module 1314 to generate a baseband signal.

Note that as indicated by a dotted line 1341 in FIG. 39, the application processor 1331 and the video processor 1332 may be integrated to provide one processor.

The external memory 1312 is a module provided outside of the video module 1311 and including a storage device used by the video module 1311. The storage device of the external memory 1312 may be realized by any physical configuration. However, the storage device is generally used to store high-capacity data, such as frame-based image data, in many cases. Therefore, it is desirable to realize the storage device by, for example, a relatively inexpensive high-capacity semiconductor memory, such as a DRAM (Dynamic Random Access Memory).

The power management module 1313 manages and controls power supplied to the video module 1311 (each component in the video module 1311).

The front-end module 1314 is a module that provides a front-end function (circuit at transmitting and receiving end of antenna side) to the RF module 1334. As illustrated in FIG. 39, the front-end module 1314 includes, for example, an antenna section 1351, a filter 1352, and an amplification section 1353.

The antenna section 1351 includes an antenna that transmits and receives wireless signals and further includes components around the antenna. The antenna section 1351 transmits a wireless signal of a signal supplied from the amplification section 1353 and supplies an electrical signal (RF signal) of a received wireless signal to the filter 1352. The filter 1352 applies a filtering process or the like to the RF signal received through the antenna section 1351 and supplies the RF signal after the process to the RF module 1334. The amplification section 1353 amplifies the RF signal supplied from the RF module 1334 and supplies the RF signal to the antenna section 1351.

The connectivity 1321 is a module with a function regarding connection to the outside. The physical configuration of the connectivity 1321 is arbitrary. For example, the connectivity 1321 includes a component with a communication function of a standard other than the communication standard corresponding to the broadband modem 1333 and further includes an external input-output terminal and the like.

For example, the connectivity 1321 may include: a module with a communication function in compliance with a wireless communication standard, such as Bluetooth (registered trademark), IEEE 802.11 (for example, Wi-Fi (Wireless Fidelity, registered trademark)), NFC (Near Field Communication), and IrDA (InfraRed Data Association); an antenna that transmits and receives a signal in compliance with the standard; and the like. The connectivity 1321 may also include, for example, a module with a communication function in compliance with a wired communication standard, such as USB (Universal Serial Bus) and HDMI (registered trademark) (High-Definition Multimedia Interface), and a terminal in compliance with the standard. The connectivity 1321 may further include, for example, other data (signal) transmission functions and the like, such as an analog input-output terminal.

Note that the connectivity 1321 may include a device of a transmission destination of data (signal). For example, the connectivity 1321 may include a drive (including not only a drive of a removable medium, but also a hard disk, an SSD (Solid State Drive), a NAS (Network Attached Storage), and the like) that reads and writes data to a recording medium, such as a magnetic disk, an optical disk, a magneto-optical disk, and a semiconductor memory. The connectivity 1321 may also include an output device (such as a monitor and a speaker) of images and sound.

The camera 1322 is a module with a function of imaging a subject to obtain image data of the subject. The image data obtained by the imaging of the camera 1322 is supplied to and encoded by, for example, the video processor 1332.

The sensor 1323 is, for example, a module with arbitrary sensor functions, such as an audio sensor, an ultrasonic sensor, an optical sensor, an illumination sensor, an infrared sensor, an image sensor, a rotation sensor, an angle sensor, an angular velocity sensor, a speed sensor, an acceleration sensor, a tilt sensor, a magnetic identification sensor, an impact sensor, and a temperature sensor. Data detected by the sensor 1323 is supplied to, for example, the application processor 1331 and used by an application or the like.

The configurations of the modules described above may be realized by processors, and conversely, the configurations of the processors described above may be realized by modules.

In the video set 1300 configured as described above, the present technique can be applied to the video processor 1332 as described later. Therefore, the video set 1300 can be carried out as a set according to the present technique.

### <Configuration Example of Video Processor>

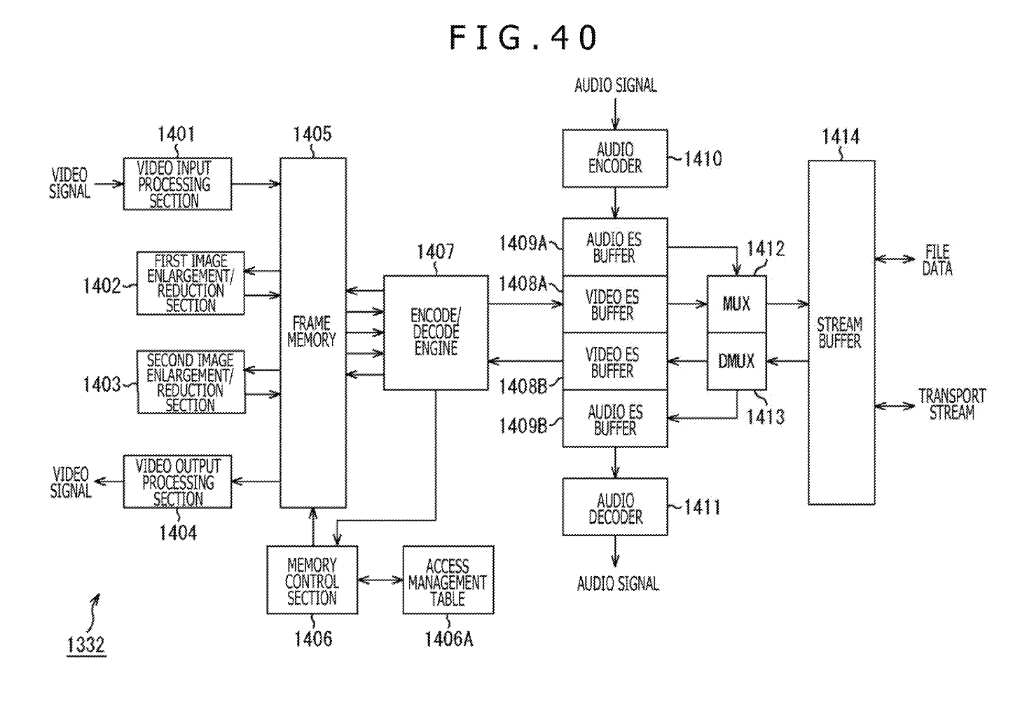

FIG. 40 illustrates an example of a schematic configuration of the video processor 1332 (FIG. 39) according to the present technique.

In the case of the example of FIG. 40, the video processor 1332 has a function of receiving an input of a video signal and an audio signal and using a predetermined system to encode the signals and has a function of decoding encoded video data and audio data and reproducing and outputting a video signal and an audio signal.

As illustrated in FIG. 40, the video processor 1332 includes a video input processing section 1401, a first image enlargement/reduction section 1402, a second image enlargement/reduction section 1403, a video output processing section 1404, a frame memory 1405, and a memory control section 1406. The video processor 1332 also includes an encode/decode engine 1407, video ES (Elementary Stream) buffers 1408A and 1408B, and audio ES buffers 1409A and 1409B. The video processor 1332 further includes an audio encoder 1410, an audio decoder 1411, a multiplexing section (MUX (Multiplexer)) 1412, a demultiplexing section (DMUX (Demultiplexer)) 1413, and a stream buffer 1414.

The video input processing section 1401 acquires, for example, a video signal input from the connectivity 1321 (FIG. 39) or the like and converts the video signal into digital image data. The first image enlargement/reduction section 1402 applies format conversion, enlargement/reduction processing of image, or the like to the image data. The second image enlargement/reduction section 1403 applies enlargement/reduction processing of image to the image data according to the format at the destination of the output through the video output processing section 1404 and applies format conversion, enlargement/reduction processing of image, or the like to the image data similar to the first image enlargement/reduction section 1402. The video output processing section 1404 performs operations, such as converting the format of the image data and converting the image data into an analog signal, and outputs a reproduced video signal to, for example, the connectivity 1321 or the like.

The frame memory 1405 is a memory for image data shared by the video input processing section 1401, the first image enlargement/reduction section 1402, the second image enlargement/reduction section 1403, the video output processing section 1404, and the encode/decode engine 1407. The frame memory 1405 is realized as, for example, a semiconductor memory, such as a DRAM.

The memory control section 1406 receives a synchronization signal from the encode/decode engine 1407 to control the access for writing and reading from the frame memory 1405 according to a schedule for accessing the frame memory 1405 written in the access management table 1406A. The access management table 1406A is updated by the memory control section 1406 according to the process executed by the encode/decode engine 1407, the first image enlargement/reduction section 1402, the second image enlargement/reduction section 1403, or the like.

The encode/decode engine 1407 executes an encoding process of image data and a decoding process of a video stream in which image data is encoded data. For example, the encode/decode engine 1407 encodes image data read from the frame memory 1405 and sequentially writes video streams to the video ES buffer 1408A. In addition, for example, the encode/decode engine 1407 sequentially reads video streams from the video ES buffer 1408B to decode the video streams and sequentially writes image data to the frame memory 1405. The encode/decode engine 1407 uses the frame memory 1405 as a work area in the encoding and the decoding. The encode/decode engine 1407 also outputs a synchronization signal to the memory control section 1406 at a timing of, for example, the start of the process for each macroblock.

The video ES buffer 1408A buffers a video stream generated by the encode/decode engine 1407 and supplies the video stream to the multiplexing section (MUX) 1412. The video ES buffer 1408B buffers a video stream supplied from the demultiplexing section (DMUX) 1413 and supplies the video stream to the encode/decode engine 1407.

The audio ES buffer 1409A buffers an audio stream generated by the audio encoder 1410 and supplies the audio stream to the multiplexing section (MUX) 1412. The audio ES buffer 1409B buffers an audio stream supplied from the demultiplexing section (DMUX) 1413 and supplies the audio stream to the audio decoder 1411.

The audio encoder 1410 performs, for example, digital conversion of an audio signal input from, for example, the connectivity 1321 or the like and uses, for example, a predetermined system, such as an MPEG audio system and an AC3 (AudioCode number 3) system, to encode the audio signal. The audio encoder 1410 sequentially writes, to the audio ES buffer 1409A, audio streams that are data in which the audio signal is encoded. The audio decoder 1411 decodes the audio stream supplied from the audio ES buffer 1409B, performs an operation, such as, for example, converting the audio stream into an analog signal, and supplies a reproduced audio signal to, for example, the connectivity 1321 or the like.

The multiplexing section (MUX) 1412 multiplexes a video stream and an audio stream. The method of multiplexing (that is, the format of the bit stream generated by multiplexing) is arbitrary. In the multiplexing, the multiplexing section (MUX) 1412 can also add predetermined header information or the like to the bit stream. That is, the multiplexing section (MUX) 1412 can convert the format of the stream by multiplexing. For example, the multiplexing section (MUX) 1412 multiplexes the video stream and the audio stream to convert the streams into a transport stream that is a bit stream in a format for transfer. In addition, for example, the multiplexing section (MUX) 1412 multiplexes the video stream and the audio stream to convert the streams into data (file data) in a file format for recording.

The demultiplexing section (DMUX) 1413 uses a method corresponding to the multiplexing by the multiplexing section (MUX) 1412 to demultiplex a bit stream in which a video stream and an audio stream are multiplexed. That is, the demultiplexing section (DMUX) 1413 extracts the video stream and the audio stream (separates the video stream and the audio stream) from the bit stream read from the stream buffer 1414. That is, the demultiplexing section (DMUX) 1413 can demultiplex the stream to convert the format of the stream (inverse transformation of the conversion by the multiplexing section (MUX) 1412). For example, the demultiplexing section (DMUX) 1413 can acquire a transport stream supplied from, for example, the connectivity 1321, the broadband modem 1333, or the like through the stream buffer 1414 and demultiplex the transport stream to convert the transport stream into a video stream and an audio stream. In addition, for example, the demultiplexing section (DMUX) 1413 can acquire file data read from various recording media by the connectivity 1321 through the stream buffer 1414 and demultiplex the file data to convert the file data into a video stream and an audio stream.

The stream buffer 1414 buffers a bit stream. For example, the stream buffer 1414 buffers a transport stream supplied from the multiplexing section (MUX) 1412 and supplies the transport stream to, for example, the connectivity 1321, the broadband modem 1333, or the like at a predetermined timing or on the basis of a request or the like from the outside.

In addition, for example, the stream buffer 1414 buffers file data supplied from the multiplexing section (MUX) 1412 and supplies the file data to, for example, the connectivity 1321 or the like at a predetermined timing or on the basis of a request or the like from the outside to record the file data in various recording media.

The stream buffer 1414 further buffers a transport stream acquired through, for example, the connectivity 1321, the broadband modem 1333, or the like and supplies the transport stream to the demultiplexing section (DMUX) 1413 at a predetermined timing or on the basis of a request or the like from the outside.

The stream buffer 1414 also buffers file data read from various recording media by, for example, the connectivity 1321 or the like and supplies the file data to the demultiplexing section (DMUX) 1413 at a predetermined timing or on the basis of a request or the like from the outside.

Next, an example of an operation of the video processor 1332 configured in this way will be described. For example, the video input processing section 1401 converts the video signal input from the connectivity 1321 or the like to the video processor 1332 into digital image data of a predetermined system, such as a 4:2:2 Y/Cb/Cr system, and sequentially writes the digital image data to the frame memory 1405. The first image enlargement/reduction section 1402 or the second image enlargement/reduction section 1403 reads the digital image data to convert the format into a predetermined system, such as a 4:2:0 Y/Cb/Cr system, and execute enlargement/reduction processing. The digital image data is written again to the frame memory 1405. The encode/decode engine 1407 encodes the image data, and the image data is written to the video ES buffer 1408A as the video stream.

In addition, the audio encoder 1410 encodes the audio signal input from the connectivity 1321 or the like to the video processor 1332, and the audio signal is written to the audio ES buffer 1409A as the audio stream.

The video stream of the video ES buffer 1408A and the audio stream of the audio ES buffer 1409A are read and multiplexed by the multiplexing section (MUX) 1412 and converted into a transport stream, file data, or the like. The transport stream generated by the multiplexing section (MUX) 1412 is buffered by the stream buffer 1414 and then output to an external network through, for example, the connectivity 1321, the broadband modem 1333, or the like. In addition, the stream buffer 1414 buffers the file data generated by the multiplexing section (MUX) 1412, and the file data is then output to, for example, the connectivity 1321 or the like and recorded in various recording media.

In addition, for example, the transport stream input from the external network to the video processor 1332 through the connectivity 1321, the broadband modem 1333, or the like is buffered by the stream buffer 1414 and then demultiplexed by the demultiplexing section (DMUX) 1413. In addition, for example, the file data read from various recording media by the connectivity 1321 or the like and input to the video processor 1332 is buffered by the stream buffer 1414 and then demultiplexed by the demultiplexing section (DMUX) 1413. That is, the transport stream or the file data input to the video processor 1332 is separated into the video stream and the audio stream by the demultiplexing section (DMUX) 1413.

The audio stream is supplied to the audio decoder 1411 through the audio ES buffer 1409B and decoded to reproduce the audio signal. In addition, the video stream is written to the video ES buffer 1408, and then the video stream is sequentially read and decoded by the encode/decode engine 1407 and written to the frame memory 1405. The decoded image data is enlarged or reduced by the second image enlargement/reduction section 1403 and written to the frame memory 1405. The decoded image data is then read by the video output processing section 1404, and the format is converted into a predetermined system, such as a 4:2:2 Y/Cb/Cr system. The decoded image data is further converted into an analog signal, and the video signal is reproduced and output.

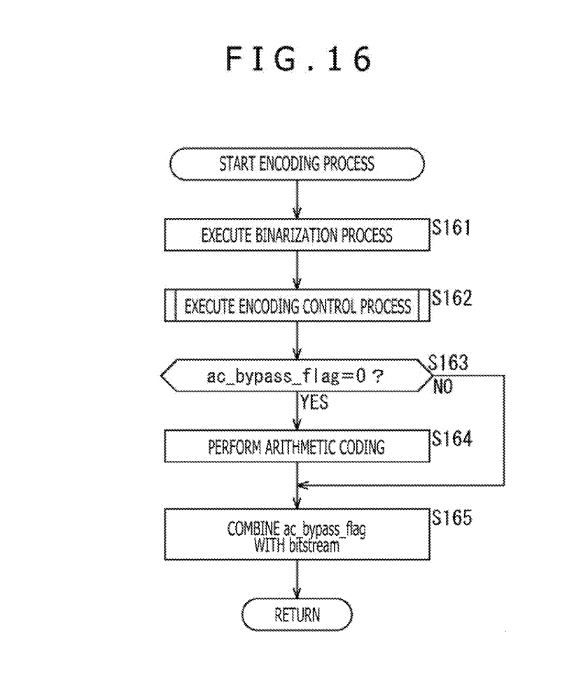

In the case of applying the present technique to the video processor 1332 configured in this way, the present technique according to each of the embodiments described above can be applied to the encode/decode engine 1407. That is, for example, the encode/decode engine 1407 may have one of or both the function of the image encoding apparatus 100 and the function of the image decoding apparatus 200 described above. As a result, the video processor 1332 can obtain advantageous effects similar to the advantageous effects in each of the embodiments described with reference to FIGS. 1 to 27.

Note that in the encode/decode engine 1407, the present technique (that is, one of or both the function of the image encoding apparatus 100 and the function of the image decoding apparatus 200) may be realized by hardware, such as a logic circuit, may be realized by software, such as an embedded program, or may be realized by both the hardware and the software.

### <Another Configuration Example of Video Processor>

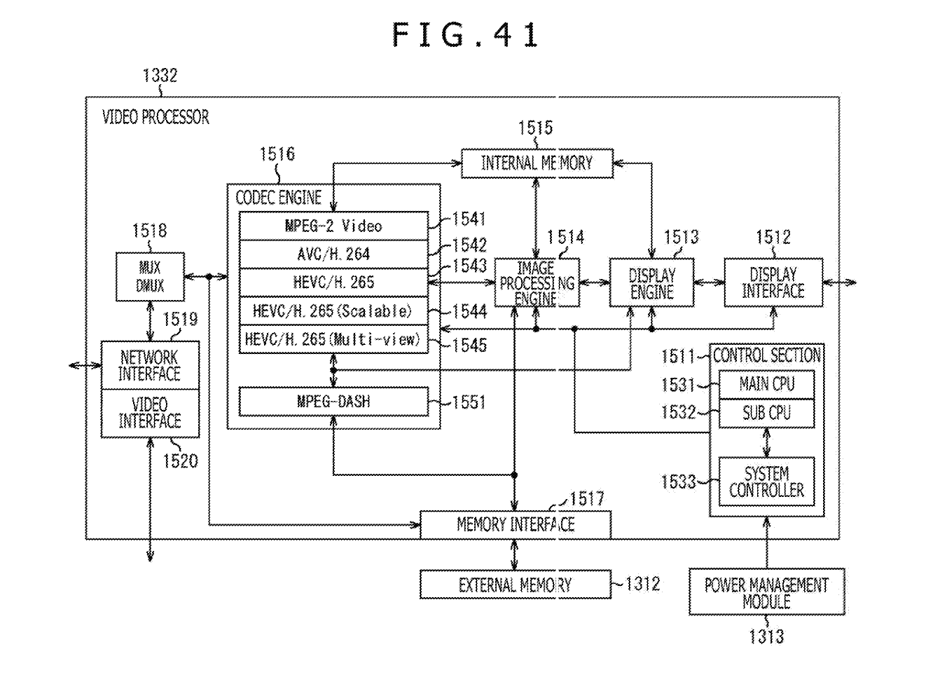

FIG. 41 illustrates another example of the schematic configuration of the video processor 1332 according to the present technique. In the case of the example of FIG. 41, the video processor 1332 has a function of using a predetermined system to encode and decode the video data.

More specifically, as illustrated in FIG. 41, the video processor 1332 includes a control section 1511, a display interface 1512, a display engine 1513, an image processing engine 1514, and an internal memory 1515. The video processor 1332 also includes a codec engine 1516, a memory interface 1517, a multiplexing/demultiplexing section (MUX DMUX) 1518, a network interface 1519, and a video interface 1520.

The control section 1511 controls the operation of each processing section in the video processor 1332, such as the display interface 1512, the display engine 1513, the image processing engine 1514, and the codec engine 1516.

As illustrated in FIG. 41, the control section 1511 includes, for example, a main CPU 1531, a sub CPU 1532, and a system controller 1533. The main CPU 1531 executes a program or the like for controlling the operation of each processing section in the video processor 1332. The main CPU 1531 generates a control signal according to the program or the like and supplies the control signal to each processing section (that is, controls the operation of each processing section). The sub CPU 1532 plays an auxiliary role of the main CPU 1531. For example, the sub CPU 1532 executes a child process, a subroutine, or the like of the program or the like executed by the main CPU 1531. The system controller 1533 controls the operations of the main CPU 1531 and the sub CPU 1532, such as designating the program executed by the main CPU 1531 and the sub CPU 1532.

The display interface 1512 outputs image data to, for example, the connectivity 1321 or the like under the control of the control section 1511. For example, the display interface 1512 converts image data of digital data into an analog signal and outputs a reproduced video signal or the image data of the digital signal to a monitor apparatus or the like of the connectivity 1321.

Under the control of the control section 1511, the display engine 1513 applies various conversion processes, such as format conversion, size conversion, and color gamut conversion, to the image data according to hardware specifications of a monitor apparatus or the like that displays the image.

The image processing engine 1514 applies predetermined image processing, such as, for example, a filtering process for improving the image quality, to the image data under the control of the control section 1511.

The internal memory 1515 is a memory shared by the display engine 1513, the image processing engine 1514, and the codec engine 1516 and provided inside of the video processor 1332. The internal memory 1515 is used to transfer data between, for example, the display engine 1513, the image processing engine 1514, and the codec engine 1516. For example, the internal memory 1515 stores data supplied from the display engine 1513, the image processing engine 1514, or the codec engine 1516 and supplies the data to the display engine 1513, the image processing engine 1514, or the codec engine 1516 as necessary (for example, according to a request). Although the internal memory 1515 may be realized by any storage device, the internal memory 1515 is generally used to store low-capacity data, such as block-based image data and parameters, in many cases, and it is desirable to realize the internal memory 1515 by a relatively (for example, compared to the external memory 1312) low-capacity semiconductor memory with high response speed, such as an SRAM (Static Random Access Memory).

The codec engine 1516 executes a process regarding encoding and decoding of image data. The system of encoding and decoding corresponding to the codec engine 1516 is arbitrary, and there may be one system or a plurality of systems. For example, the codec engine 1516 may have codec functions of a plurality of encoding and decoding systems and may use selected one of the codec functions to encode image data or decode encoded data.

In the example illustrated in FIG. 41, the codec engine 1516 includes, for example, an MPEG-2 Video 1541, an AVC/H.264 1542, an HEVC/H.265 1543, an HEVC/H.265 (Scalable) 1544, an HEVC/H.265 (Multi-view) 1545, and an MPEG-DASH 1551 that are functional blocks of processes regarding the codec.

The MPEG-2 Video 1541 is a functional block that uses the MPEG-2 system to encode and decode image data. The AVC/H.264 1542 is a functional block that uses the AVC system to encode and decode image data. The HEVC/H.265 1543 is a functional block that uses the HEVC system to encode and decode image data. The HEVC/H.265 (Scalable) 1544 is a functional block that uses the HEVC system to apply scalable encoding and scalable decoding to image data. The HEVC/H.265 (Multi-view) 1545 is a functional block that uses the HEVC system to apply multi-view encoding and multi-view decoding to the image data.

The MPEG-DASH 1551 is a functional block that uses the MPEG-DASH (MPEG-Dynamic Adaptive Streaming over HTTP) system to transmit and receive image data. The MPEG-DASH is a technique of using the HTTP (HyperText Transfer Protocol) to stream a video, and one of the features is that appropriate encoded data is transmitted by selecting the encoded data on a segment-by-segment basis from a plurality of pieces of encoded data with different resolutions or the like prepared in advance. The MPEG-DASH 1551 performs operations, such as generating a stream in compliance with the standard and controlling the transmission of the stream, and uses the components from the MPEG-2 Video 1541 to the HEVC/H.265 (Multi-view) 1545 to encode and decode image data.

The memory interface 1517 is an interface for the external memory 1312. The data supplied from the image processing engine 1514 or the codec engine 1516 is supplied to the external memory 1312 through the memory interface 1517. In addition, the data read from the external memory 1312 is supplied to the video processor 1332 (image processing engine 1514 or codec engine 1516) through the memory interface 1517.

The multiplexing/demultiplexing section (MUX DMUX) 1518 multiplexes and demultiplexes various types of data regarding the image, such as a bit stream of encoded data, image data, and a video signal. The method of multiplexing and demultiplexing is arbitrary. For example, the multiplexing/demultiplexing section (MUX DMUX) 1518 can not only group together a plurality of pieces of data in multiplexing, but can also add predetermined header information or the like to the data. In addition, the multiplexing/demultiplexing section (MUX DMUX) 1518 can not only partition one piece of data into a plurality of pieces of data in demultiplexing, but can also add predetermined header information or the like to each of the partitioned pieces of data. That is, the multiplexing/demultiplexing section (MUX DMUX) 1518 can multiplex and demultiplex data to convert the format of the data. For example, the multiplexing/demultiplexing section (MUX DMUX) 1518 can multiplex a bit stream to convert the bit stream into a transport stream that is a bit stream in the format of transfer or into data (file data) in the file format for recording. Obviously, the inverse transformation of the data can also be performed by demultiplexing.

The network interface 1519 is, for example, an interface for the broadband modem 1333, the connectivity 1321, and the like. The video interface 1520 is, for example, an interface for the connectivity 1321, the camera 1322, and the like.

Next, an example of the operation of the video processor 1332 will be described. For example, when a transport stream is received from an external network through the connectivity 1321, the broadband modem 1333, or the like, the transport stream is supplied to the multiplexing/demultiplexing section (MUX DMUX) 1518 through the network interface 1519 and demultiplexed, and the codec engine 1516 decodes the transport stream. The image processing engine 1514 applies, for example, predetermined image processing to the image data obtained by the decoding of the codec engine 1516, and the display engine 1513 performs predetermined conversion. The image data is supplied to, for example, the connectivity 1321 or the like through the display interface 1512, and the image is displayed on the monitor. In addition, for example, the codec engine 1516 encodes again the image data obtained by the decoding of the codec engine 1516, and the multiplexing/demultiplexing section (MUX DMUX) 1518 multiplexes the image data and converts the image data into file data. The file data is output to, for example, the connectivity 1321 or the like through the video interface 1520 and recorded in various recording media.

Furthermore, for example, the file data of the encoded data including the encoded image data read by the connectivity 1321 or the like from a recording medium not illustrated is supplied to the multiplexing/demultiplexing section (MUX DMUX) 1518 through the video interface 1520 and demultiplexed, and the file data is decoded by the codec engine 1516. The image processing engine 1514 applies predetermined image processing to the image data obtained by the decoding of the codec engine 1516, and the display engine 1513 performs predetermined conversion of the image data. The image data is supplied to, for example, the connectivity 1321 or the like through the display interface 1512, and the image is displayed on the monitor. In addition, for example, the codec engine 1516 encodes again the image data obtained by the decoding of the codec engine 1516, and the multiplexing/demultiplexing section (MUX DMUX) 1518 multiplexes the image data and converts the image data into a transport stream. The transport stream is supplied to, for example, the connectivity 1321, the broadband modem 1333, or the like through the network interface 1519 and transmitted to another apparatus not illustrated.

Note that the transfer of the image data and other data between processing sections in the video processor 1332 is performed by using, for example, the internal memory 1515 or the external memory 1312. In addition, the power management module 1313 controls power supplied to, for example, the control section 1511.

In the case where the present technique is applied to the video processor 1332 configured in this way, the present technique according to each of the embodiments described above can be applied to the codec engine 1516. That is, for example, the codec engine 1516 can include one of or both the function of the image encoding apparatus 100 and the function of the image decoding apparatus 200 described above. In this way, the video processor 1332 can obtain advantageous effects similar to the advantageous effects in each of the embodiments described with reference to FIGS. 1 to 27.

Note that in the codec engine 1516, the present technique (that is, the function of the image encoding apparatus 100) may be realized by hardware, such as a logic circuit, may be realized by software, such as an embedded program, or may be realized by both the hardware and the software.

Although two configurations of the video processor 1332 have been illustrated, the configuration of the video processor 1332 is arbitrary, and the configuration may be other than the configurations of the two examples. In addition, the video processor 1332 may be provided as one semiconductor chip or may be provided as a plurality of semiconductor chips. For example, the video processor 1332 may be a three-dimensional stacked LSI including a plurality of stacked semiconductors. The video processor 1332 may also be realized by a plurality of LSIs.

### <Example of Application to Apparatus>

The video set 1300 can be incorporated into various apparatuses that process image data. For example, the video set 1300 can be incorporated into the television apparatus 900 (FIG. 35), the mobile phone 920 (FIG. 36), the recording/reproducing apparatus 940 (FIG. 37), the imaging apparatus 960 (FIG. 38), and the like. The incorporation of the video set 1300 allows the apparatus to obtain advantageous effects similar to the advantageous effects in each of the embodiments described with reference to FIGS. 1 to 27.

Note that part of each configuration of the video set 1300 can be carried out as a configuration according to the present technique as long as the part includes the video processor 1332. For example, the video processor 1332 alone can be carried out as a video processor according to the present technique. In addition, for example, the processor indicated by the dotted line 1341, the video module 1311, or the like can be carried out as a processor, a module, or the like according to the present technique as described above. Furthermore, for example, the video module 1311, the external memory 1312, the power management module 1313, and the front-end module 1314 can be combined to carry out a video unit 1361 according to the present technique. In any of the configurations, advantageous effects similar to the advantageous effects in each of the embodiments described with reference to FIGS. 1 to 27 can be obtained.

That is, any configuration including the video processor 1332 can be incorporated into various apparatuses that process image data, as in the case of the video set 1300. For example, the video processor 1332, the processor indicated by the dotted line 1341, the video module 1311, or the video unit 1361 can be incorporated into the television apparatus 900 (FIG. 35), the mobile phone 920 (FIG. 36), the recording/reproducing apparatus 940 (FIG. 37), the imaging apparatus 960 (FIG. 38), or the like. Then, the incorporation of one of the configurations according to the present technique allows the apparatus to obtain advantageous effects similar to the advantageous effects in each of the embodiments described with reference to FIGS. 1 to 27, as in the case of the video set 1300.

### <Etc.>

Note that although various types of information are multiplexed into encoded data (bit stream) and transmitted from the encoding side to the decoding side in the example described in the present specification, the method of transmitting the information is not limited to the example. For example, the information may not be multiplexed into encoded data, and the information may be transmitted or recorded as separate data associated with the encoded data. Here, the term “associated” means, for example, that the image (may be part of the image, such as a slice or a block) included in the encoded data and the information corresponding to the image can be linked at the decoding. That is, the information associated with the encoded data (image) may be transmitted on a transmission path different from the encoded data (image). In addition, the information associated with the encoded data (image) may be recorded in a recording medium separate from the encoded data (image) (or in a separate recording area of the same recording medium). Furthermore, the image and the information corresponding to the image may be associated with each other in an arbitrary unit, such as, for example, a plurality of frames, one frame, and part of the frame.

In addition, as described above, the terms, such as “combine,” “multiplex,” “add,” “integrate,” “include,” “store,” “put in,” “place into,” and “insert,” in the present specification denote grouping of a plurality of things, such as grouping of the flag information and the encoded data of the information regarding the image into one piece of data, and each term denotes one method of “associating” described above.

In addition, the embodiments of the present technique are not limited to the embodiments described above, and various changes can be made without departing from the scope of the present technique.

For example, the system in the present specification denotes a set of a plurality of constituent elements (apparatuses, modules (components), and the like), and whether or not all of the constituent elements are in the same housing does not matter. Therefore, a plurality of apparatuses stored in separate housings and connected through a network and one apparatus storing a plurality of modules in one housing are both systems.

Furthermore, for example, the configuration of one apparatus (or processing section) described above may be divided to provide a plurality of apparatuses (or processing sections). Conversely, the configurations of a plurality of apparatuses (or processing sections) described above may be put together to provide one apparatus (or processing section). In addition, configurations other than the configurations described above may be obviously added to the configuration of each apparatus (or each processing section). Furthermore, part of the configuration of an apparatus (or processing section) may be included in the configuration of another apparatus (or another processing section) as long as the configuration and the operation of the entire system are substantially the same.

In addition, the present technique can be provided as, for example, cloud computing in which a plurality of apparatuses share one function and cooperate to execute a process through a network.

In addition, the program described above can be executed by, for example, an arbitrary apparatus. In that case, the apparatus can have necessary functions (such as functional blocks) and obtain necessary information.

In addition, for example, one apparatus can execute each step described in the flow charts, or a plurality of apparatuses can take charge and execute each step. Furthermore, in the case where one step includes a plurality of processes, one apparatus can execute the plurality of processes included in one step, or a plurality of apparatuses can take charge and execute the processes.

Note that the program executed by the computer may be a program in which the processes of the steps describing the program are executed in chronological order described in the present specification, or the program may be a program for executing the processes in parallel or for executing the processes separately at a necessary timing such as when the processes are invoked. That is, the processes of the steps may be executed in an order different from the order described above as long as there is no contradiction. Furthermore, the processes of the steps describing the program may be executed in parallel with processes of other programs or may be executed in combination with processes of other programs.

Note that the plurality of present techniques described in the present specification can be independently and separately carried out as long as there is no contradiction. Obviously, a plurality of arbitrary present techniques can be combined and carried out. For example, the present technique described in one of the embodiments can also be carried out in combination with the present technique described in another embodiment. In addition, an arbitrary present technique described above can also be carried out in combination with another technique not described above.

Note that the present technique can also be configured as follows.

(1)

An image processing apparatus including:

a flag information setting section that sets flag information indicating whether to apply arithmetic coding to binary data including binary information regarding an image; and

an encoding section that encodes the information regarding the image to generate encoded data including the flag information set by the flag information setting section.

(2)

The image processing apparatus according to (1), in which

on a basis of the flag information set by the flag information setting section, the encoding section
binarizes the information regarding the image to generate the binary data and applies the arithmetic coding to the generated binary data to thereby generate encoded data including the binary and arithmetic-coded information regarding the image or
binarizes the information regarding the image to generate encoded data including the binary information regarding the image.
   (3)

The image processing apparatus according to (1) or (2), further including:

a flag information addition section that adds the flag information set by the flag information setting section to the encoded data of the information regarding the image.

(4)

The image processing apparatus according to any one of (1) to (3), in which

the flag information addition section adds the flag information so as to include the flag information in a slice header of the encoded data.

(5)

The image processing apparatus according to any one of (1) to (4), in which

the flag information setting section sets the flag information on a basis of information regarding the encoding of the image.

(6)

The image processing apparatus according to any one of (1) to (5), in which

the information regarding the encoding includes information regarding a throughput of the encoding of the image.

(7)

The image processing apparatus according to any one of (1) to (6), in which

the information regarding the throughput includes at least one of information regarding a code amount generated by the encoding of the image, information regarding a compression ratio of the encoding of the image, and information regarding processing time of the encoding of the image.

(8)

The image processing apparatus according to any one of (1) to (7), in which

the information regarding the encoding includes information regarding a delay in the encoding of the image.

(9)

The image processing apparatus according to any one of (1) to (8), in which

the flag information setting section sets the flag information for each slice of the image.

(10)

The image processing apparatus according to any one of (1) to (9), in which

the flag information setting section sets the flag information on a basis of control information for controlling use of the flag information.

(11)

The image processing apparatus according to any one of (1) to (10), in which

the control information includes permission information for permitting the use of the flag information, and

the flag information setting section is configured to set the flag information in a case where the use is permitted by the permission information.

(12)

The image processing apparatus according to any one of (1) to (11), further including:

a control information addition section that adds the control information to the encoded data of the information regarding the image.

(13)

An image processing method including:

setting flag information indicating whether to apply arithmetic coding to binary data including binary information regarding an image; and

encoding the information regarding the image to generate encoded data including the set flag information.

(14)

An image processing apparatus including:

a decoding section that applies arithmetic decoding and obtains multi-level data of encoded data, the encoded data including binary and arithmetic-coded information regarding an image, on a basis of flag information indicating whether to apply the arithmetic coding to binary data including the binary information regarding the image to thereby obtain multi-level data of the encoded data, the encoded data including the binary information regarding the image.

(15)

The image processing apparatus according to (14), further including:

a flag information acquisition section that acquires the flag information added to the encoded data, in which

the decoding section is configured to apply the arithmetic decoding and obtain the multi-level data of the encoded data, the encoded data including the binary and arithmetic-coded information regarding the image, on a basis of the flag information acquired by the flag information acquisition section to thereby obtain the multi-level data of the encoded data, the encoded data including the binary information regarding the image.

(16)

The image processing apparatus according to (14) or (15), in which

the flag information acquisition section acquires the flag information stored in a slice header of the encoded data.

(17)

The image processing apparatus according to any one of (14) to (16), in which

the flag information acquisition section acquires the flag information on a basis of control information for controlling use of the flag information.

(18)

The image processing apparatus according to any one of (14) to (17), in which

the control information includes permission information for permitting the use of the flag information, and

the flag information acquisition section is configured to acquire the flag information in a case where the use is permitted by the permission information.

(19)

The image processing apparatus according to any one of (14) to (18), further including:

a control information acquisition section that acquires the control information added to the encoded data, in which

the flag information acquisition section is configured to acquire the flag information on a basis of the control information acquired by the control information acquisition section.

(20)

An image processing method including:

applying arithmetic decoding and obtaining multi-level data of encoded data, the encoded data including binary and arithmetic-coded information regarding an image, on a basis of flag information indicating whether to apply the arithmetic coding to binary data including the binary information regarding the image to thereby obtain multi-level data of the encoded data, the encoded data including the binary information regarding the image.

### REFERENCE SIGNS LIST

100 Image encoding apparatus, 115 Encoding section, 131 Encoding control section, 132 CABAC encoding section, 133 Buffer, 134 Selecting/combining section, 141 Operation mode setting section, 151 Binarization section, 152 Arithmetic coding section, 200 Image decoding apparatus, 212 Decoding section, 231 Decoding control section, 232 Selection section, 233 CABAC decoding section, 234 Buffer, 241 Operation mode setting section, 251 Arithmetic decoding section, 252 Multi-level formation section, 301 Encoding control section, 304 Selecting/combining section, 311 Control information setting section, 312 Operation mode setting section, 351 Decoding control section, 361 Control information buffer, 362 Operation mode setting section

1. An image processing apparatus comprising:
a flag information setting section that sets flag information indicating whether to apply arithmetic coding to binary data including binary information regarding an image; and
an encoding section that encodes the information regarding the image to generate encoded data including the flag information set by the flag information setting section.

2. The image processing apparatus according to claim 1, wherein
on a basis of the flag information set by the flag information setting section, the encoding section
binarizes the information regarding the image to generate the binary data and applies the arithmetic coding to the generated binary data to thereby generate encoded data including the binary and arithmetic-coded information regarding the image or
binarizes the information regarding the image to generate encoded data including the binary information regarding the image.

3. The image processing apparatus according to claim 1, further comprising:
a flag information addition section that adds the flag information set by the flag information setting section to the encoded data of the information regarding the image.

4. The image processing apparatus according to claim 3, wherein
the flag information addition section adds the flag information so as to include the flag information in a slice header of the encoded data.

5. The image processing apparatus according to claim 1, wherein
the flag information setting section sets the flag information on a basis of information regarding the encoding of the image.

6. The image processing apparatus according to claim 5, wherein
the information regarding the encoding includes information regarding a throughput of the encoding of the image.

7. The image processing apparatus according to claim 6, wherein
the information regarding the throughput includes at least one of information regarding a code amount generated by the encoding of the image, information regarding a compression ratio of the encoding of the image, and information regarding processing time of the encoding of the image.

8. The image processing apparatus according to claim 5, wherein
the information regarding the encoding includes information regarding a delay in the encoding of the image.

9. The image processing apparatus according to claim 1, wherein
the flag information setting section sets the flag information for each slice of the image.

10. The image processing apparatus according to claim 1, wherein
the flag information setting section sets the flag information on a basis of control information for controlling use of the flag information.

11. The image processing apparatus according to claim 10, wherein
the control information includes permission information for permitting the use of the flag information, and
the flag information setting section is configured to set the flag information in a case where the use is permitted by the permission information.

12. The image processing apparatus according to claim 10, further comprising:
a control information addition section that adds the control information to the encoded data of the information regarding the image.

13. An image processing method comprising:
setting flag information indicating whether to apply arithmetic coding to binary data including binary information regarding an image; and
encoding the information regarding the image to generate encoded data including the set flag information.

14. An image processing apparatus comprising:
a decoding section that applies arithmetic decoding and obtains multi-level data of encoded data, the encoded data including binary and arithmetic-coded information regarding an image, on a basis of flag information indicating whether to apply the arithmetic coding to binary data including the binary information regarding the image to thereby obtain multi-level data of the encoded data, the encoded data including the binary information regarding the image.

15. The image processing apparatus according to claim 14, further comprising:
a flag information acquisition section that acquires the flag information added to the encoded data, wherein
the decoding section is configured to apply the arithmetic decoding and obtain the multi-level data of the encoded data, the encoded data including the binary and arithmetic-coded information regarding the image, on a basis of the flag information acquired by the flag information acquisition section to thereby obtain the multi-level data of the encoded data, the encoded data including the binary information regarding the image.

16. The image processing apparatus according to claim 15, wherein
the flag information acquisition section acquires the flag information stored in a slice header of the encoded data.

17. The image processing apparatus according to claim 15, wherein
the flag information acquisition section acquires the flag information on a basis of control information for controlling use of the flag information.

18. The image processing apparatus according to claim 17, wherein
the control information includes permission information for permitting the use of the flag information, and
the flag information acquisition section is configured to acquire the flag information in a case where the use is permitted by the permission information.

19. The image processing apparatus according to claim 17, further comprising:
a control information acquisition section that acquires the control information added to the encoded data, wherein
the flag information acquisition section is configured to acquire the flag information on a basis of the control information acquired by the control information acquisition section.

20. An image processing method comprising:
applying arithmetic decoding and obtaining multi-level data of encoded data, the encoded data including binary and arithmetic-coded information regarding an image, on a basis of flag information indicating whether to apply the arithmetic coding to binary data including the binary information regarding the image to thereby obtain multi-level data of the encoded data, the encoded data including the binary information regarding the image.
